(19) United States
(12) Patent Application Publication
(10) Pub. No.: US 2015/0247350 A1
(43) Pub. Date: Sep. 3, 2015

(54) ROCKER STYLE CHAIRS, MODULAR COMPONENTS FOR USE WITHIN ROCKER STYLE CHAIRS AND PARTS FOR USE WITHIN THE MODULAR COMPONENTS

(71) Applicants: Frederick Jacobs, Holland, MI (US); Matthew Jacobs, Holland, MI (US); Michiel van de Ven, West Olive, MI (US)

(72) Inventors: Frederick Jacobs, Holland, MI (US); Matthew Jacobs, Holland, MI (US); Michiel van de Ven, West Olive, MI (US)

(21) Appl. No.: 14/636,045

(22) Filed: Mar. 2, 2015

Related U.S. Application Data
(60) Provisional application No. 61/946,824, filed on Mar. 2, 2014.
(60) Provisional application No. 62/006,363, filed on Jun. 2, 2014.
(60) Provisional application No. 62/018,854, filed on Jun. 30, 2014.

(51) Int. Cl. E05F 1/12; E05D 5/06; A47C 1/121

(52) U.S. Cl. CPC E05F 1/12; A47C 1/121; E05D 5/065

(57) ABSTRACT

Rocker style chairs and rocker style chairs with pivoting seats are provided along with modular components for use within rocker style chairs and parts for assembling within the modular components. The related components and chair assemblies minimize manufacturing time, maximize material usage and decrease related installation time. The related rocker style chairs may provide comfort to chair occupants and minimize noise during related chair component motion.

### CROSS REFERENCE TO RELATED APPLICATIONS

The present application claims priority under 35 U.S.C. §119(b) to commonly assigned patent application Ser. No. 61/946,824, entitled Rocker Style Chairs, Modular Components for use within Rocker Style Chairs and Parts for use within the Modular Components, filed Mar. 2, 2014; Ser. No. 62/006,363, entitled Reconfigurable Seating Systems, Seat Assemblies for use within the Reconfigurable Seating Systems, Components for use within the Seat Assemblies and Parts for use within the Components, filed Jun. 2, 2014; and Ser. No. 62/018,854, entitled Beam Mounted Chair Assemblies, Chair Assemblies for use within the Beam Mounted Chair assemblies, Components for use within the Chair Assemblies and Parts for use within the Components, filed Jun. 30, 2014, the disclosures of which are all incorporated herein in their entireties by reference.

### TECHNICAL FIELD

The present disclosure generally relates to rocker style chairs and rocker style chairs with pivoting seats. More particularly, the present disclosure relates to rocker style chairs and rocker style chairs with pivoting seats, modular components for use within rocker style chairs, parts for use within the modular components and related manufacturing and installation methods.

### BACKGROUND

Rocker style chairs are often installed in gymnasiums, auditoriums, stadiums, theaters, arenas, conference centers, cinemas, home theaters, places of worship (e.g., a church), education facilities, classrooms, performance halls and the like. Rocker style chairs with pivoting seats may be preferred to reduce space requirements when compared to rocker style chairs that do not include pivoting seats. For example, when a rocker style chair with a pivoting seat is unoccupied, the seat automatically pivots upward such that the seat does not extend as far into a related isle compared to when the seat is occupied. Thereby, more rocker style chairs with pivoting seats can be installed within a given space compared to rocker style chairs without pivoting seats.

Rocker style chairs and rocker style chairs with pivoting seats typically include a plethora of individual parts. Many of the corresponding components, assembled from the individual parts, are complex. Manufacturing of the parts and assembly of the components is time consuming and expensive. Installation of a plurality of rocker style chairs or rocker style chairs with pivoting seats, starting with the individual parts on site, requires a protracted amount of time and resources and involves a wide variety of likelihood for error and lost parts.

Rocker style chairs and rocker style chairs with pivoting seats are needed that minimize part manufacturing time, maximize material usage and reduce component assembly time and chair installation time. Furthermore, rocker style chairs and rocker style chairs with pivoting seats are needed that minimize the need for skilled labor during installation.

### SUMMARY

A seat bracket for use in a rocker style chair may include a first spring assembly fastener hole and a second spring assembly fastener hole, wherein the first spring assembly fastener hole and said second spring assembly fastener hole are configured to receive a respective fastener of a spring assembly. The seat bracket may further include an over-travel bolt nut receptacle, wherein the over-travel bolt nut receptacle is configured to receive an associated over-travel bolt nut and to prevent the over-travel bolt nut from rotating when the over-travel bolt nut is received within the over-travel bolt nut receptacle. The seat bracket may also include a seat assembly fastener hole and corresponding seat assembly fastening bolt head receptacle, wherein the seat assembly fastening bolt head receptacle is configured to receive an associated seat assembly fastening bolt head and to prevent the seat assembly fastening bold head from rotating when the seat assembly fastening bolt head is received within the seat assembly fastening bolt head receptacle.

In another embodiment, a seat bracket for use in a rocker style chair may include an over-travel bolt nut receptacle, wherein the over-travel bolt nut receptacle is configured to receive an associated over-travel bolt nut and to prevent the over-travel bolt nut from rotating when the over-travel bolt nut is received within the over-travel bolt nut receptacle. The seat bracket may further include a seat assembly fastener hole and corresponding seat assembly fastening receptacle, wherein the seat assembly fastening receptacle is configured to receive an associated seat assembly fastening head and to prevent the seat assembly fastening from rotating when the seat assembly fastening head is received within the seat assembly fastening head receptacle.

In a further embodiment, a seat bracket for use in a rocker style chair include at least one fastener head receptacle, wherein the at least one fastener head receptacle is configured to receive a fastener head and to prevent the fastener head from rotating when a fastener head is received within the fastener head receptacle. The seat bracket may further include a substantially flat bottom surface that is configured to engage a substantially flat surface of an associated spring assembly.

In yet another embodiment, a rocker style chair is provided. The rocker style chair may include a modular left-hand standard assembly including a left-hand landing bracket, wherein the left-hand landing bracket is shaped from a first landing bracket blank. The rocker style chair may also include a modular right-hand standard assembly including a right-hand landing bracket, wherein the right-hand landing bracket is shaped from a second landing bracket blank and wherein the second landing bracket blank is substantially the same shape as the first landing bracket blank and the right-hand landing bracket is substantially a mirror image of the left-hand landing bracket. The rocker style chair may further include a modular chair seat assembly and a modular chair back assembly.

In yet a further embodiment, a method of installing at least one of rocker style chair at an installation site is provided. The method may include assembling at least two modular standard assemblies at a first site. The method may also include assembling at least one modular chair seat assembly at a second site. The method may further include assembling at least one modular chair back assembly at a third site. The method may yet further include delivering the at least two modular standard assemblies, the at least one modular chair seat assembly and the at least one modular chair back assembly to the installation site, wherein a geographic location of the first site, a geographic location of the second site and a geographic location of the third site are different than a geographic location of the installation site. The method may also include placing the at least one modular chair seat assembly and the at least one modular chair back assembly proximate the at least two modular standard assemblies, at the installation site, in a free standing, final resting position at the installation site, without using any hand tools or fasteners, to define at least one rocker style chair.

In another embodiment, a plurality of rocker style chairs are provided. The plurality of rocker style chairs may include at least one modular left-hand standard assembly including a left-hand landing bracket, wherein the left-hand landing bracket is shaped from a first landing bracket blank. The plurality of rocker style chairs may also include at least one modular center standard assembly including a left-hand landing bracket and a right-hand landing bracket, wherein the right-hand landing bracket is shaped from a second landing bracket blank and wherein the second landing bracket blank is substantially the same shape as the first landing bracket blank and the right-hand landing bracket is substantially a mirror image of the left-hand landing bracket. The plurality of rocker style chairs may further include at least one modular right-hand standard assembly including a right-hand landing bracket. The plurality of rocker style chairs may yet further include at least two modular chair seat assemblies and at least two modular chair back assemblies.

In yet further embodiments, at least one component and/or assembly is provided that may be used on either a right-side of an associated rocker style chair or a left-side of the associated rocker style chair.

### BRIEF DESCRIPTION OF THE DRAWINGS

The figures described below depict various aspects of rocker style chairs and rocker style chairs with pivoting seats, components for use within the chairs and parts for use within the components that are disclosed herein. It should be understood that each figure depicts an embodiment of a particular aspect of the disclosed chairs, components and/or parts, and that each of the figures is intended to accord with a possible embodiment thereof. Furthermore, wherever possible, the following description refers to the reference numerals included in the following figures, in which features depicted in multiple figures may be designated with consistent reference numerals and/or consistent reference numerals having a differing concatenated letter.

FIG. 1A depicts a plan view of an example rocker style chair with pivoting seat installation;

FIG. 1B depicts a perspective view of two example rocker style chairs with pivoting seats installed as shown in FIG. 1A;

FIG. 1C depicts a side, profile, view of an example rocker style chair “rocking” between various positions;

FIG. 1D depicts an exploded, perspective view of the two example rocker style chairs with pivoting seats of FIG. 1B;

FIG. 1E depicts a perspective view of the two example rocker style chairs with pivoting seats of FIG. 1B;

FIG. 1F depicts a perspective view of the two example rocker style chairs with pivoting seats of FIG. 1E with related arm rests and cup holders removed;

FIG. 1G depicts a perspective view of the two example rocker style chairs with pivoting seats of FIG. 1F with related dust covers removed;

FIG. 1H depicts a front profile view of the two example rocker style chairs with pivoting seats of FIG. 1B;

FIG. 1J depicts a rear profile view of the two example rocker style chairs with pivoting seats of FIG. 1B;

FIG. 1K depicts a left-side profile view of the two example rocker style chairs with pivoting seats of FIG. 1B;

FIG. 1L depicts a right-side profile view of the two example rocker style chairs with pivoting seats of FIG. 1B;

FIG. 2A depicts a front perspective view of an example chair back assembly for use within either of the rocker style chairs of FIG. 1B;

FIG. 2B depicts a rear perspective view of an example chair back assembly for use within either of the rocker style chairs of FIG. 1B;

FIG. 2C depicts an exploded, front perspective view of an example chair back assembly for use within either of the rocker style chairs of FIG. 1B;

FIG. 2D depicts an exploded, rear perspective view of an example chair back assembly for use within either of the rocker style chairs of FIG. 1B;

FIG. 3A depicts a front, top, perspective view of an example chair seat assembly for use within either of the rocker style chairs of FIG. 1B;

FIG. 3B depicts a front, bottom, perspective view of an example chair seat assembly for use within either of the rocker style chairs of FIG. 1B;

FIG. 3C depicts a front profile view of an example chair seat assembly for use within either of the rocker style chairs of FIG. 1B;

FIG. 3D depicts a bottom profile view of an example chair seat assembly for use within either of the rocker style chairs of FIG. 1B;

FIG. 3E depicts a front profile view of an example chair seat assembly, pivoted upward, for use within either of the rocker style chairs of FIG. 1B;

FIG. 3F depicts a left-side profile view of an example chair seat assembly for use within either of the rocker style chairs of FIG. 1B;

FIG. 3G depicts a top profile view of an example chair seat assembly for use within either of the rocker style chairs of FIG. 1B;

FIG. 3H depicts an exploded front, top, perspective view of an example chair seat assembly for use within either of the rocker style chairs of FIG. 1B;

FIG. 3J depicts an exploded front, bottom, perspective view of an example chair seat assembly for use within either of the rocker style chairs of FIG. 1B;

FIG. 3K depicts an exploded front, top, perspective view of an example chair seat assembly for use within either of the rocker style chairs of FIG. 1B;

FIG. 3L depicts an exploded front, bottom, perspective view of an example chair seat assembly for use within either of the rocker style chairs of FIG. 1B;

FIG. 4A depicts a front, top, perspective view of example standard assemblies for use within the rocker style chairs of FIG. 1B;

FIG. 4B depicts a rear, profile view of example standard assemblies for use within the rocker style chairs of FIG. 1B;

FIG. 4C depicts a bottom, profile view of example standard assemblies for use within the rocker style chairs of FIG. 1B;

FIG. 4D depicts a front, profile view of example standard assemblies for use within the rocker style chairs of FIG. 1B;

FIG. 4E depicts a top, profile view of example standard assemblies for use within the rocker style chairs of FIG. 1B;

FIG. 4F depicts a front, top, perspective view of an example right-side standard assembly for use within the rocker style chairs of FIG. 1B;

FIG. 4G depicts a front, top, exploded, perspective view of an example right-side standard of FIG. 4F;

FIG. 4H depicts a front, top, perspective view of an example center standard assembly for use within the rocker style chairs of FIG. 1B;

FIG. 4J depicts a front, top, exploded, perspective view of an example center standard assembly of FIG. 4H;

FIG. 4K depicts a front, top, perspective view of an example left-side standard assembly for use within the rocker style chairs of FIG. 1B;

FIG. 4L depicts a front, top, exploded, perspective view of an example left-side standard assembly of FIG. 4K;

FIG. 4M depicts a front, top, perspective view of another example right-side standard assembly for use within the rocker style chairs of FIG. 1B;

FIG. 4N depicts a front, top, exploded, perspective view of another example right-side standard assembly of FIG. 4M;

FIG. 4P depicts a front, top, perspective view of another example center standard assembly for use within the rocker style chairs of FIG. 1B;

FIG. 4Q depicts a front, top, exploded, perspective view of the example center standard assembly of FIG. 4P;

FIG. 4R depicts a front, side, perspective view of another example center standard assembly for use within the rocker style chairs of FIG. 1B;

FIG. 4S depicts a front, side, perspective view of another example center standard assembly for use within the rocker style chairs of FIG. 1B;

FIG. 4T depicts a front, side, exploded, perspective view of the example center standard assembly of FIG. 4S;

FIG. 4U depicts a front, side, perspective view of another example center standard assembly for use within the rocker style chairs of FIG. 1B;

FIG. 4V depicts a front, right-side, perspective view of an example right-end standard assembly for use within the rocker style chairs of FIG. 1B;

FIG. 4W depicts a front, left-side, perspective view of the example right-end standard assembly of FIG. 4V;

FIG. 4X depicts a front, right-side, exploded, perspective view of the right-end standard assembly of FIG. 4V;

FIG. 4Y depicts a front, left-side, exploded, perspective view of the example right-end standard assembly of FIG. 4V;

FIGS. 4Z1-4Z4 depict various perspective views of an example right-end standard assembly;

FIG. 5A depicts a rear, top, perspective view of an example left-side chair assembly for use within the rocker style chairs of FIG. 1B;

FIG. 5B depicts an exploded, perspective, view of the example left-side chair assembly of FIG. 5A;

FIG. 5C depicts a front, bottom, perspective view of an example left-side chair assembly for use within the rocker style chairs of FIG. 1B;

FIG. 5D depicts an exploded, perspective, view of the example left-side chair assembly of FIG. 5C;

FIG. 5E depicts a top, plan, view of the example left-side chair assembly of FIG. 5A;

FIG. 5F depicts a side, plan, section view of the example left-side chair assembly of FIG. 5E;

FIG. 5G depicts a right-side perspective view of another example left-side chair assembly for use within the rocker style chairs of FIG. 1B;

FIG. 5H depicts a left-side perspective view of the left-side chair assembly of FIG. 5G;

FIG. 5J depicts a right-side perspective view of another example right-side chair assembly for use within the rocker style chairs of FIG. 1B;

FIG. 5K depicts a left-side perspective view of the right-side chair assembly of FIG. 5J;

FIG. 6A depicts a front, top, perspective view of an example left-side bottom bracket and back bracket for use within the rocker style chairs of FIG. 1B;

FIG. 6B depicts a front, top, perspective view of left-side bottom bracket and back bracket for use within the rocker style chairs of FIG. 1B with the back bracket rotated;

FIG. 7A depicts a front, top, perspective view of right-side bottom bracket and back bracket for use within the rocker style chairs of FIG. 1B;

FIG. 7B depicts a front, top, perspective view of right-side bottom bracket and back bracket for use within the rocker style chairs of FIG. 1B with the back bracket rotated;

FIG. 7C depicts a front, top, perspective view of right-side bottom bracket for use within the rocker style chairs of FIG. 1B with the back bracket rotated;

FIG. 7D depicts a front, bottom, perspective view of right-side bottom bracket for use within the rocker style chairs of FIG. 1B with the back bracket rotated;

FIGS. 8A, 8C and 8D each depict a front, bottom, perspective view of an example left-side chair pivot for use within the rocker style chairs of FIG. 1B in a position reflecting an occupant is in the chair;

FIG. 8B depicts a front, bottom, exploded, perspective view of an example left-side chair pivot for use within the rocker style chairs of FIG. 1B;

FIG. 8E depicts a front, bottom, perspective view of an example right-side chair pivot for use within the rocker style chairs of FIG. 1B in a position reflecting no occupant in the chair;

FIGS. 9A, 9C and 9D each depict a front, bottom, perspective view of an example right-side chair pivot for use within the rocker style chairs of FIG. 1B in a position reflecting an occupant is in the chair;

FIG. 9B depicts a front, bottom, exploded, perspective view of an example right-side chair pivot for use within the rocker style chairs of FIG. 1B;

FIG. 9E depicts a front, bottom, perspective view of an example left-side chair pivot for use within the rocker style chairs of FIG. 1B in a position reflecting no occupant in the chair;

FIG. 10A depicts a rear, top, perspective view of an example spring for use within the rocker style chairs of FIG. 1B;

FIG. 10B depicts a rear, top, exploded, perspective view of an example spring for use within the rocker style chairs of FIG. 1B;

FIG. 11A depicts a blank of a right-hand debris cover formed in a flat piece of metal;

FIG. 11B depicts a perspective view of a right-hand debris cover shaped from the blank of FIG. 11A;

FIG. 12A depicts a blank of a center debris cover formed in a flat piece of metal;

FIG. 12B depicts a perspective view of a center debris cover shaped from the blank of FIG. 12A;

FIG. 13A depicts a blank of a left-hand debris cover formed in a flat piece of metal;

FIG. 13B depicts a perspective view of a left-hand debris cover shaped from the blank of FIG. 13A;

FIG. 14 depicts an end cover formed in a flat piece of metal;

FIG. 15A depicts a blank of a right-hand landing bracket formed in a flat piece of metal;

FIG. 15B depicts a perspective view of a right-hand landing bracket shaped from the blank of FIG. 15A;

FIG. 16A depicts a blank of a left-hand landing bracket formed in a flat piece of metal;

FIG. 16B depicts a perspective view of a left-hand landing bracket shaped from the blank of FIG. 16A;

FIG. 17A depicts a blank of a right-hand seat connector formed in a flat piece of metal;

FIG. 17B depicts a perspective view of a right-hand seat connector shaped from the blank of FIG. 17A;

FIG. 18A depicts a blank of a left-hand seat connector formed in a flat piece of metal;

FIG. 18B depicts a perspective view of a left-hand seat connector shaped from the blank of FIG. 18A;

FIG. 19A depicts a blank of a right-hand pivot arm formed in a flat piece of metal;

FIG. 19B depicts a perspective view of a right-hand pivot arm shaped from the blank of FIG. 19A;

FIGS. 20A and 20C each depict a blank of a left-hand pivot arm formed in a flat piece of metal;

FIGS. 20B, 20D and 20E each depict a perspective view of a left-hand pivot arm shaped from the blank of FIG. 20A;

FIG. 21 depicts a flow diagram of a method of forming a component from a flat piece of metal;

FIG. 22 depicts a flow diagram of a method of installing a plurality of rocker style chairs;

FIGS. 23A-23G depict various example debris covers; and

FIGS. 23H and 23J-23K depict various views of an example right-end cover.

### DETAILED DESCRIPTION

The rocker style chairs and rocker style chairs with pivoting seats of the present disclosure may be installed within gymnasiums, auditoriums, stadiums, theaters, arenas, conference centers, cinemas, places of worship (e.g., a church), education facilities, classrooms, performance halls, home theaters and the like. The individual rocker style chairs or rocker style chairs with pivoting seats, or a related installation structure, may include power and/or data connections for use by a chair occupant.

The rocker style chairs and rocker style chairs with pivoting seats of the present disclosure may be assembled, on site, starting with a set of modular components. For example, each rocker style chair may include a left-hand standard module, a right-hand standard module, a chair seat module and a chair back module (i.e., each rocker style chair may include four modular components). When two, or more, rocker style chairs are installed side-by-side in a row, each rocker style chair, within a row of side-by-side rocker style chairs, may share a center standard module. In any event, the individual modular components (e.g., left-hand standard module, right-hand standard module, center standard module, chair seat module and chair back module) may be pre-assembled off site. As a result, on-site installation time is minimized, the need for on-site skilled labor is minimized, the likelihood of losing parts on-site is minimized, on-site assembly errors are minimized, etc.

The rocker style chairs and rocker style chairs with pivoting seats, related components and parts of the present disclosure may provide additional comfort to a chair occupant compared to a non-rocker style chair. Furthermore, the rocker style chairs and rocker style chairs with pivoting seats of the present disclosure may incorporate a chair seat and, or a chair back as described in commonly assigned U.S. patent application Ser. No. 61/868,547, filed Aug. 21, 2013, the entire disclosure of which is incorporated by reference herein. Moreover, the rocker style chairs and rocker style chairs with pivoting seats, related components and parts of the present disclosure may include noise minimizing features.

The terms “right-hand,” “right-side,” “left-hand” and “left-side” are used herein in reference to a location of various components, parts and assemblies with respect to an occupant setting in a related rocker style chair. In particular, the side of an occupant that is closest to a related component, part or assembly will be used to identify the component, part or assembly.

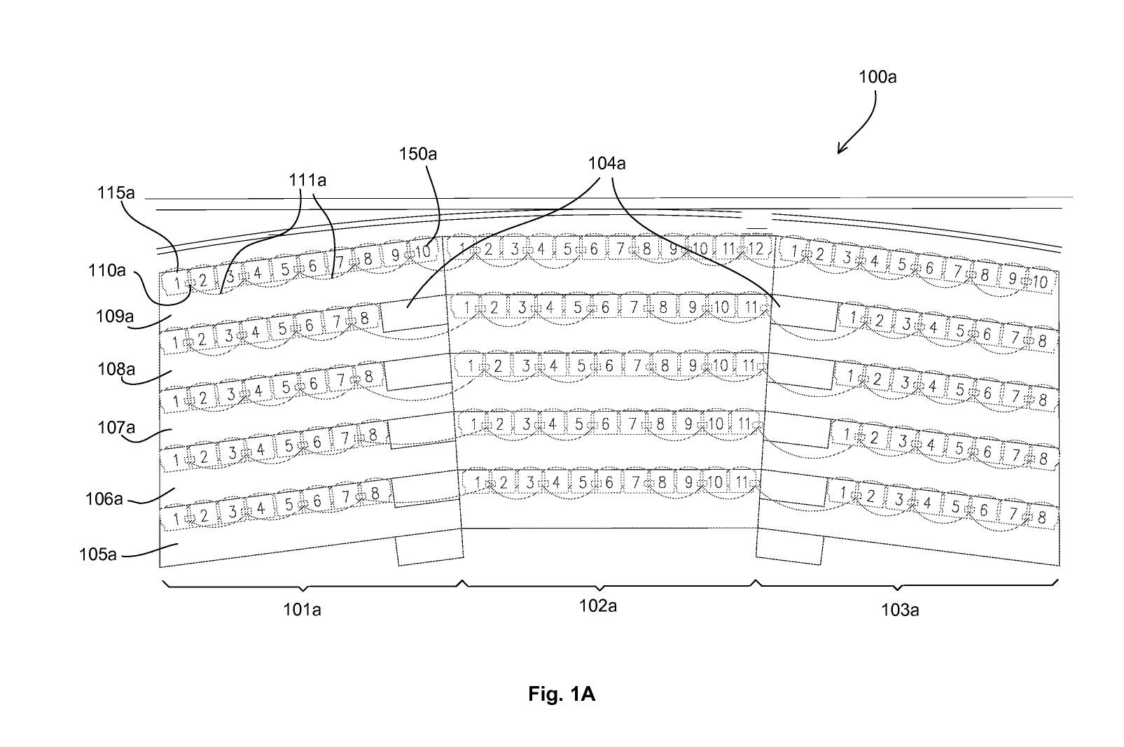

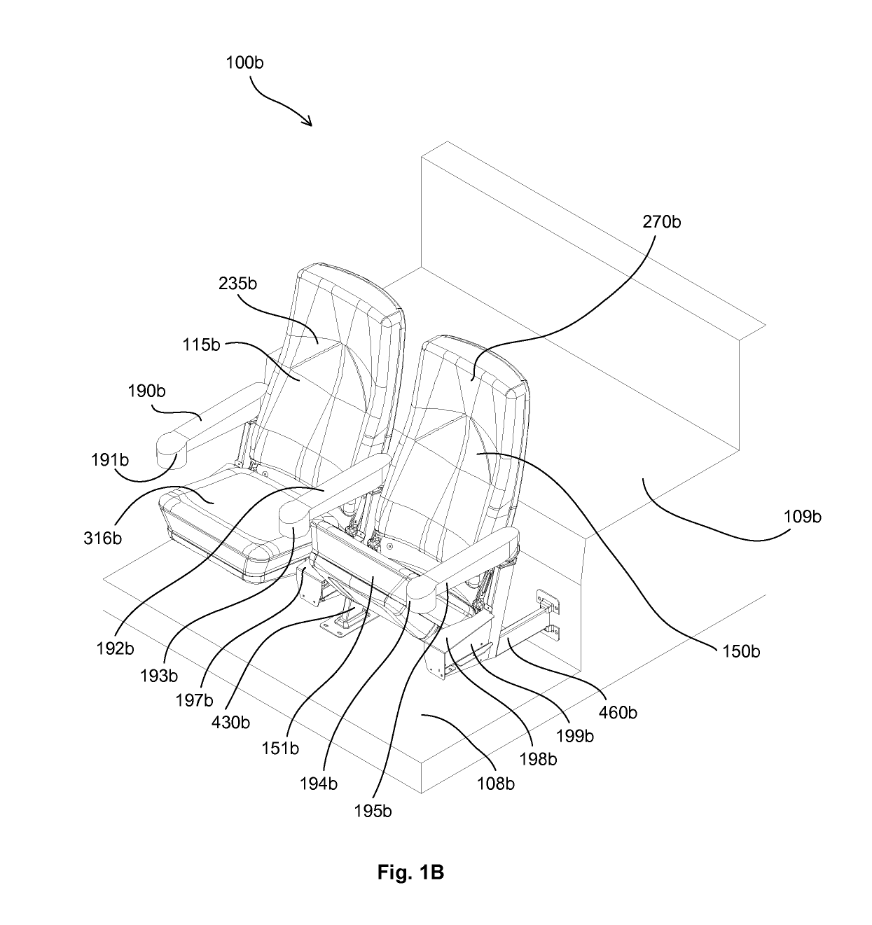

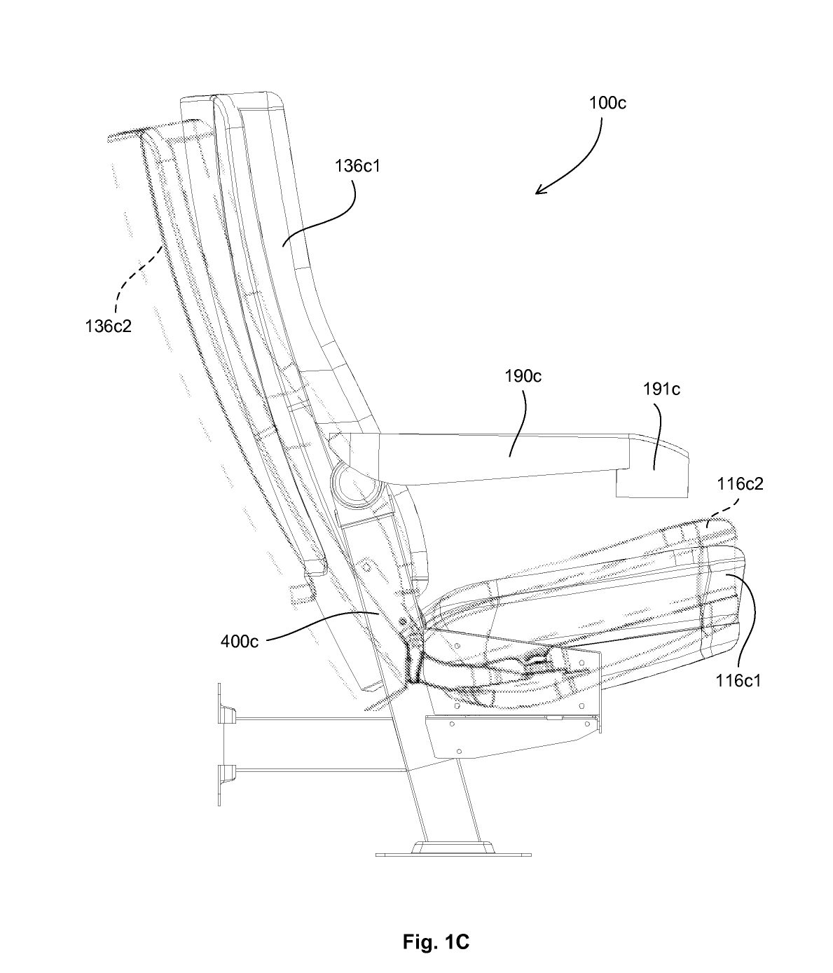

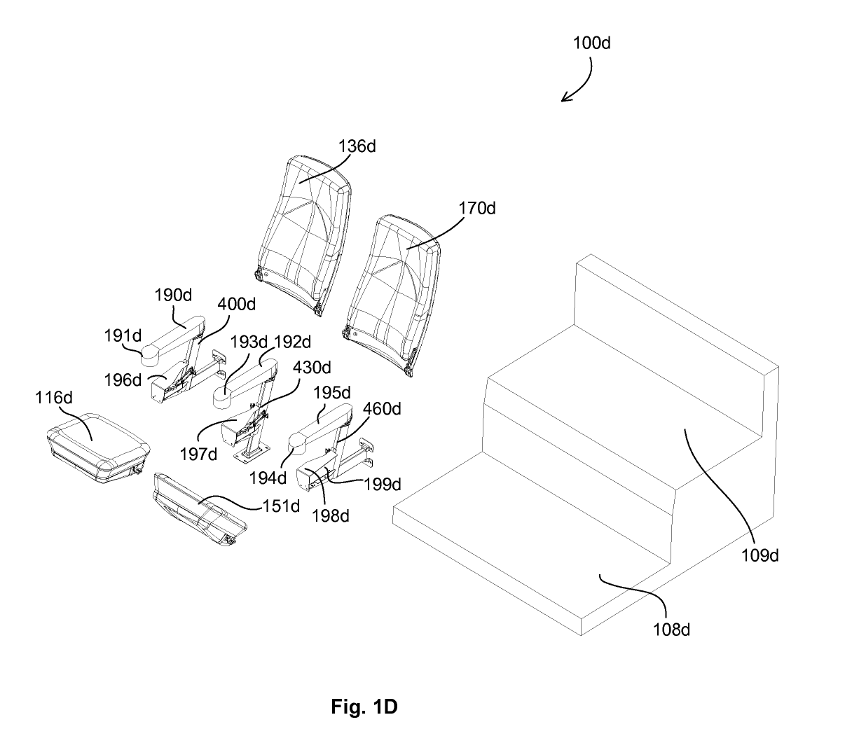

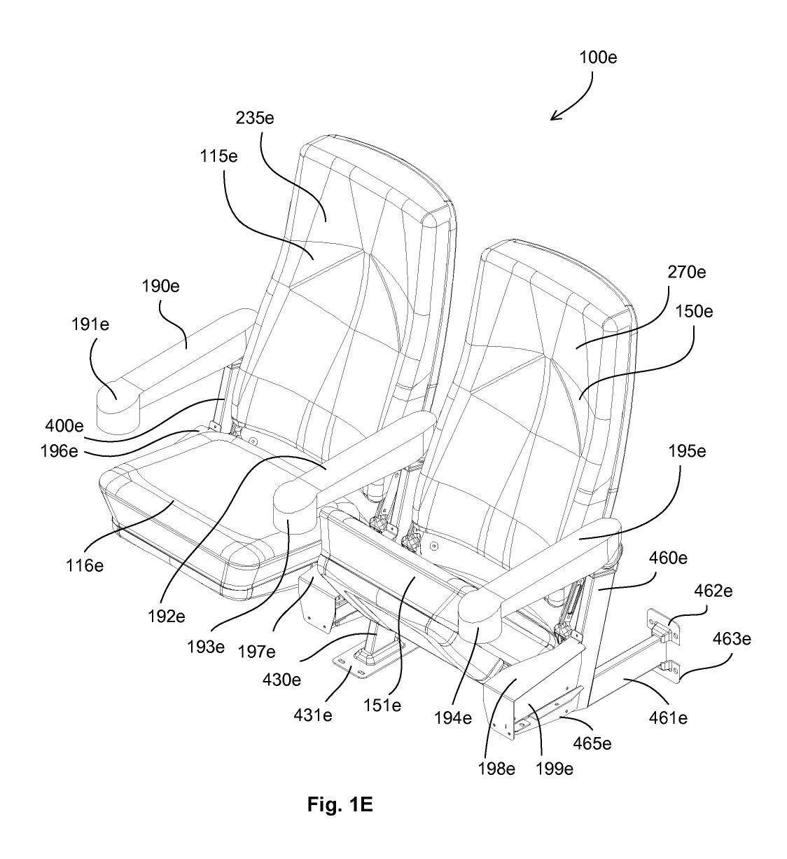

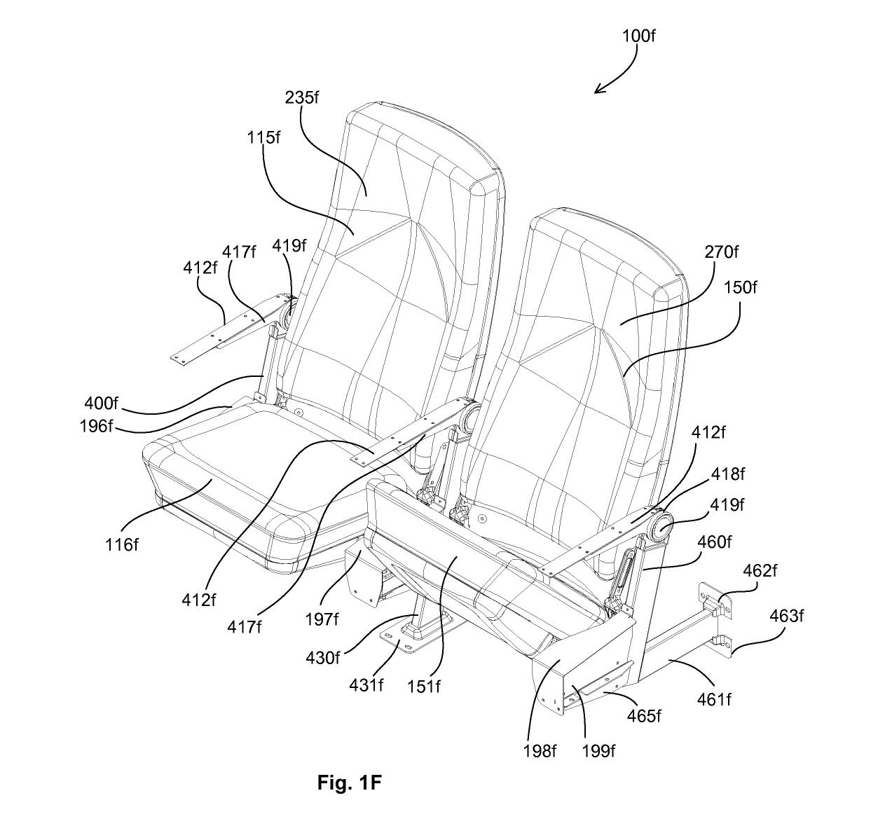

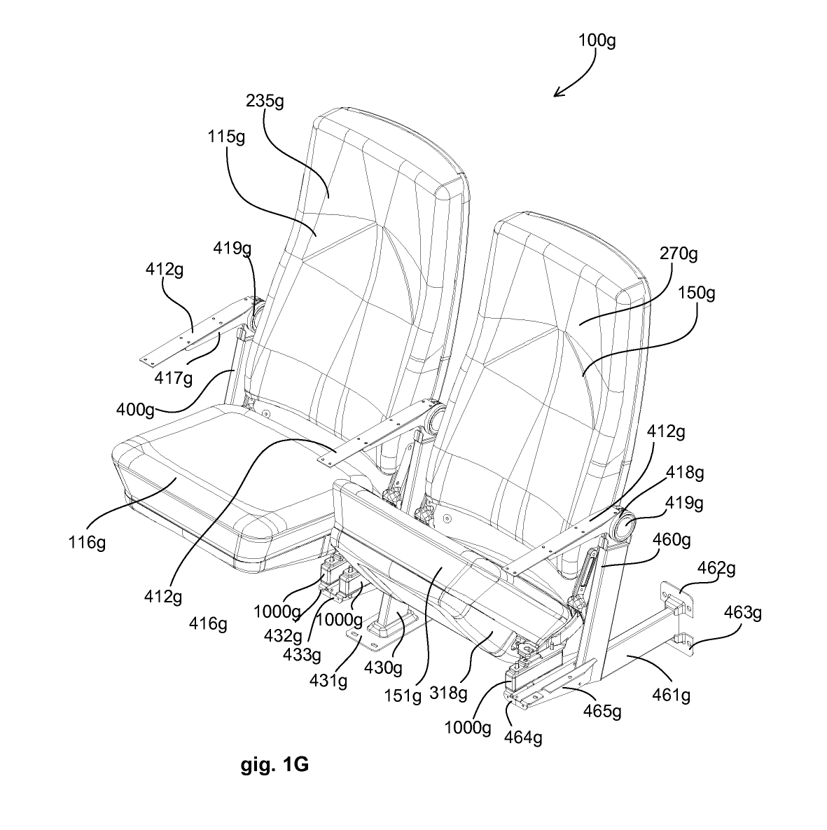

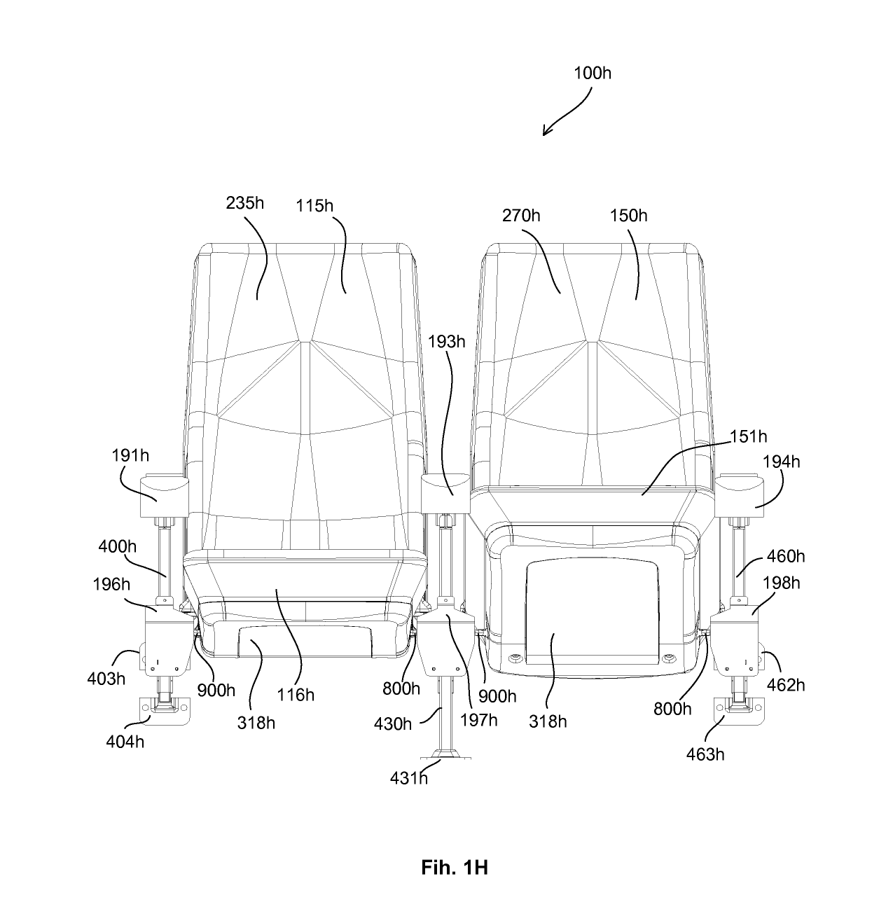

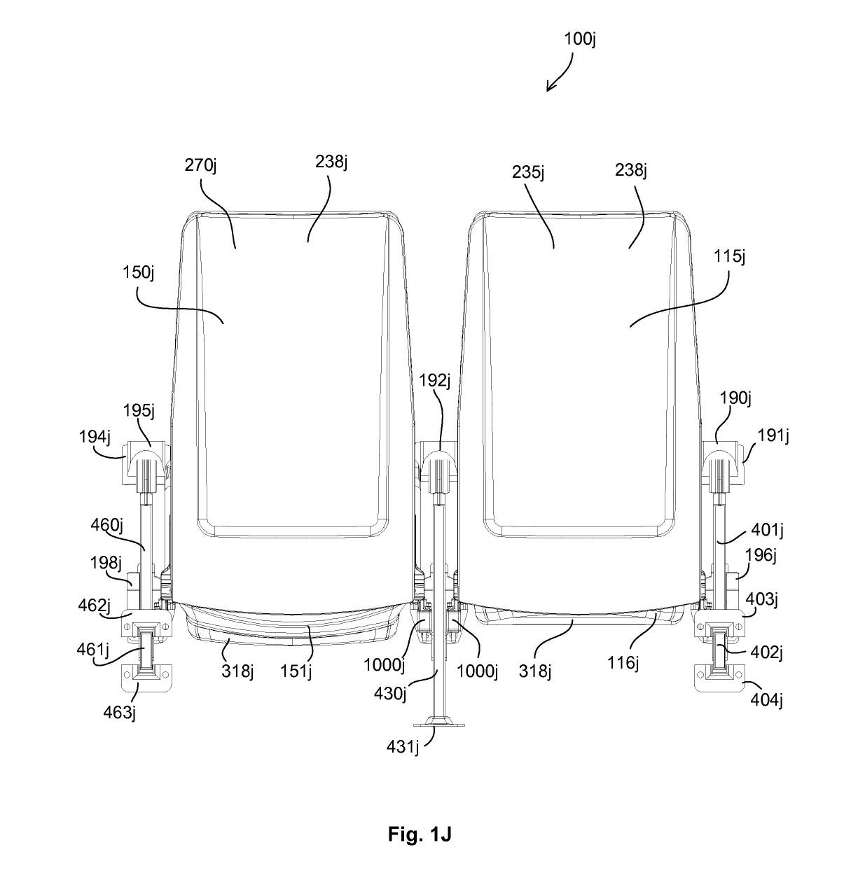

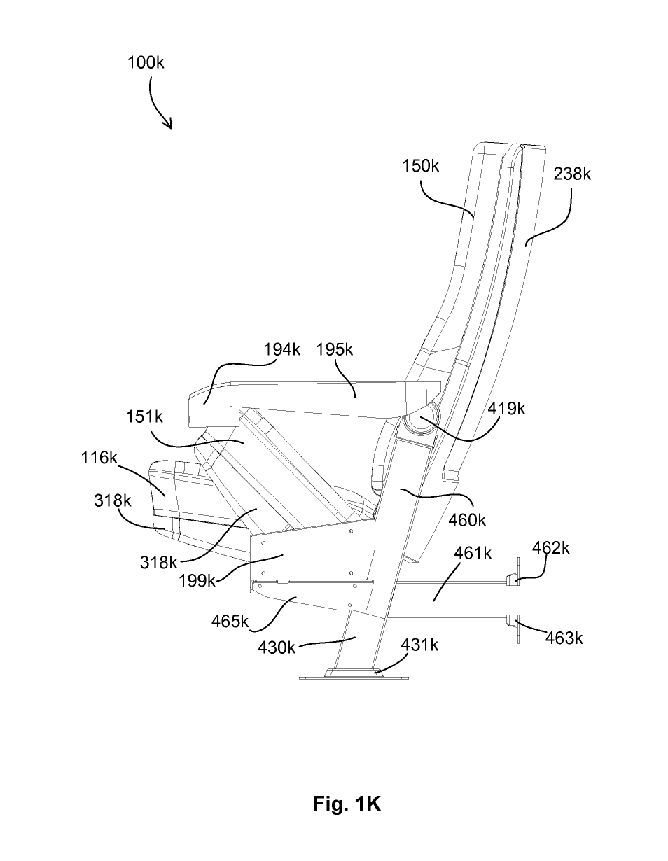

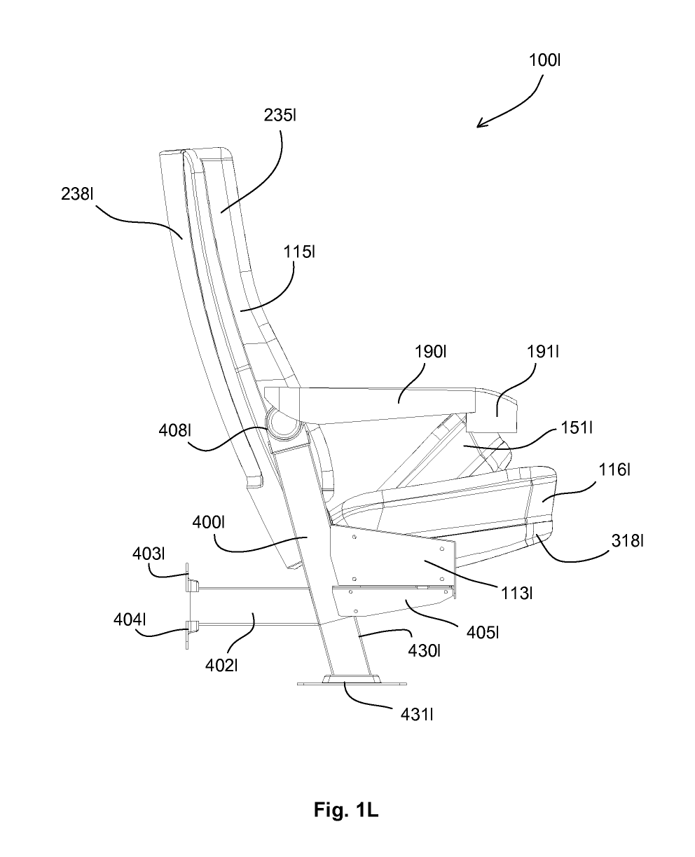

Turning to FIG. 1A, a plan view of an example rocker style chair installation 100a is depicted. The installation 100a may include a first section 101a, a second section 102a and a third section 103a. The installation 100a may further include a first isle 104a between the sections 101a, 102a and a second isle 104a between the sections 102a, 103a. While the installation 100a of FIG. 1A is depicted to include three sections 101a, 102a, 103a and two isles 104a, any given installation may include more, or less sections and/or isles than are shown in FIG. 1A. As further depicted in FIG. 1A, each section 101a, 102a, 103a may include a first row 105a, a second row 106a, a third row 107a, a fourth row 108a and a fifth row 109a. While the installation 100a of FIG. 1A is depicted to include five rows 105a, 106a, 107a, 108a, 109a, any given installation may include more, or less rows than are shown in FIG. 1A. As also depicted in FIG. 1A, any given row 105a, 106a, 107a, 108a, 109a, within any given section 101a, 102a, 103a may include eight or ten individual rocker style chairs 115a, 150a. While the installation 100a of FIG. 1A is depicted to include either eight or ten individual rocker style chairs 115a, 150a within any given row 105a, 106a, 107a, 108a, 109a, within any given section 101a, 102a, 103a, any given installation may include more, or less individual rocker style chairs 115a, 150a within any given row. Details of the individual rocker style chairs 115a, 150a, related modular components and individual parts are described herein.

With further reference to FIG. 1A, the installation 100a may include a plurality of power and, or data outlets 110a with interconnections 111a. For example, each rocker style chair 115a, 150a may include a power and/or data outlet 110a such that each chair occupant has her own power and/or data outlet 110a. Alternatively, a power and/or data outlet 110a may be centrally located proximate two or more rocker style chairs 115a, 150a such that two or more chair occupants may share the centrally located power and/or data outlet 110a.

Turning to FIG. 1B, a perspective view of two example rocker style chairs 115b, 150b with pivoting seats is depicted within an installation 100b. While the rocker style chairs 115b, 150b of FIG. 1B include pivoting seats, any given rocker style chair 115b, 150b may include a non-pivoting seat. The installation 100b may be similar to the installation 100a. The installation 100b may include a second row 109b that is elevated with respect to a first row 108b. While the installation 100b of FIG. 1B is depicted to include two rows 108b, 109b, the installation 100b may include any number of rows. Furthermore, the rows 105a, 106a, 107a, 108a, 109a of FIG. 1A may be elevationally arranged with respect to one another similar to the rows 108b, 109b of FIG. 1B.

With further reference to FIG. 1B, the first rocker style chair 115a may include a chair seat 316b, a chair back 235b, a right-hand arm rest 190b with a cup holder 191b. The first rocker style chair 115b may be supported by a center standard 430b and a right-hand standard (not shown in FIG. 1B). The center standard 430b may include a debris cover 197b. The chair seat 316b is depicted in a position reflecting an occupant within the rocker style chair 115b. The second rocker style chair 150b may include a chair seat 151b, a chair back 270b, a left-hand arm rest 195b with a cup holder 194b. The chair seat 151b is depicted in a position reflecting no occupant within the rocker style chair 150b (i.e., as described in detail herein the chair seat 151b automatically pivots upward to increase chair access space). The second rocker style chair 150b may be supported by a center standard 430b and a left-hand standard 460b. The left-hand standard 460b may include a debris cover 198b and end cover 199b. The debris covers 197b, 198b and end cover 199b may prevent accumulation of debris in, and around a related rocker spring and related components, as well as, limiting occupant exposure to the rocker spring and related components.

Turning to FIG. 1C, a right-side, profile, view of an example rocker style chair 100c is depicted “rocking” between a first position 116c1, 136c1 and a second position 116c2, 136c2. The rocker style chair 100c may be similar to either of the rocker style chairs 115b, 150b of FIG. 1B. As can be seen in FIG. 1C, the standard 400c, the arm rest 190c and the cup holder 191c remain substantially stationary while the rocker style chair 100c rocks between the first position 116c1, 136c1 and a second position 116c2, 136c2.

Turning to FIG. 1D an exploded, perspective view of the two example rocker style chairs with pivoting seats 100d, similar to the rocker style chairs 115b, 150b of FIG. 1B, is depicted in proximity to an associated installation structure 108d, 109d. The two rocker style chairs with pivoting seats 100d may include a right-hand modular standard assembly 400d, a center modular standard assembly 430d, a left-hand modular standard assembly 460d, a first modular chair seat assembly 116d, a first modular chair back assembly 136d, a second modular chair seat assembly 151d and a second modular chair back assembly 170d. The right-hand modular standard assembly 400d may include a debris cover 196d, an arm rest 190d and a cup holder 191d. The center modular standard assembly 430d may include a debris cover 196d, an arm rest 192d and a cup holder 193d. The left-hand modular standard assembly 460d may include a debris cover 198d, an end cover 199d, an arm rest 195d and a cup holder 194d.

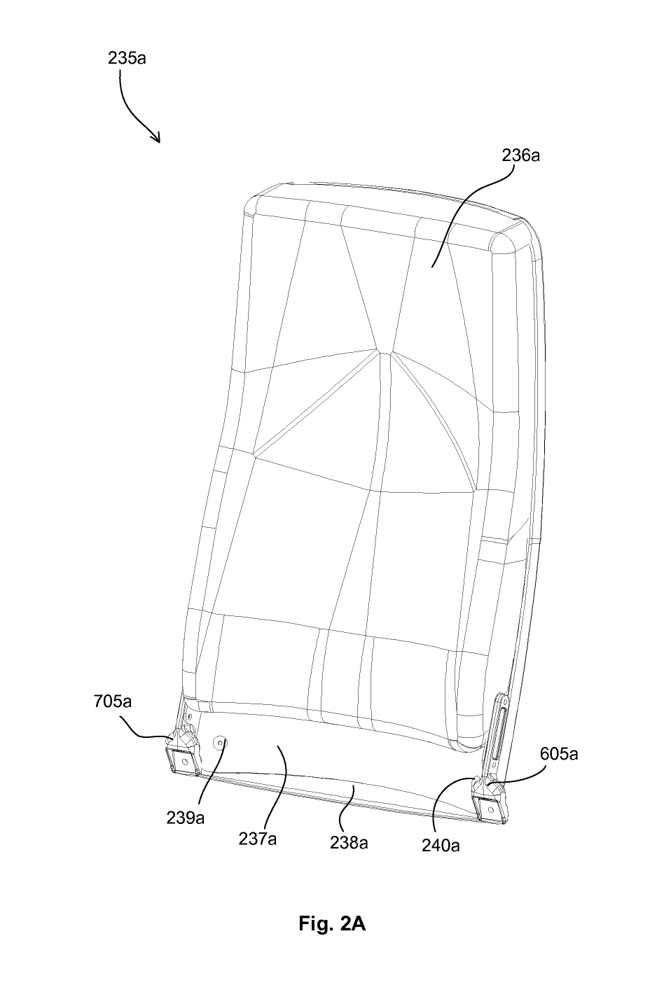

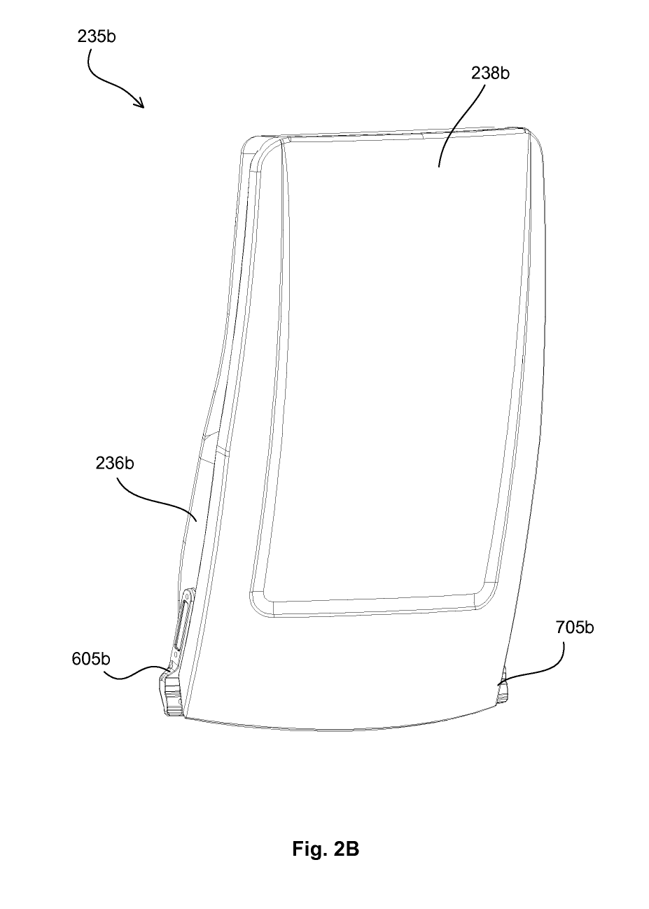

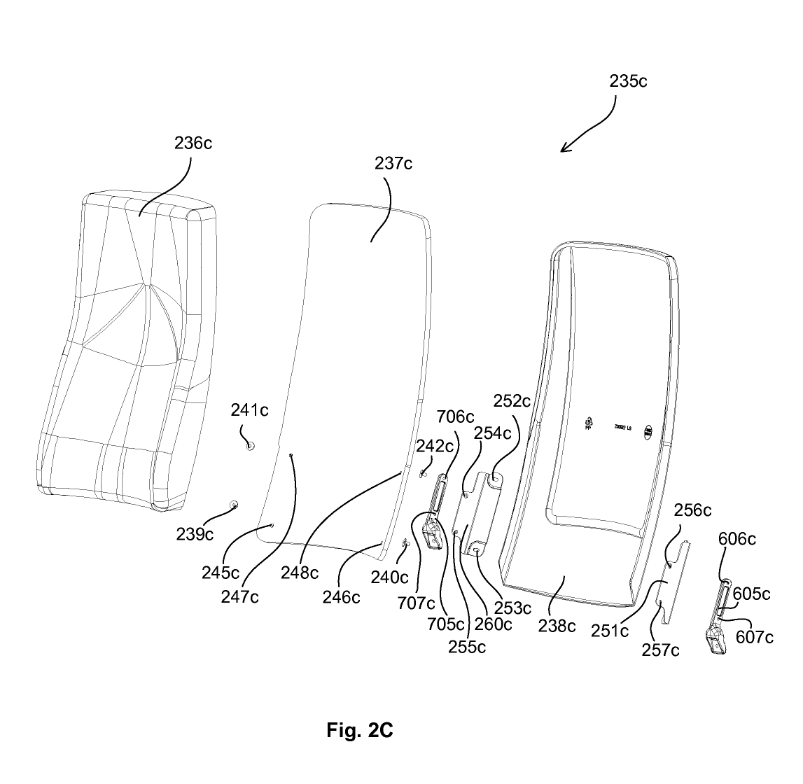

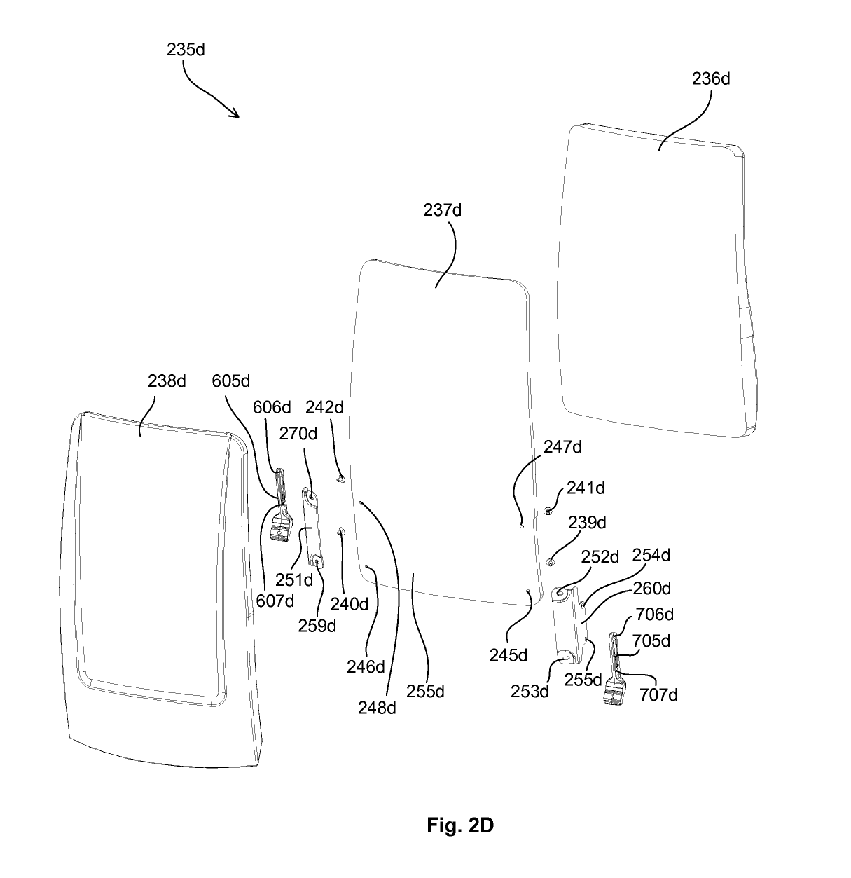

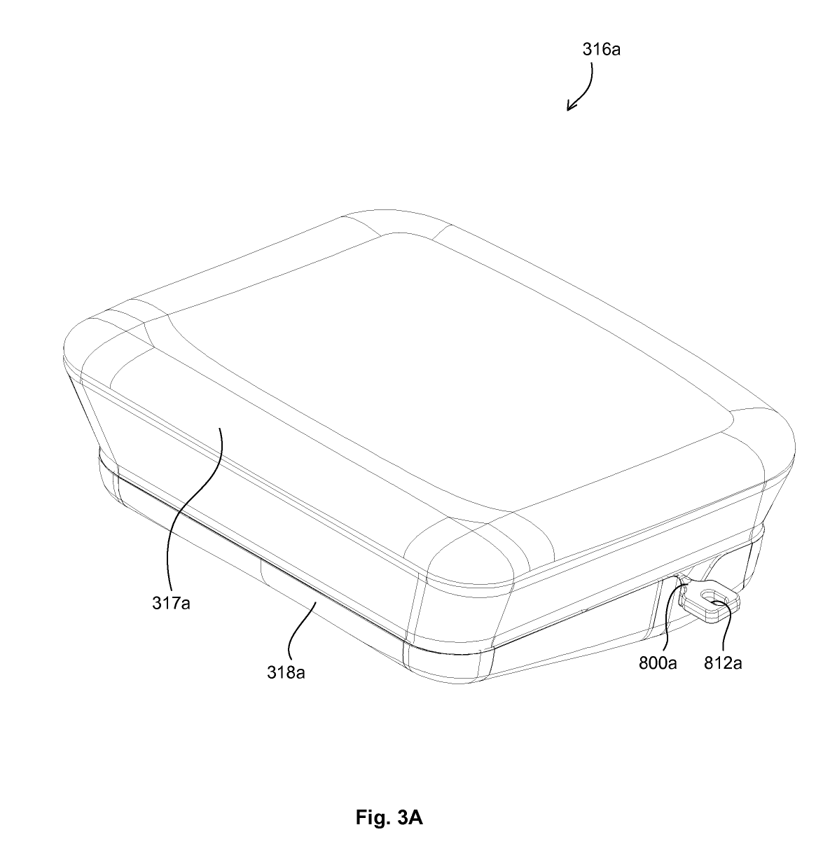

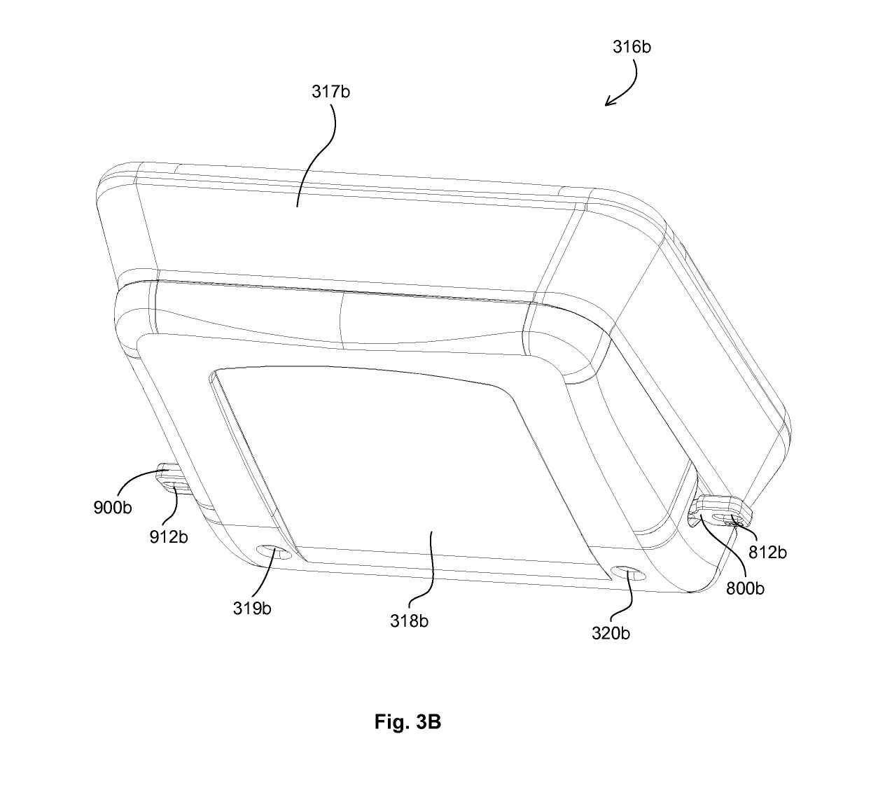

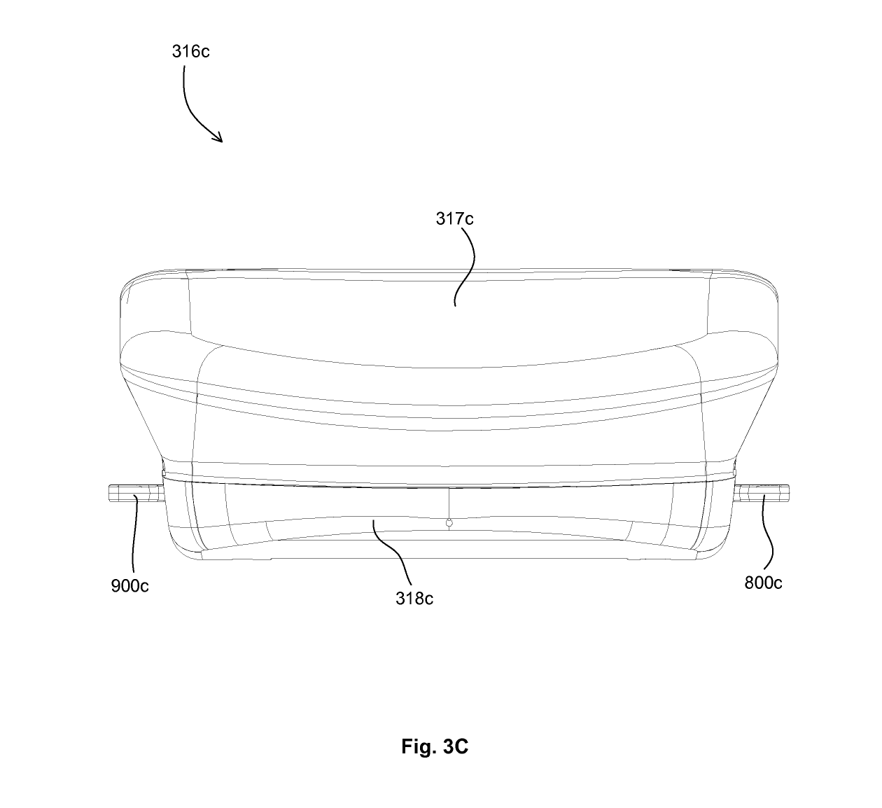

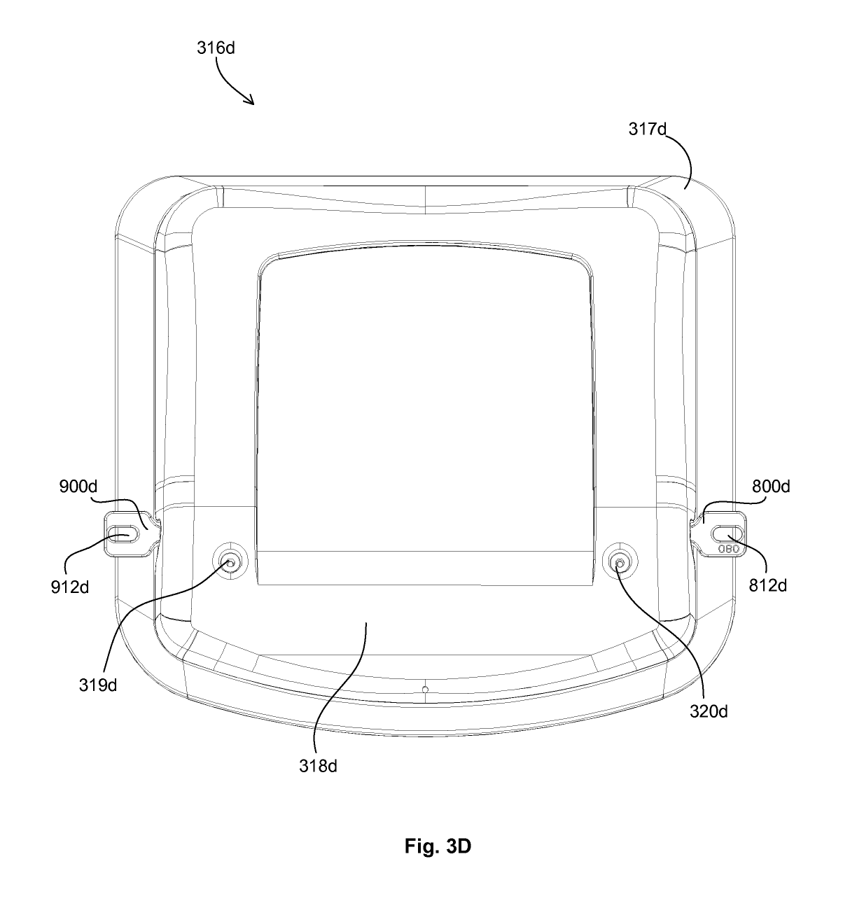

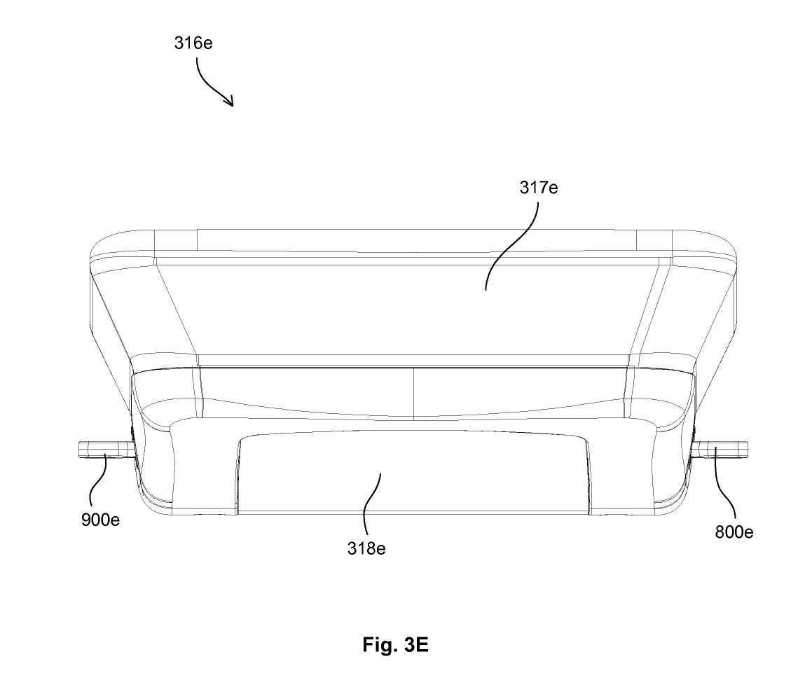

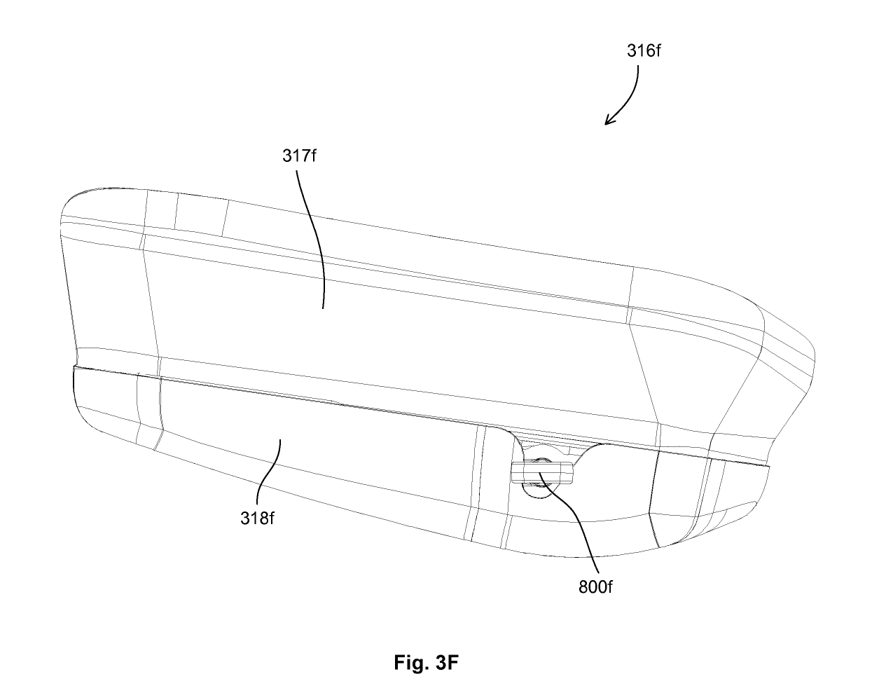

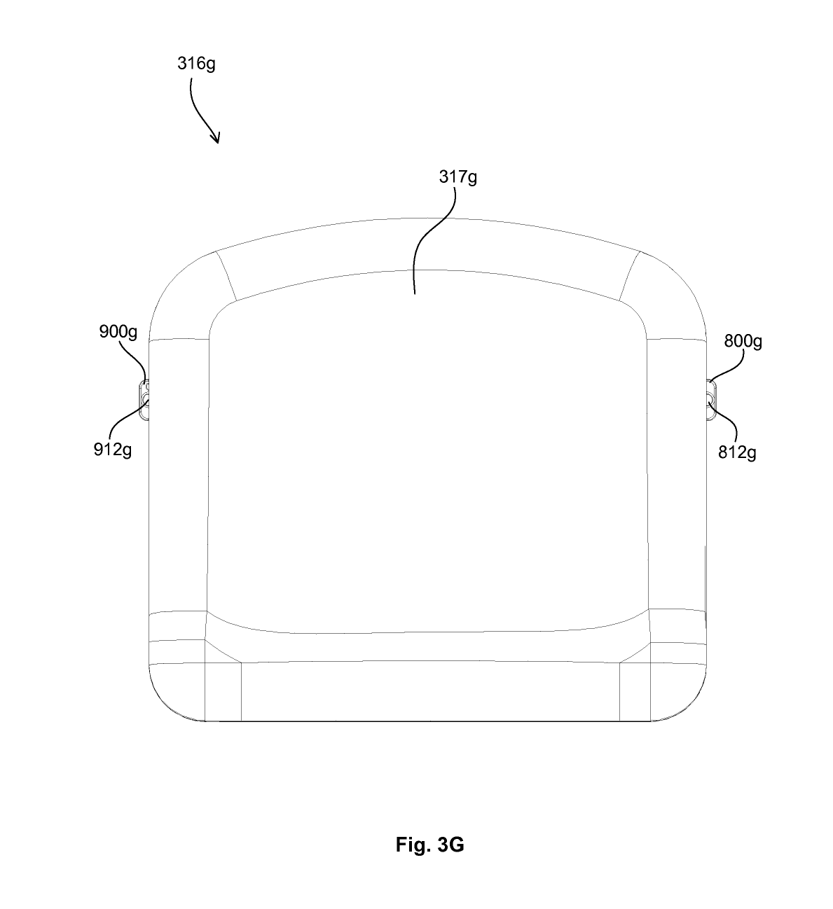

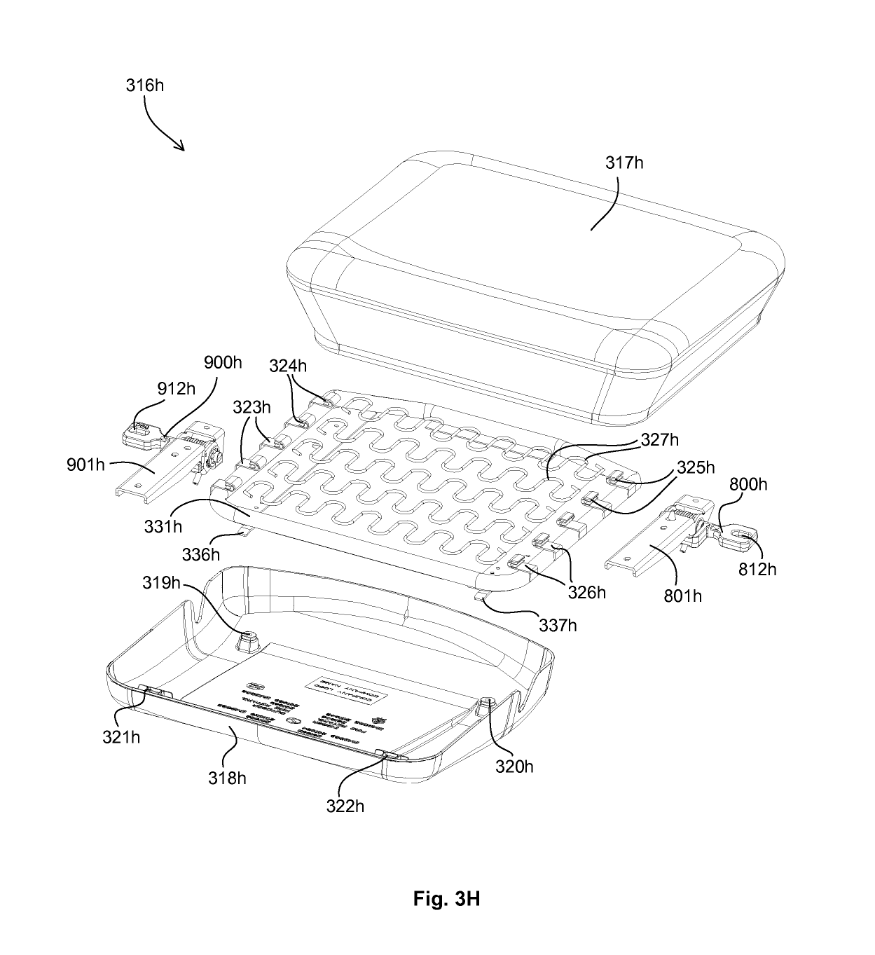

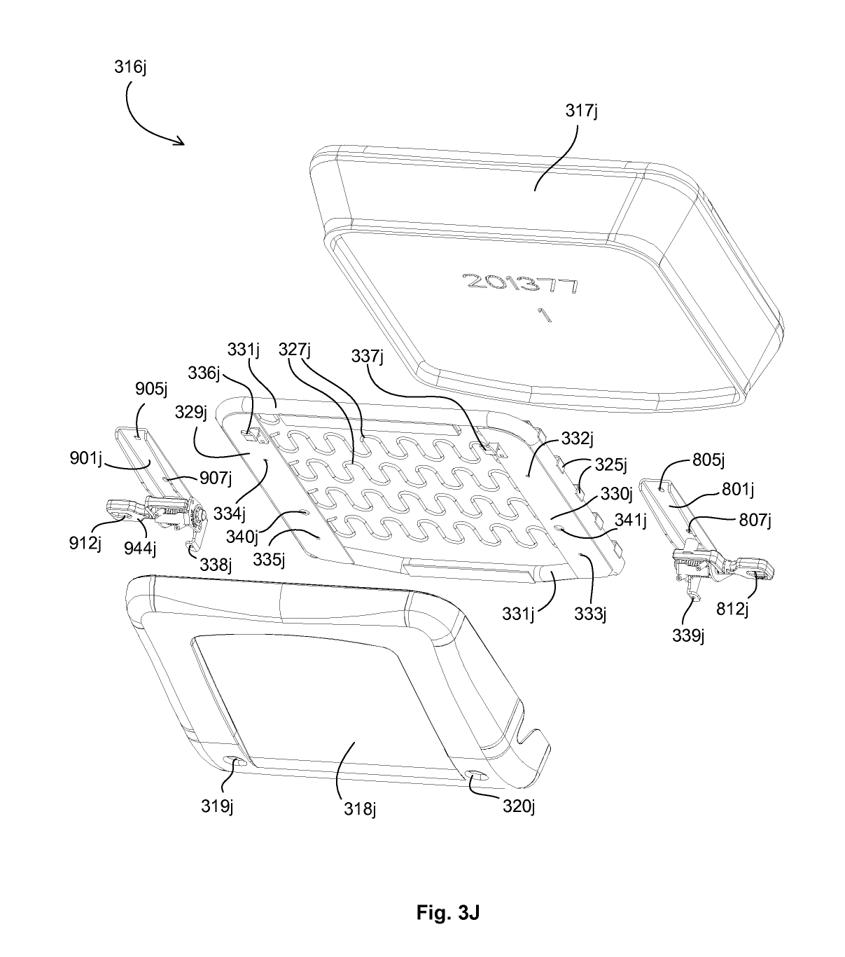

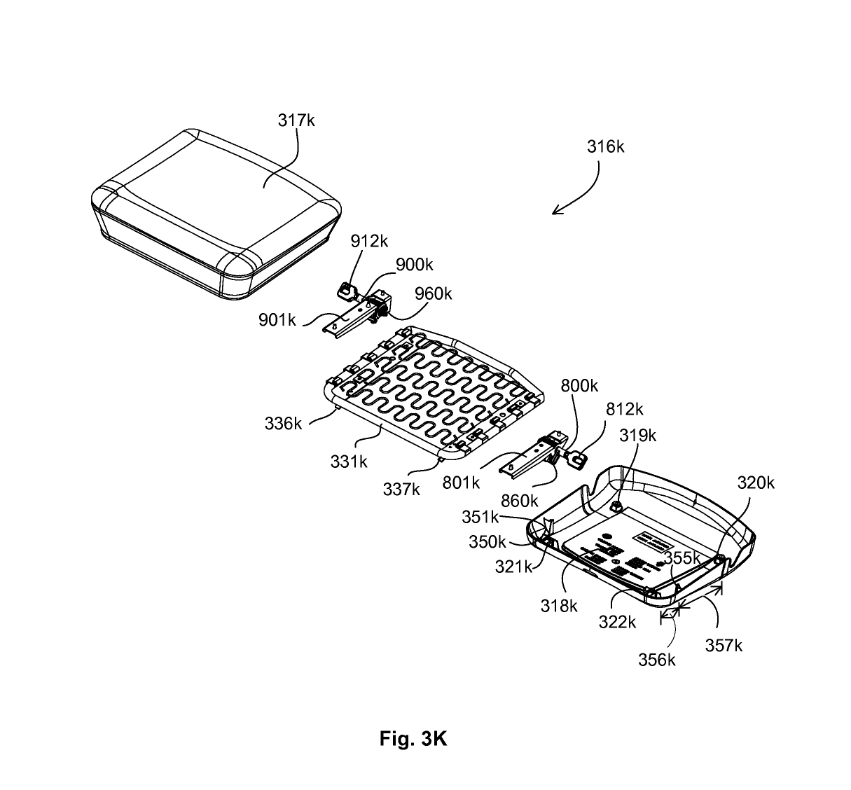

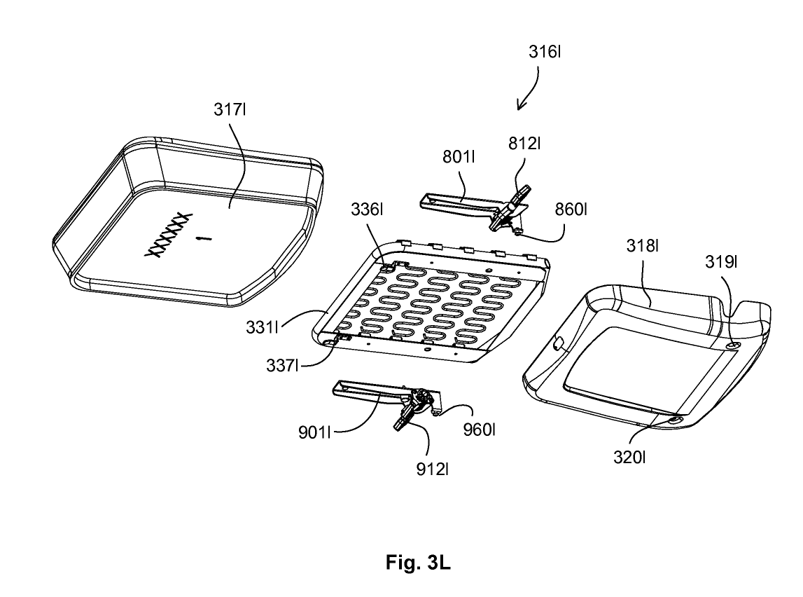

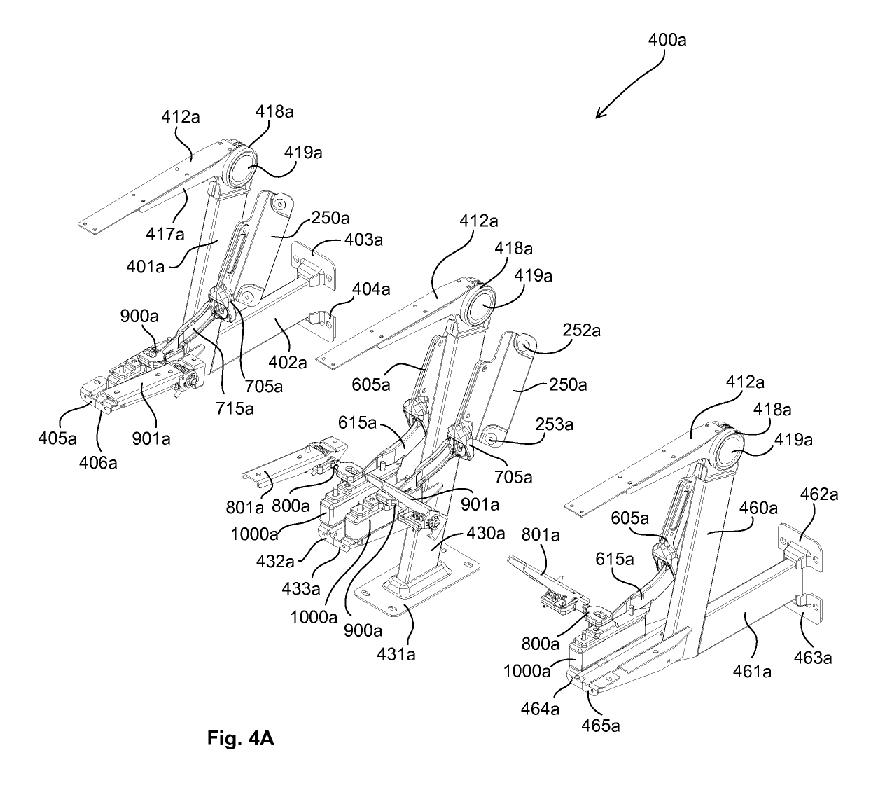

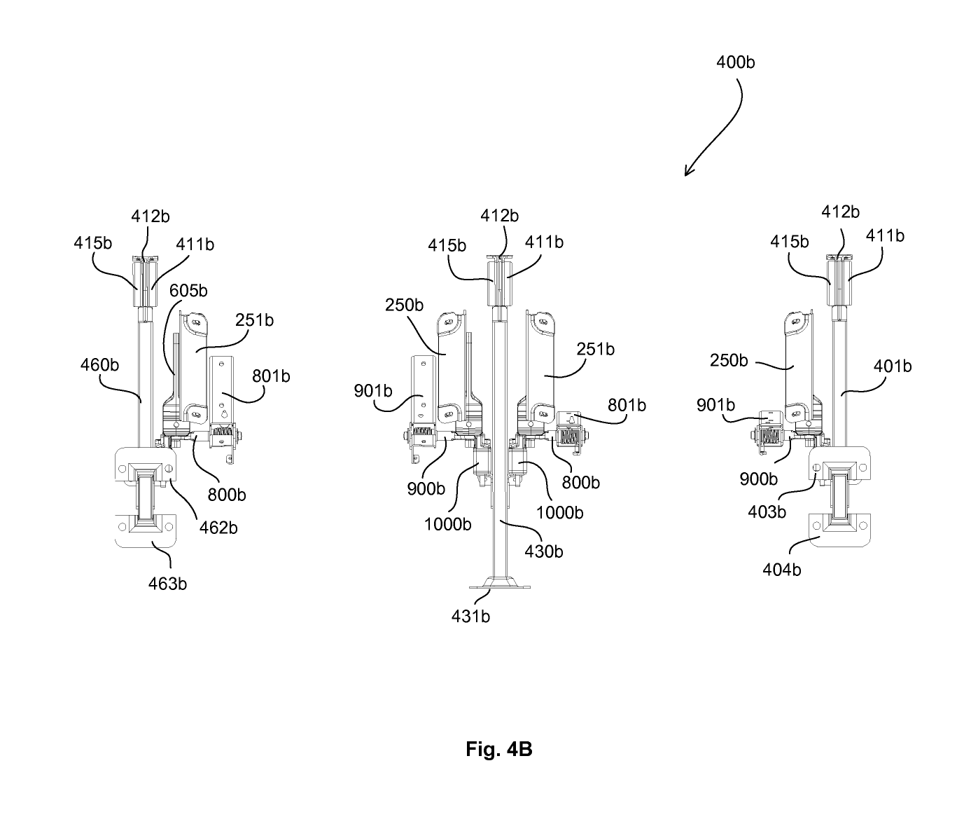

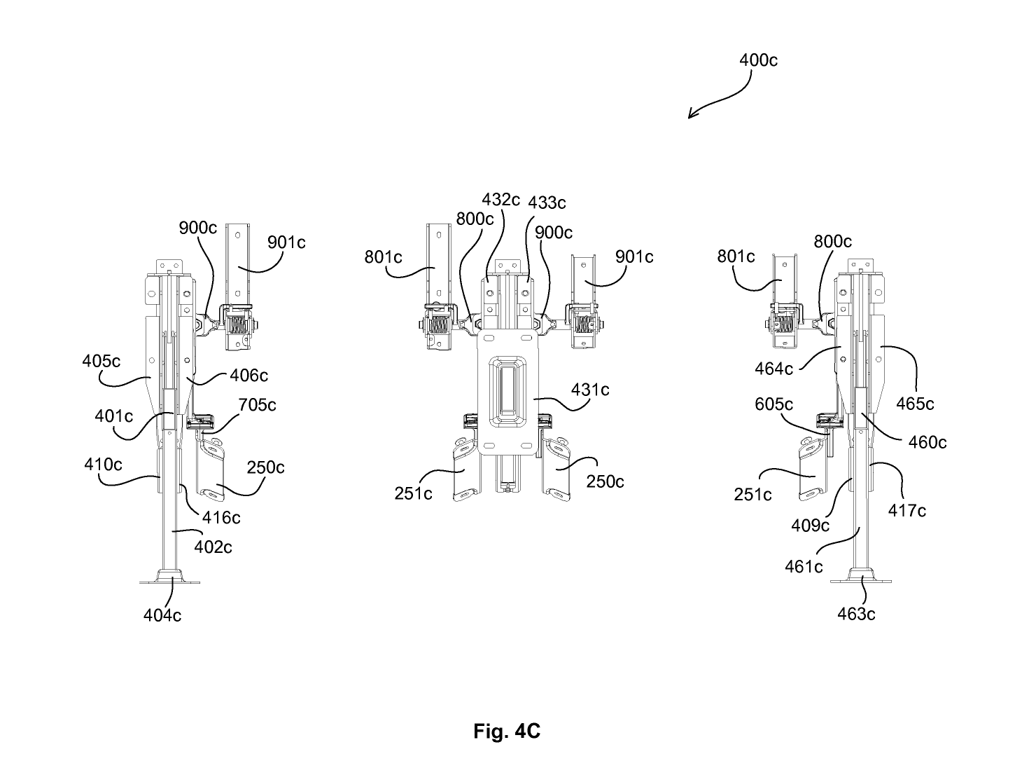

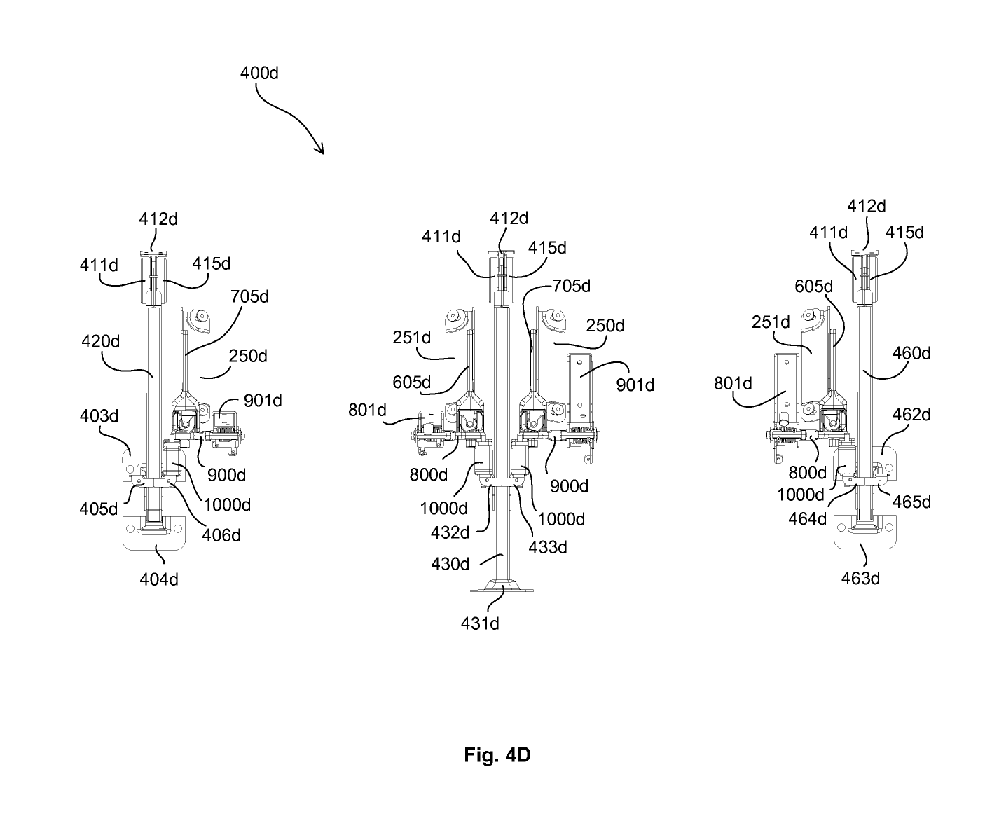

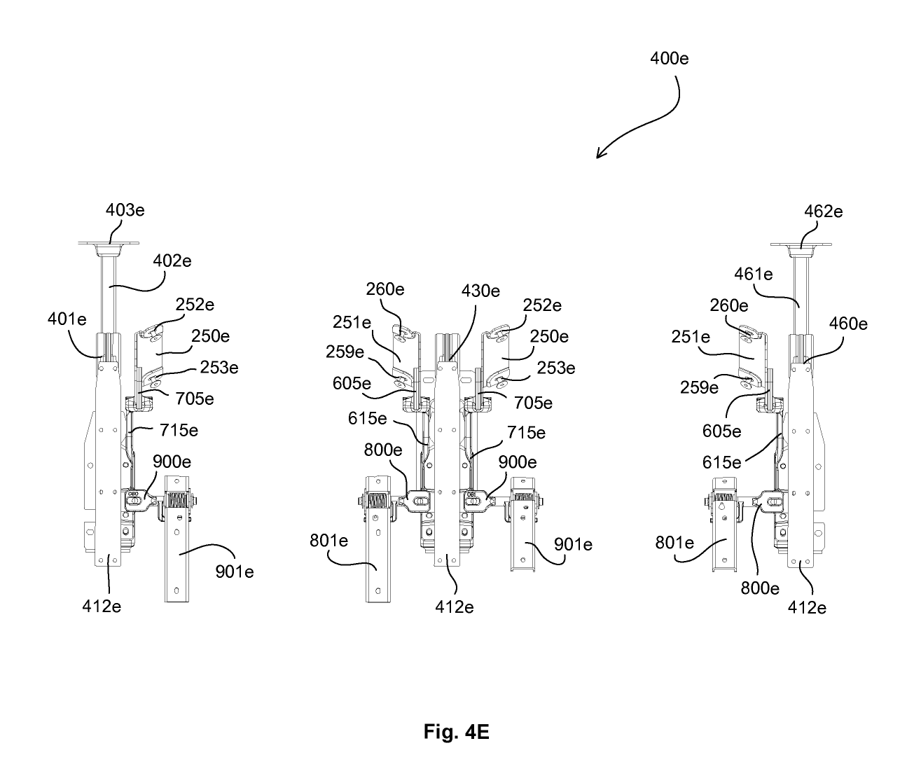

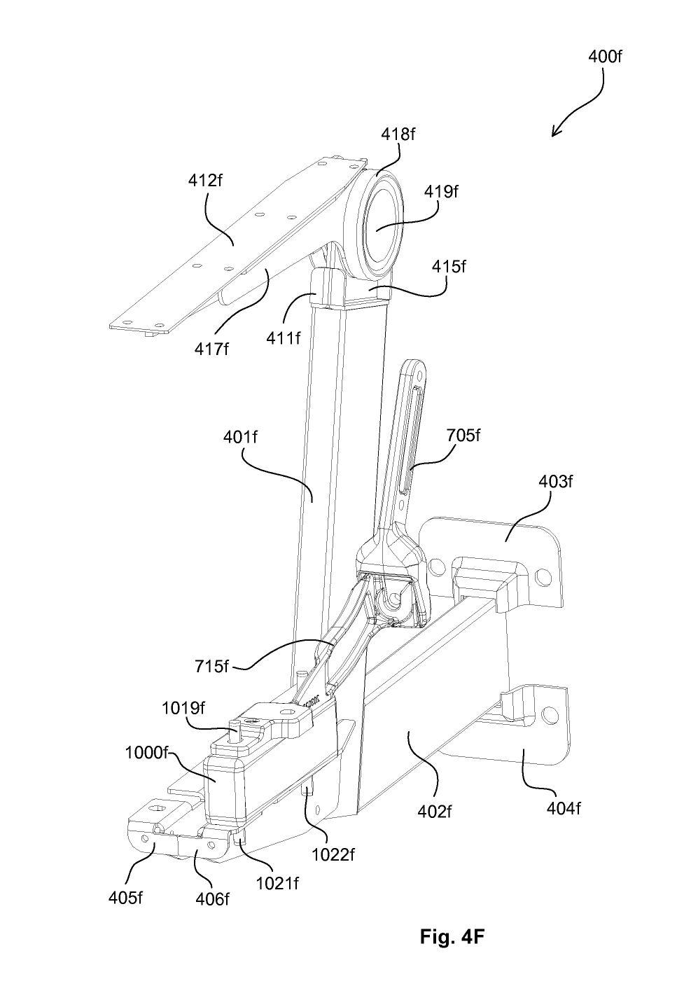

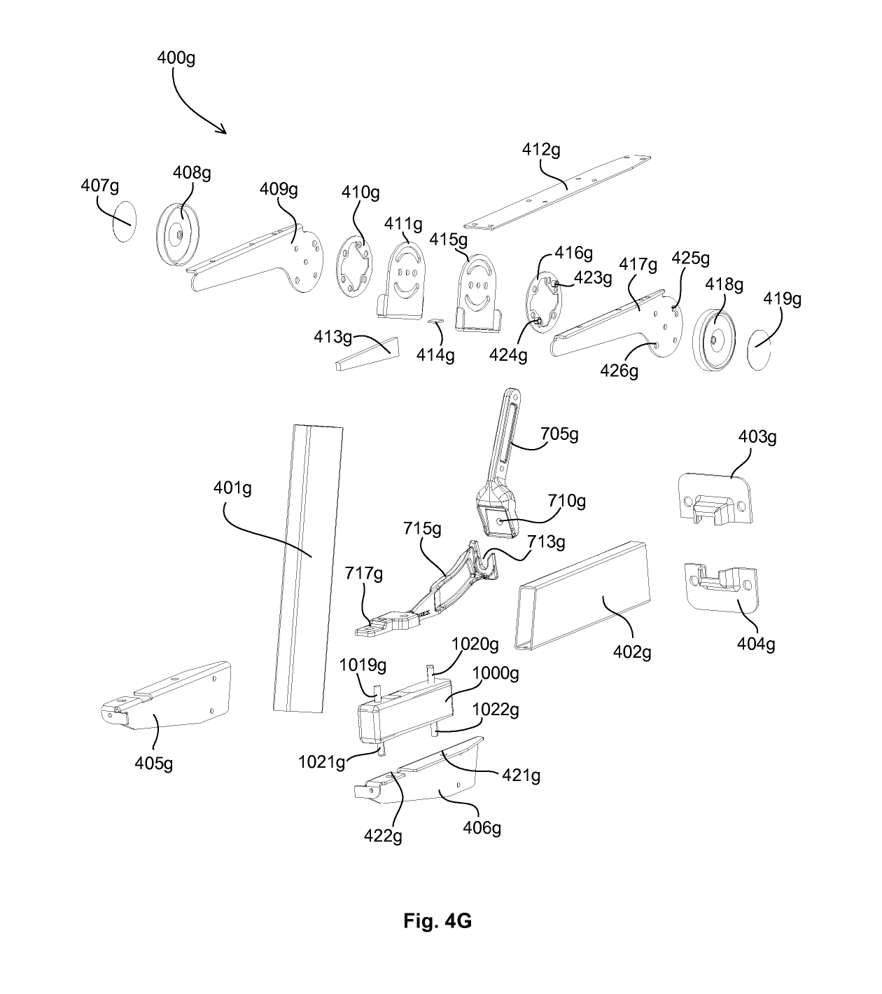

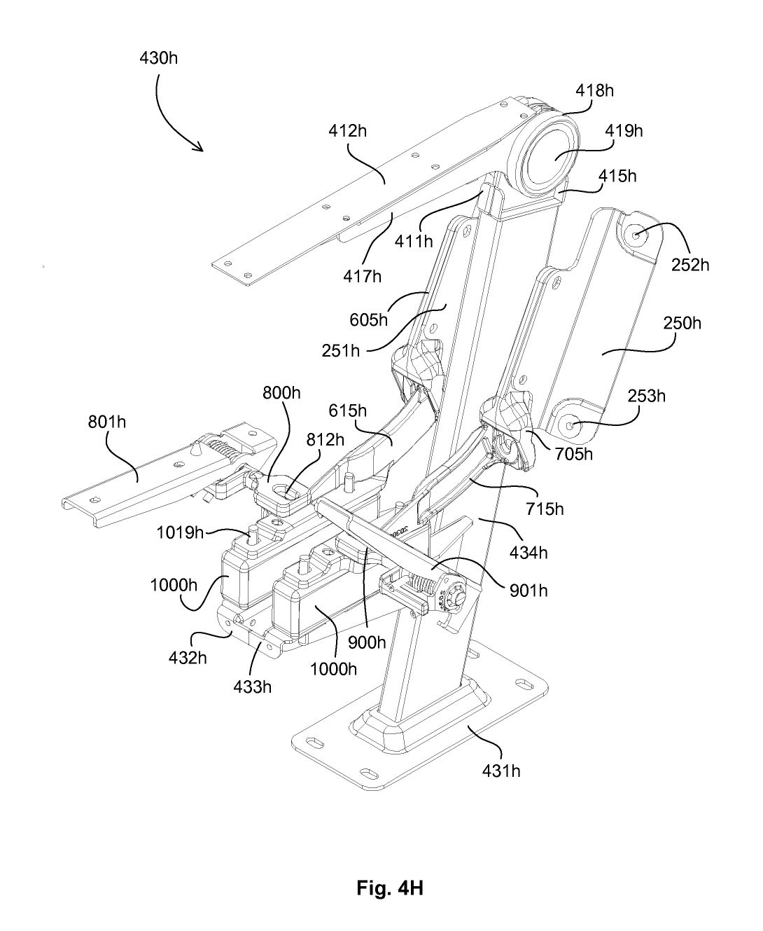

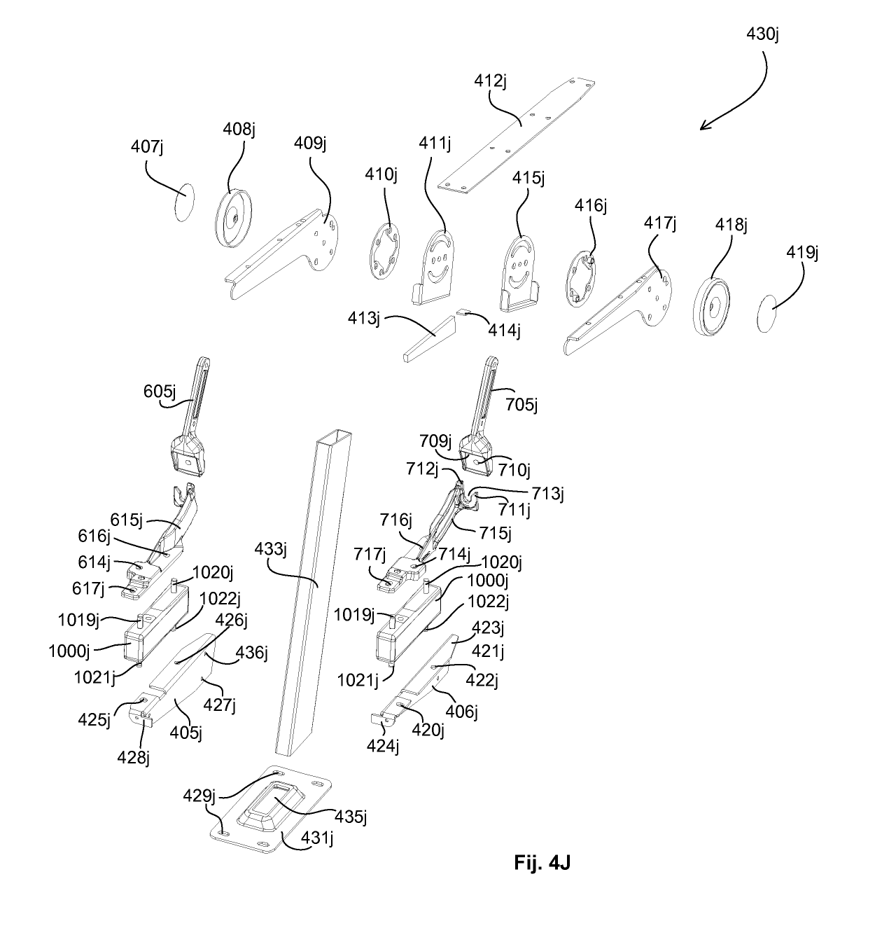

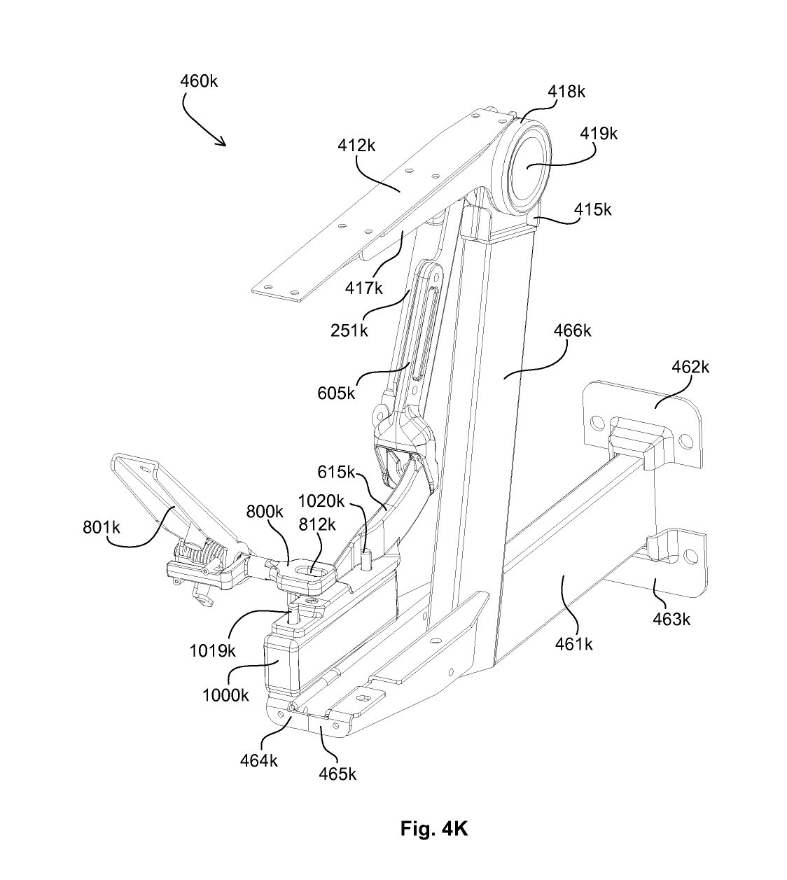

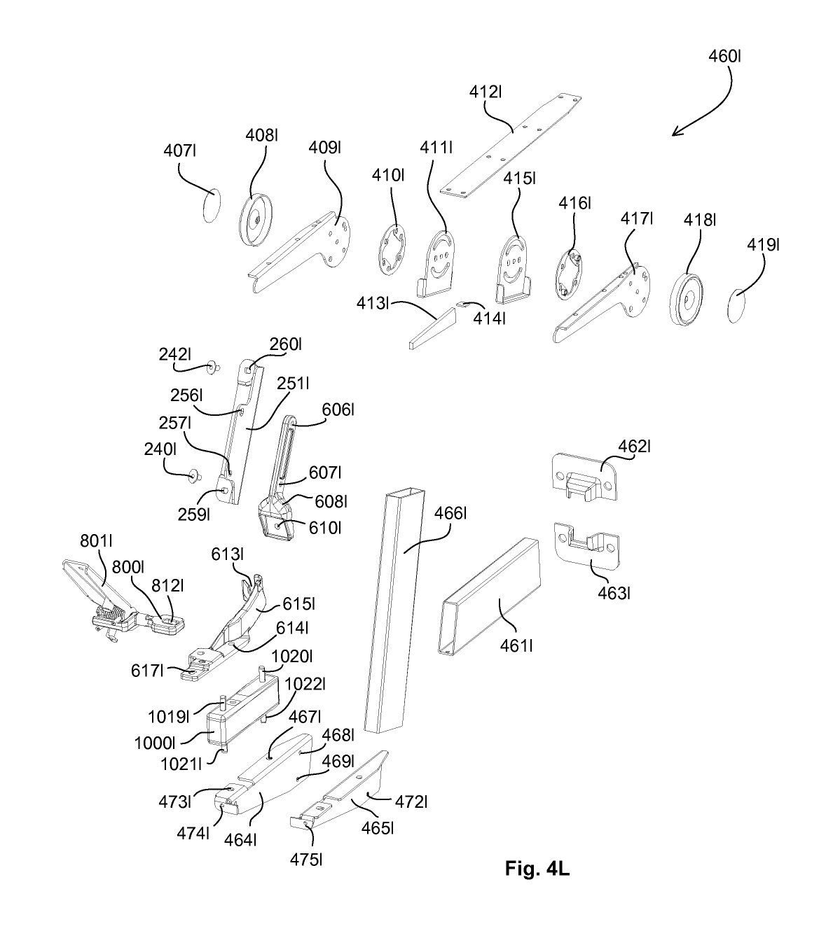

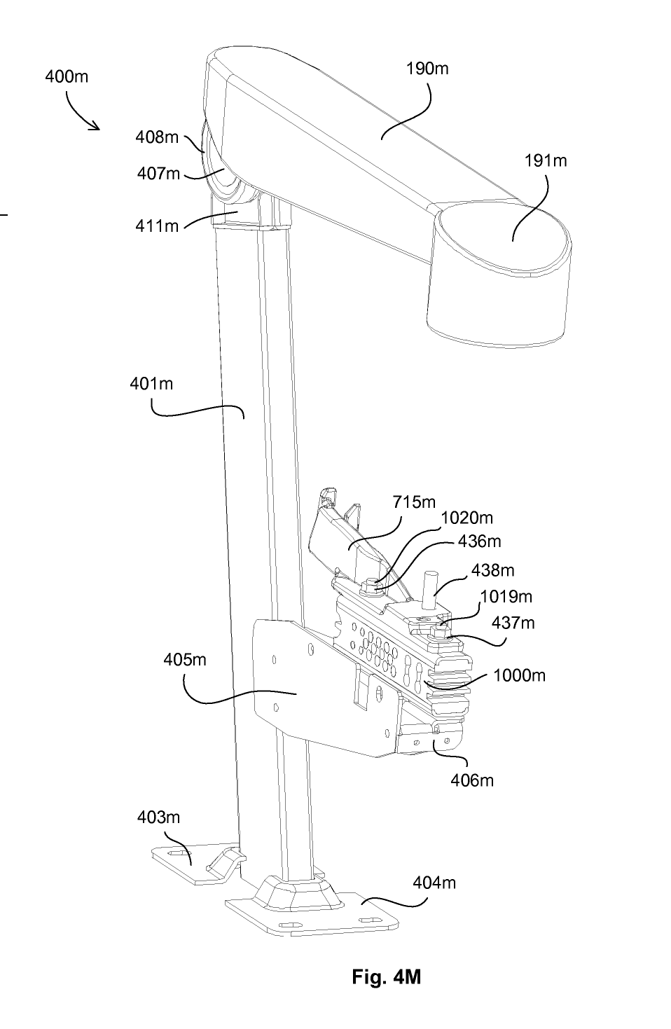

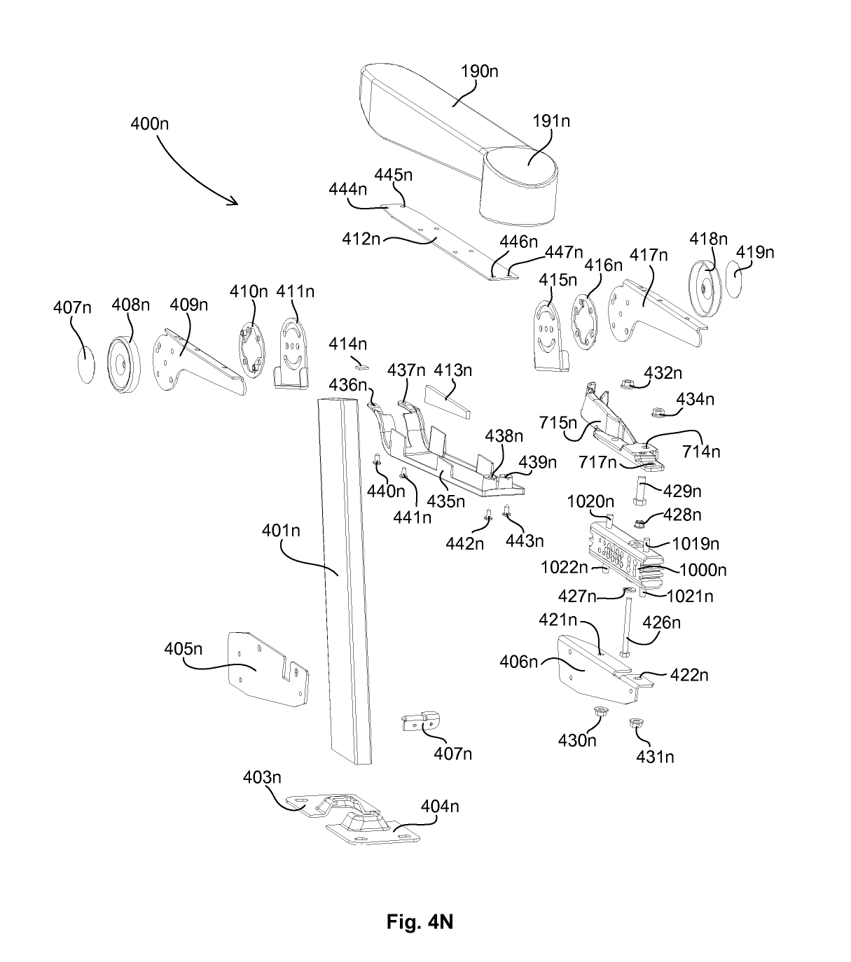

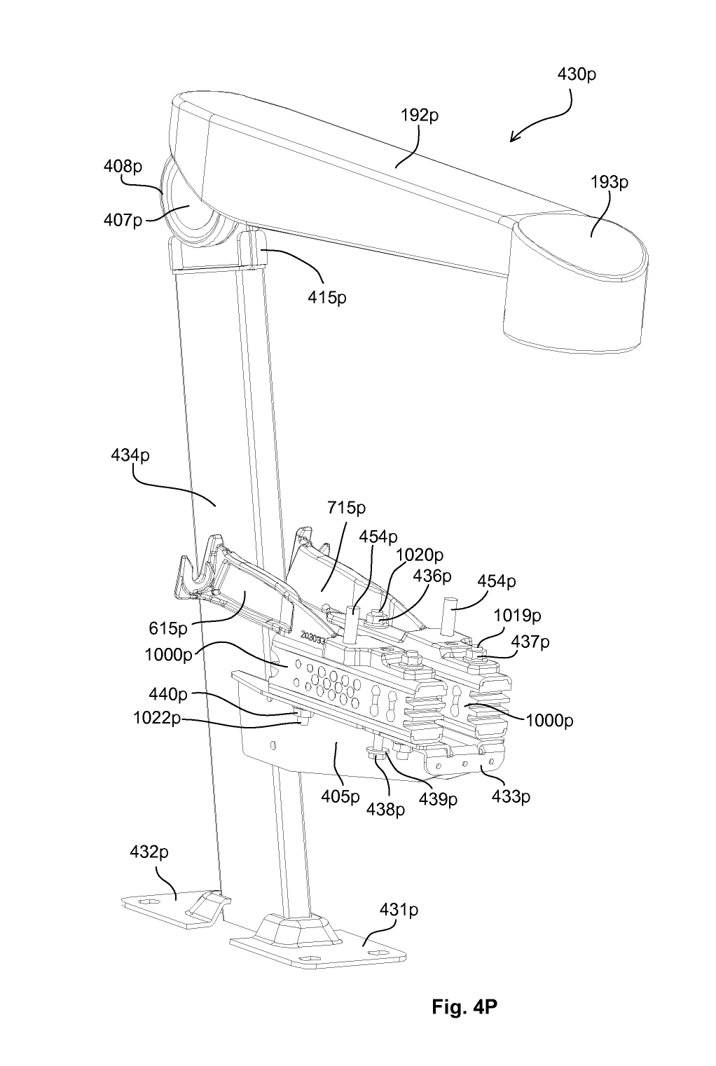

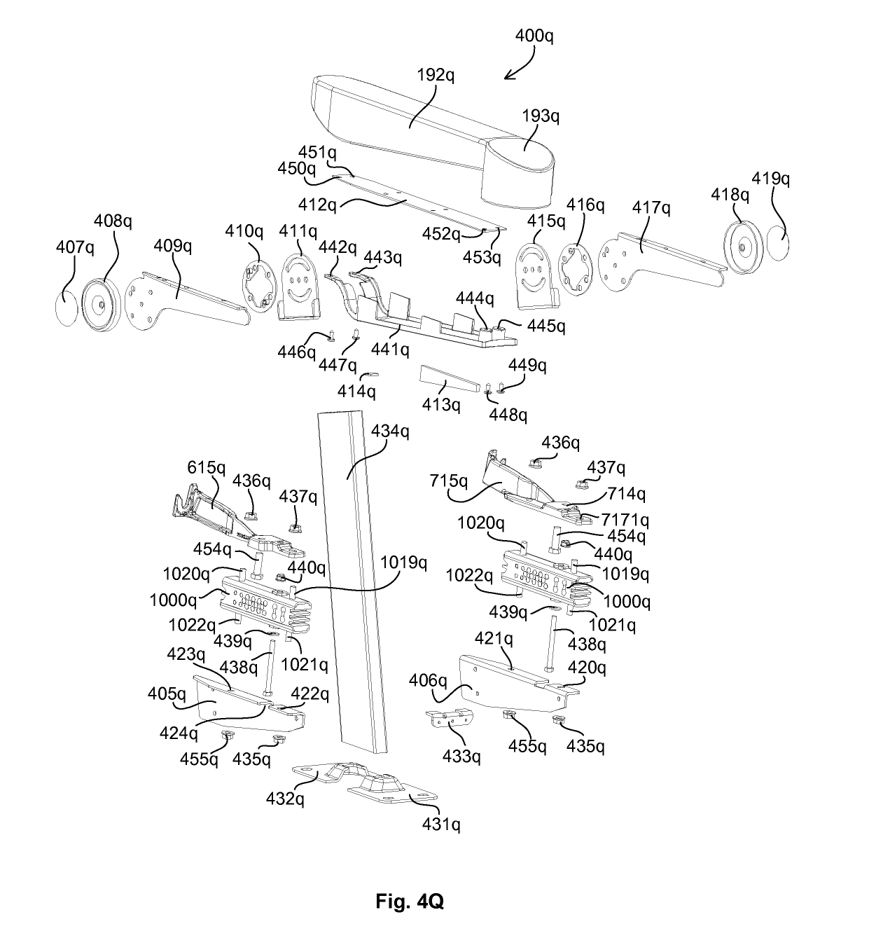

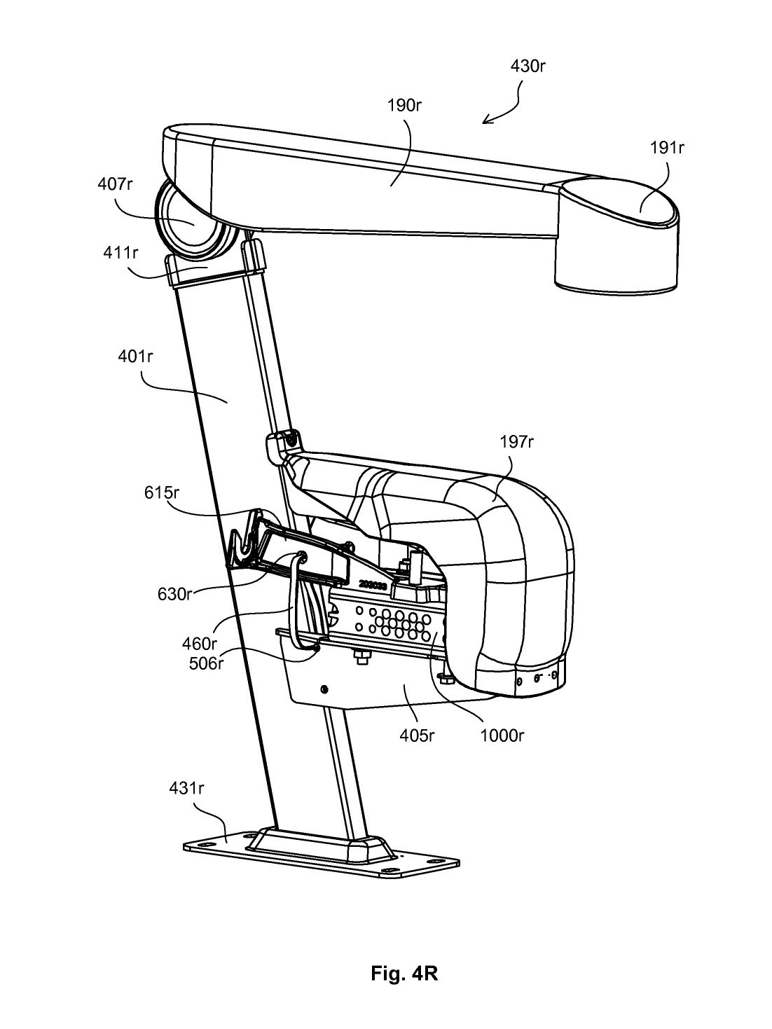

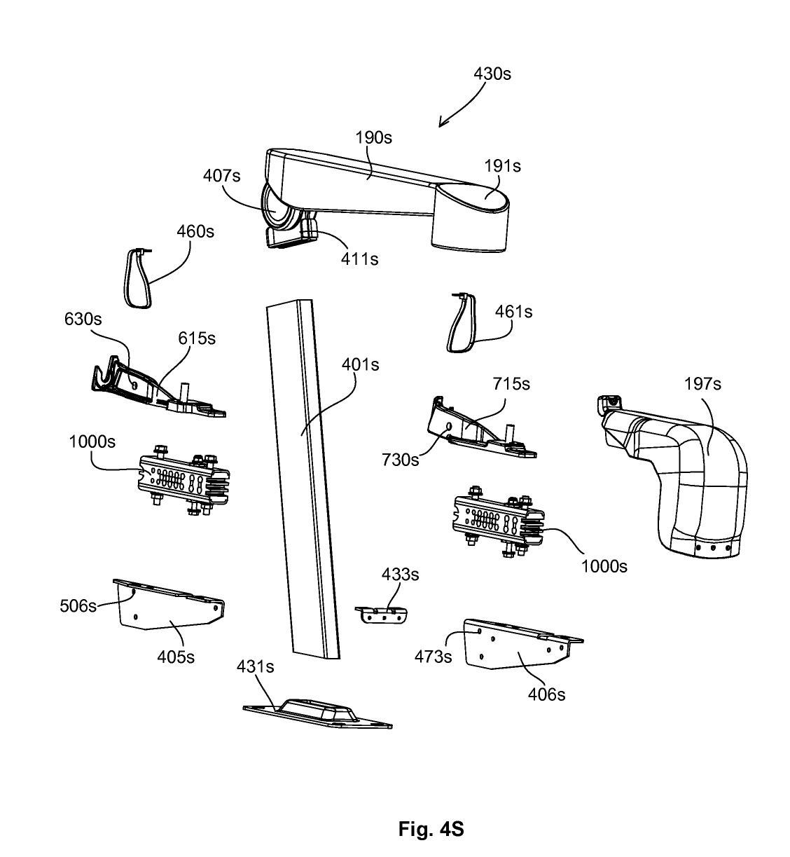

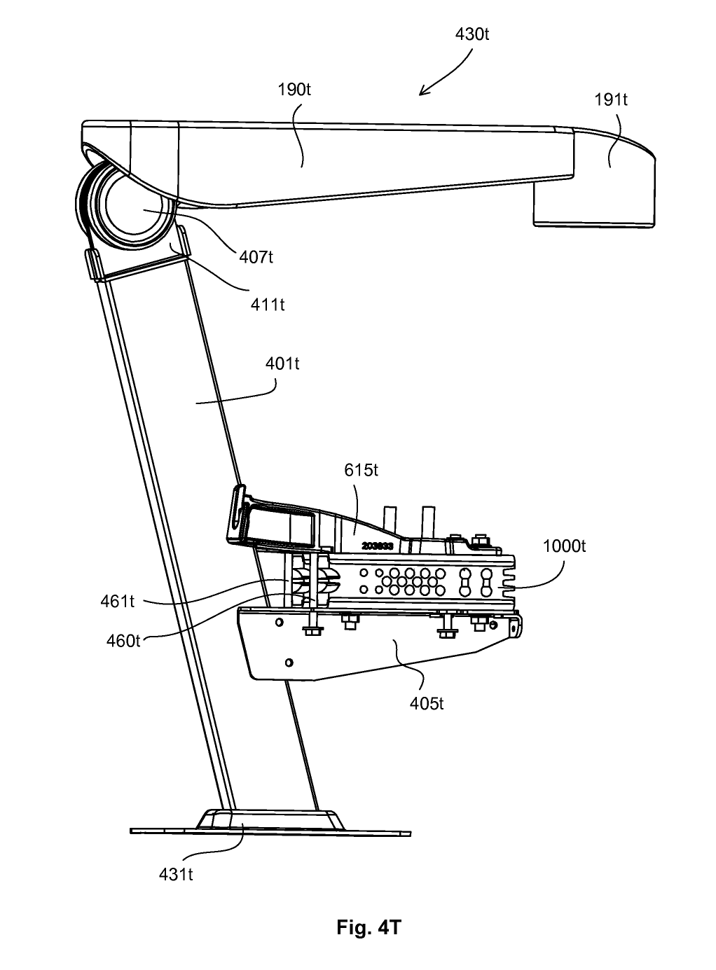

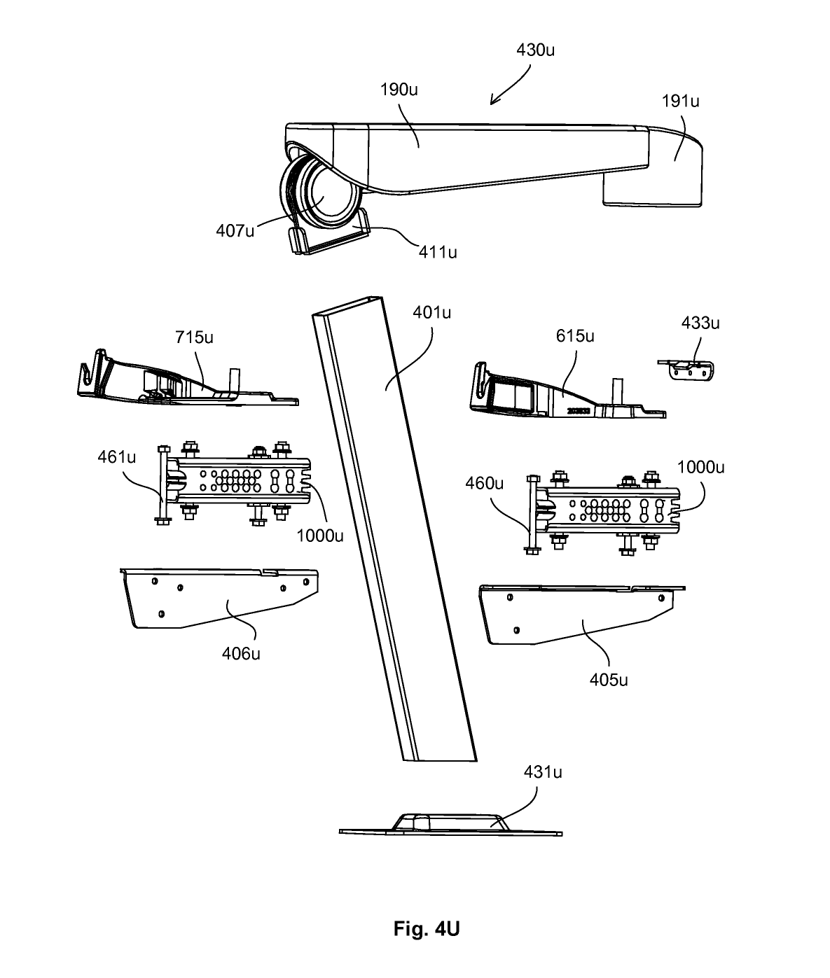

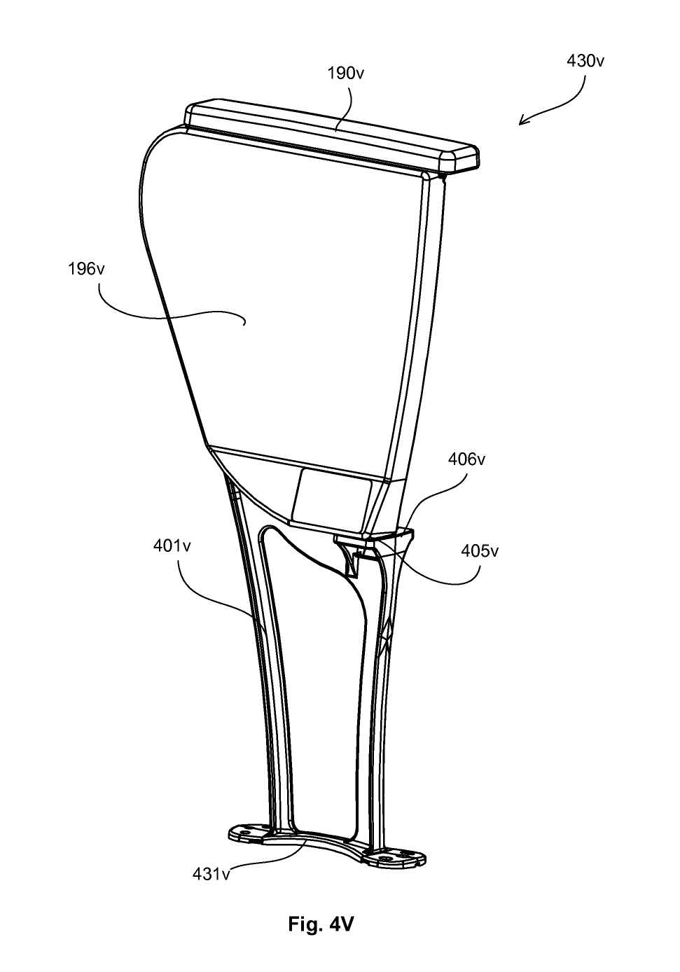

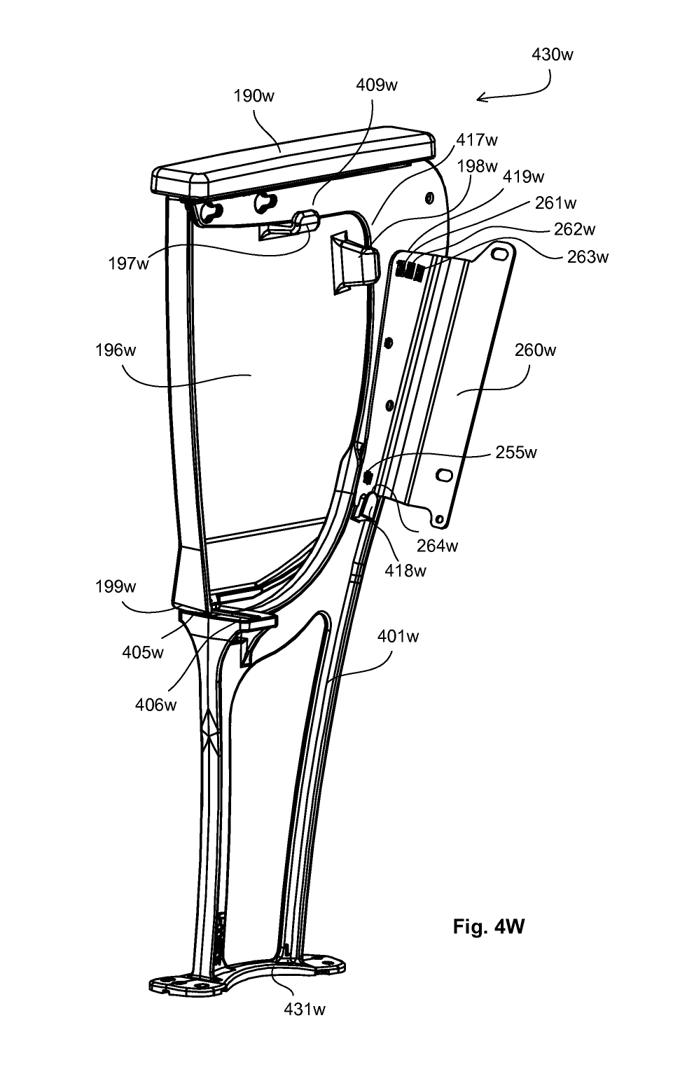

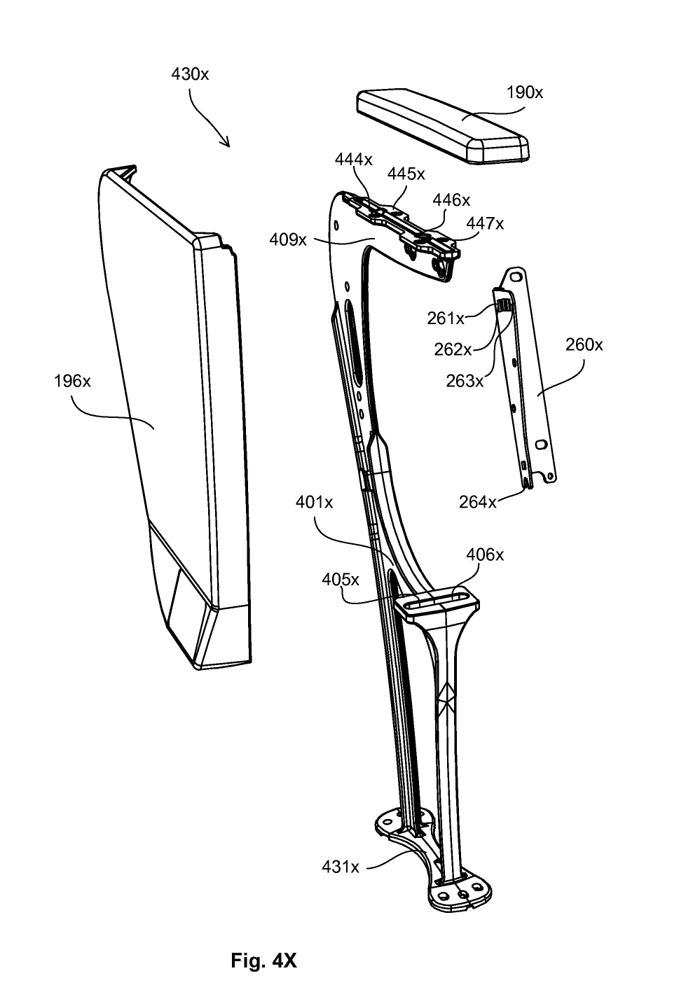

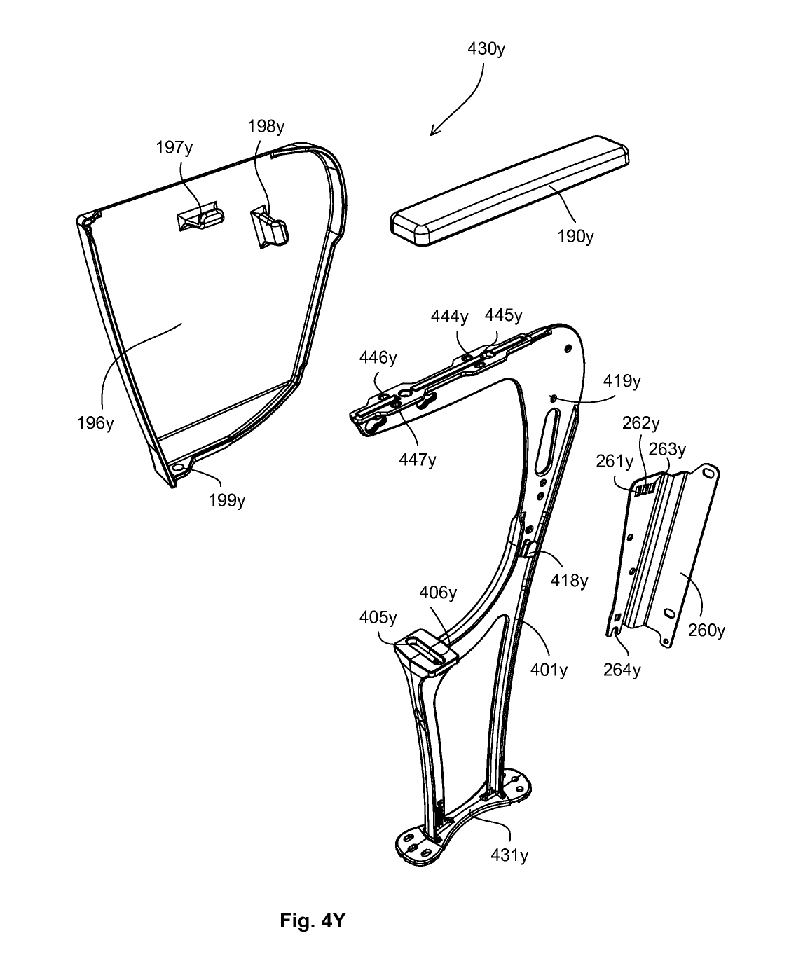

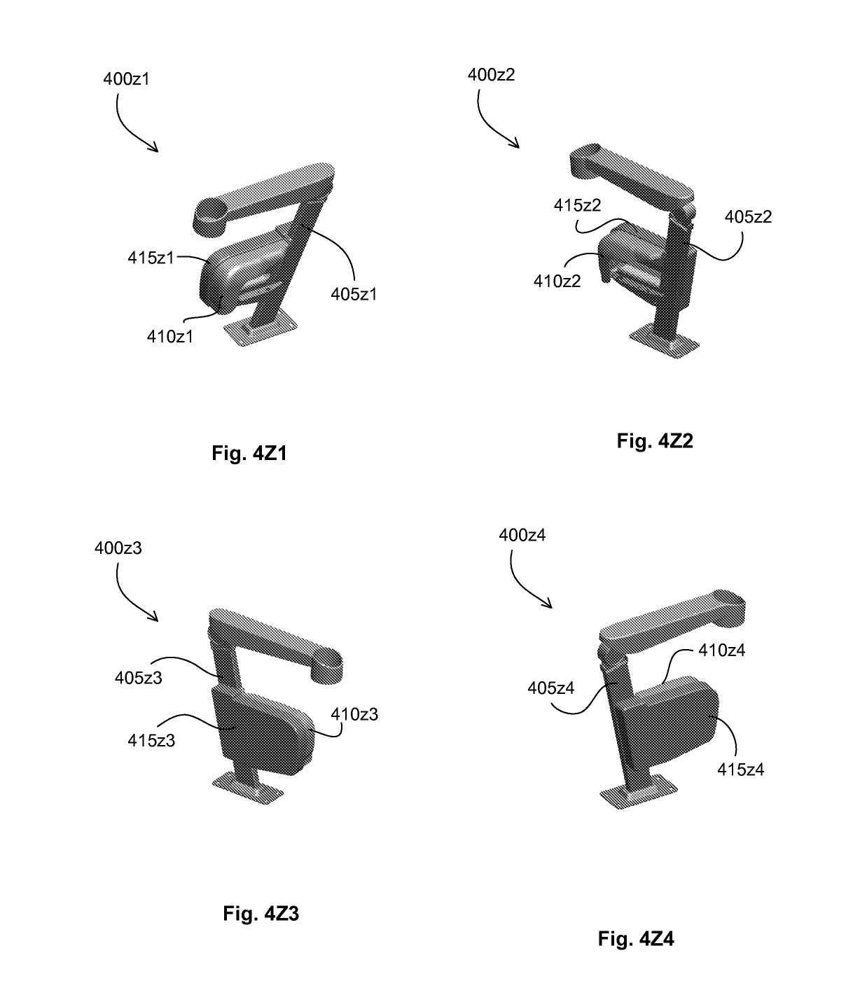

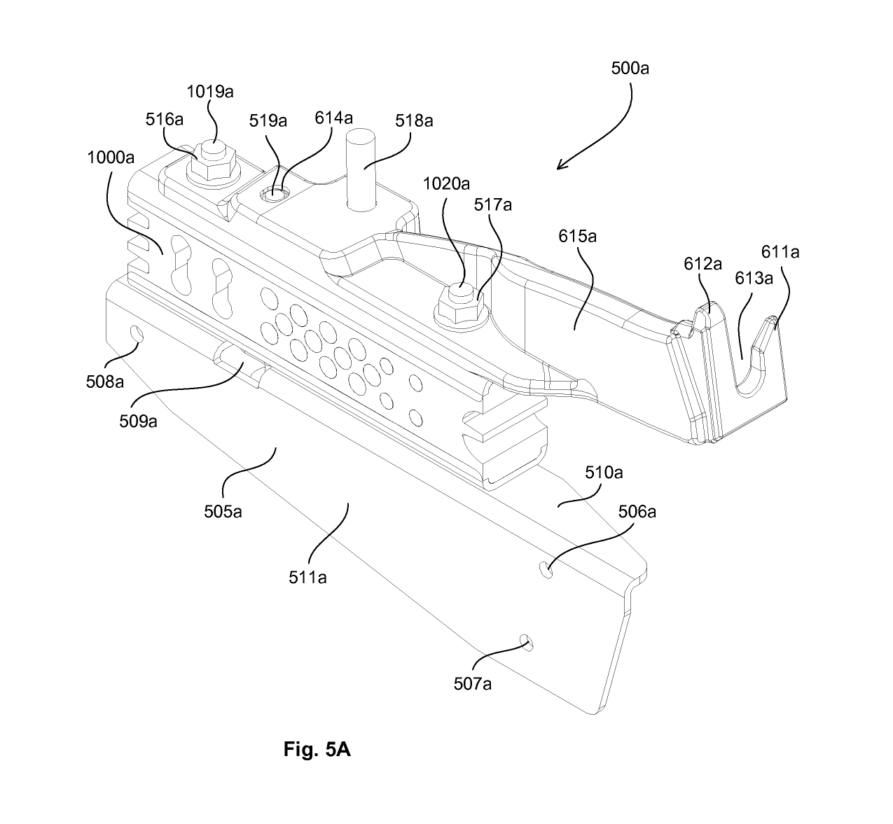

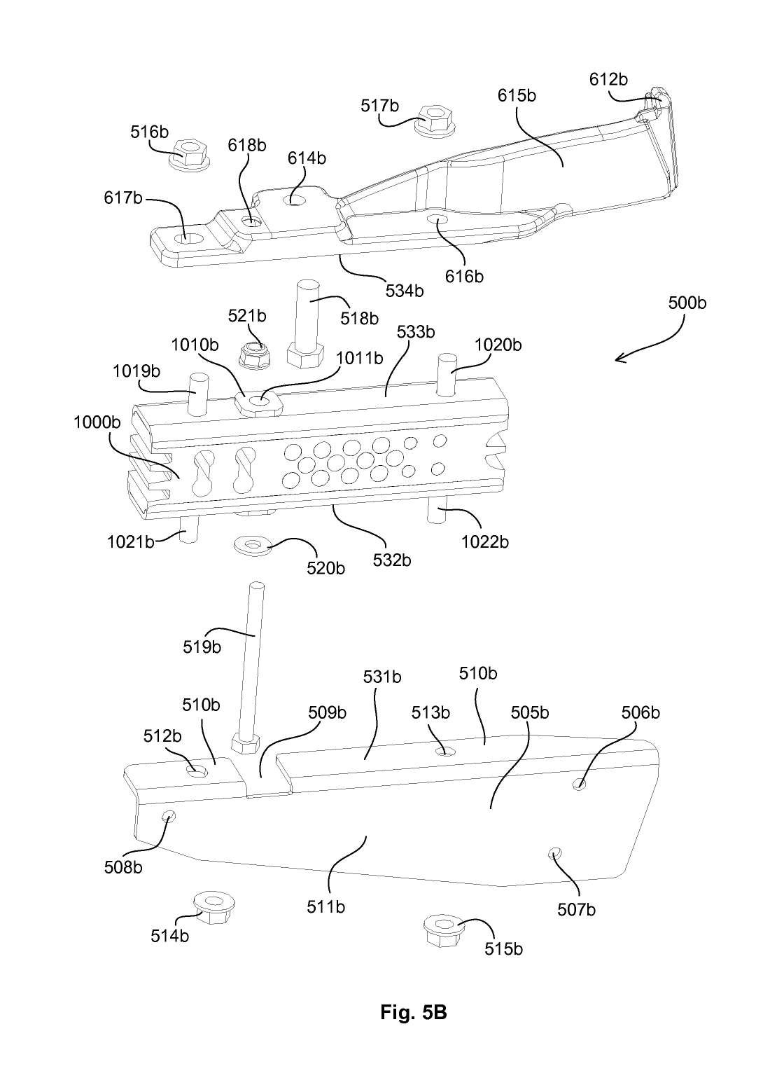

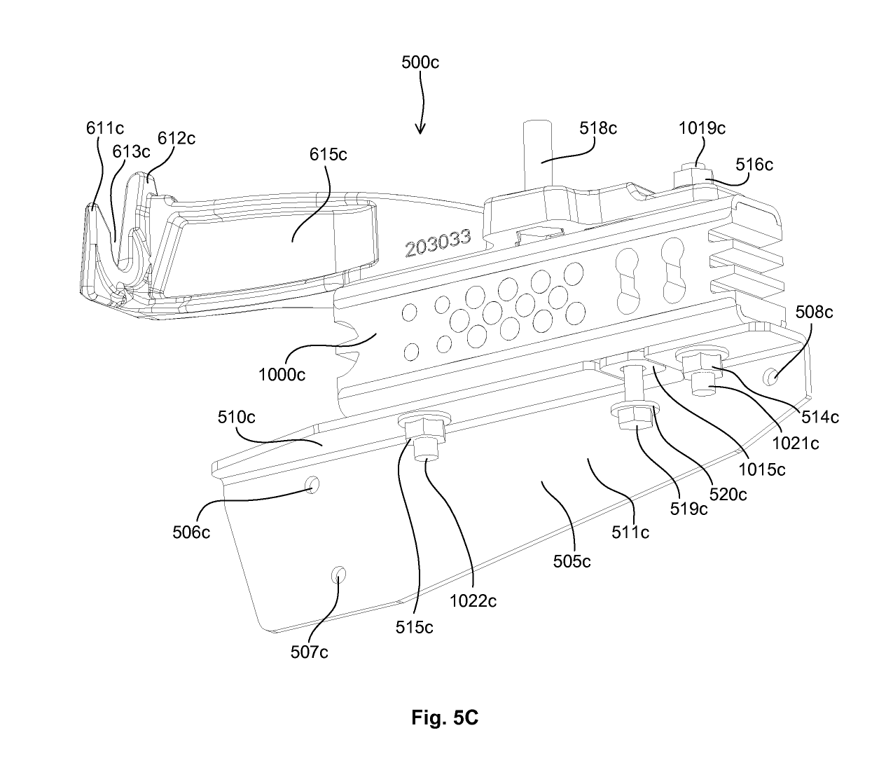

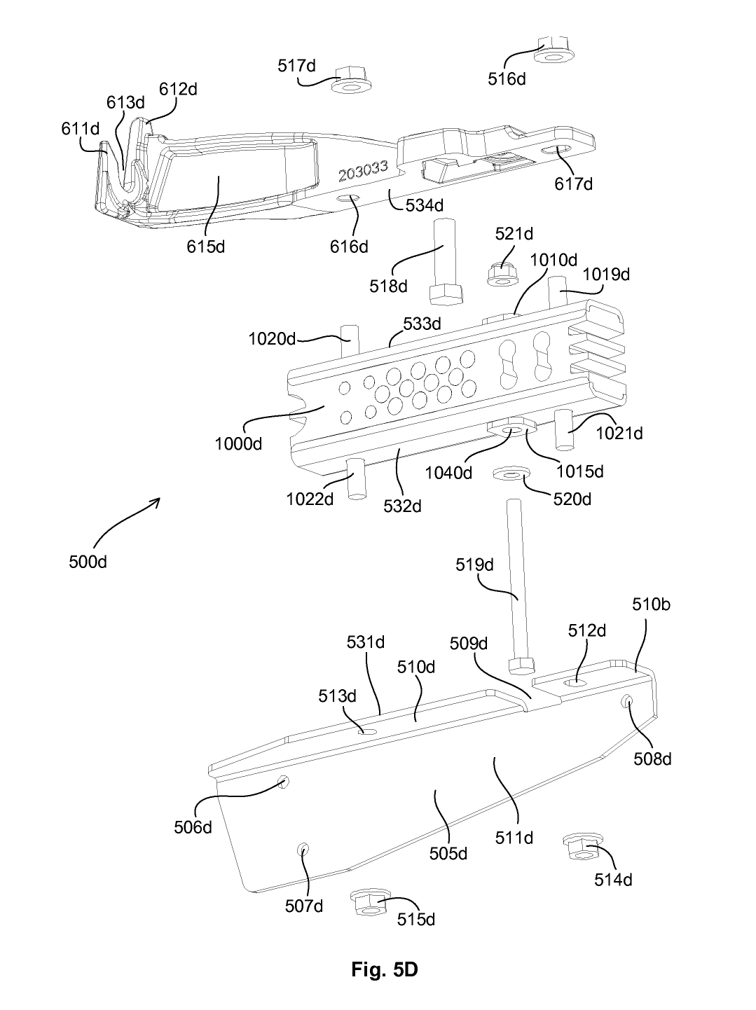

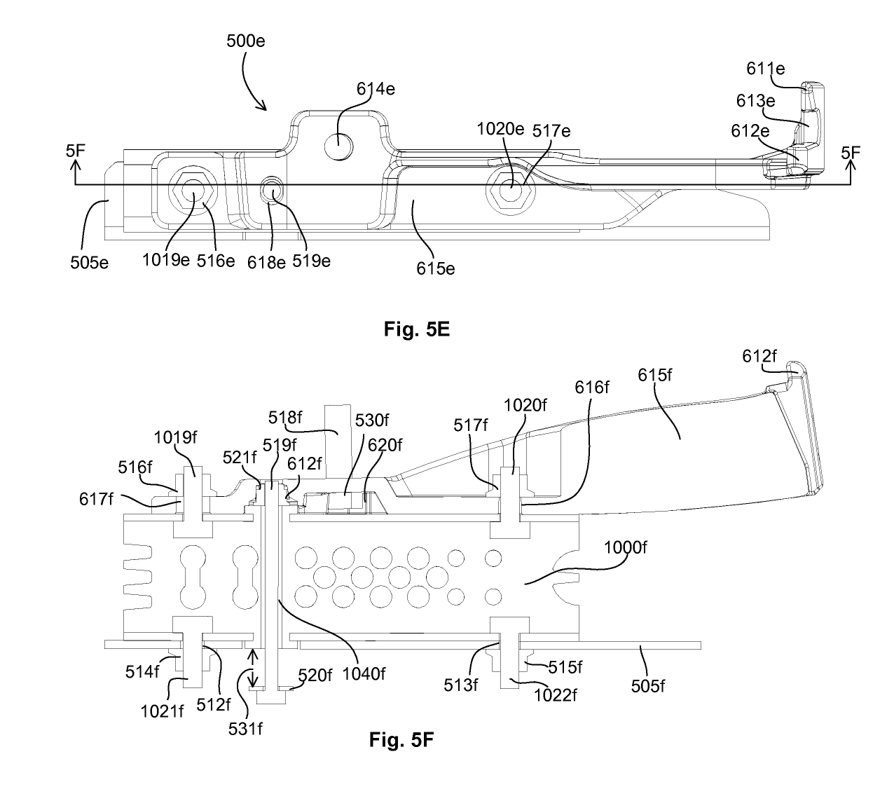

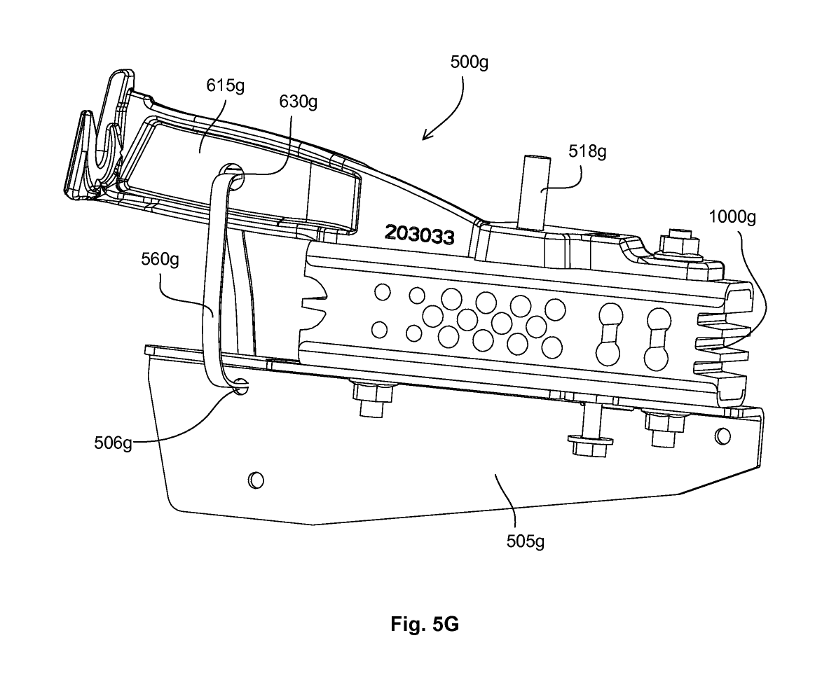

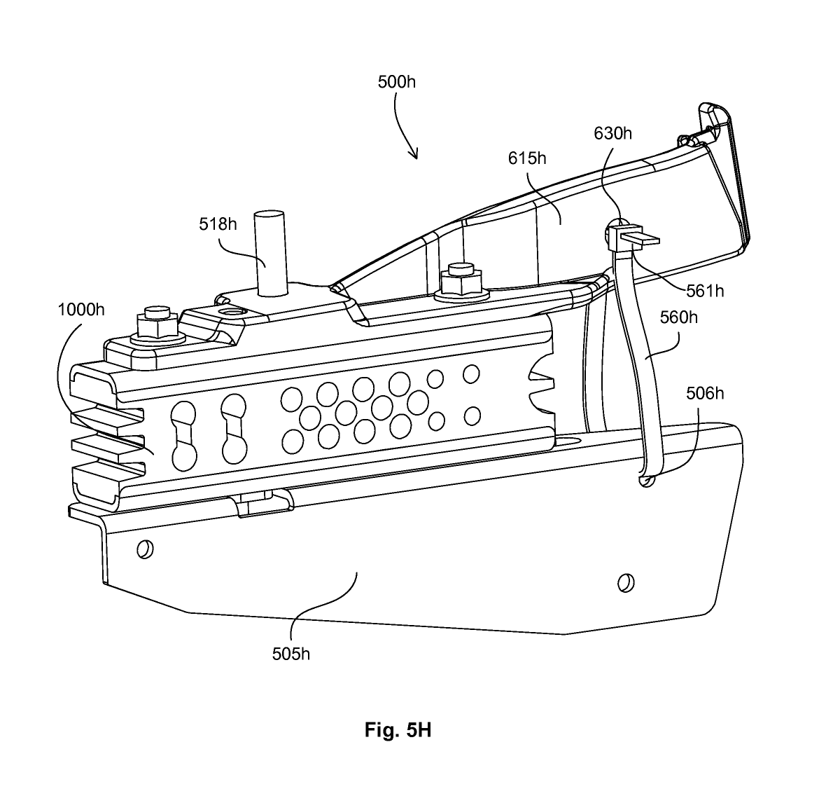

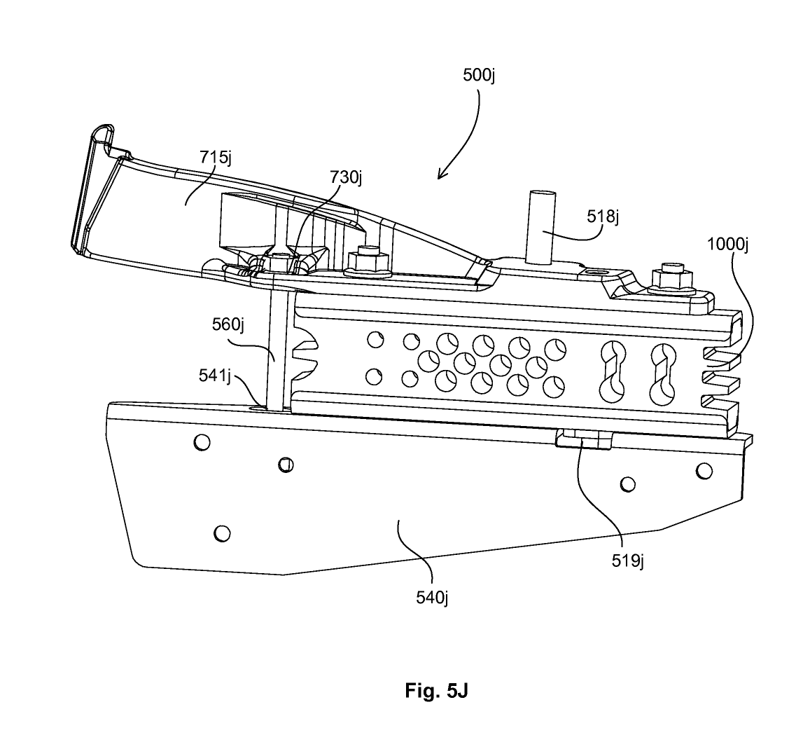

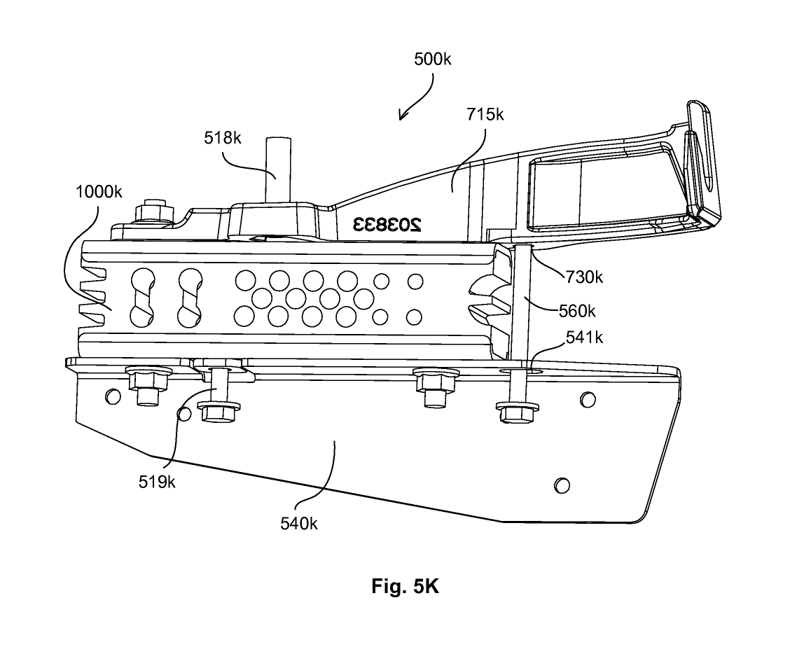

Additional details of the modular chair back assembly 136d, 170d are included throughout this disclosure and particularly with regard to FIGS. 2A-2D. Additional details of the modular chair seat assembly 116d, 151d are included throughout this disclosure and particularly with regard to FIGS. 3A-3H and 3J. Additional details of right-hand modular standard assembly 400d are included throughout this disclosure and particularly with regard to FIGS. 4A-4G, M and N. Additional details of the center modular standard assembly 430d are included throughout this disclosure and particularly with regard to FIGS. 4A-4E, H, J, P and Q. Additional details of the left-hand modular standard assembly 460d are included throughout this disclosure and particularly with regard to FIGS. 4A-E, K and L. Additional details of the related components and parts are included throughout this disclosure and particularly with regard to FIGS. 5A-5E, 6A, 6B, 7A-7D, 8A-8C, 9A-9C, 10A and 10B.

With reference now to FIG. 1E, a perspective view of the two example rocker style chairs with pivoting seats 100e is depicted. The two rocker style chairs 100e may be similar to the rocker style chairs 115b, 150b of FIG. 1B. The first rocker style chair 115e may include a chair seat 116e, a chair back 235e, a right-hand arm rest 190e with a cup holder 191e. The first rocker style chair 115e may be supported by a center standard 430e and a right-hand standard 400e. The right-hand standard 400e may include a debris cover 196e and the center standard 430b may include a debris cover 197b and a mounting foot 431e. The chair seat 116e is depicted in a position reflecting an occupant within the rocker style chair 115e. The second rocker style chair 150e may include a chair seat 151e, a chair back 270e, a left-hand arm rest 195e with a cup holder 194e. The chair seat 151e is depicted in a position reflecting no occupant within the rocker style chair 150e (i.e., as described in detail herein the chair seat 151e automatically pivots upward to increase chair access space). The second rocker style chair 150e may be supported by the center standard 430e and a left-hand standard 460e. The left-hand standard 460e may include a debris cover 198e, end cover 199e, a right-hand landing bracket 465e, a horizontal mounting structure 461e, a first mounting foot 462e and a second mounting foot 463e.

FIG. 1F depicts a perspective view of the two example rocker style chairs with pivoting seats 100f. The two example rocker chairs with pivoting seats 100f of FIG. 1F may be similar to the rocker style chairs 115e, 150e of FIG. 1E. As depicted in FIG. 1F, however, related arm rests 190e, 192e, 195e and cup holders 191e, 193e, 194e are removed. In addition to the components described with regard to FIG. 1E, the right-hand standard 400f may include an arm rest attachment 412f, an arm rest support 417f and an end-cap 419f. In addition to the components described with regard to FIG. 1E, the center standard 430f may include an arm rest attachment 412f and an arm rest support 417f. In addition to the components described with regard to FIG. 1E, the left-hand standard 460f may include an arm rest attachment 412f, an arm rest support 417f, an arm rest pivot ring 418f and an end-cap 419f. The remaining reference numbers of FIG. 1F relate to similarly identified components of FIG. 1E having the “e” replaced with an “f”.

FIG. 1G depicts a perspective view of the two example rocker style chairs with pivoting seats 100g. The two example rocker chairs with pivoting seats 100g of FIG. 1G may be similar to the rocker style chairs 115e, 150e of FIG. 1E. As depicted in FIG. 1G, however, related arm rests 190e, 192e, 195e, cup holders 191e, 193e, 194e, debris covers 196e, 197e, 198e and end cover 199e are removed. In addition to the components described with regard to FIG. 1E, the right-hand standard 400g may include an arm rest attachment 412g, an arm rest support 417g and an end-cap 419g. In addition to the components described with regard to FIG. 1E, the center standard 430g may include an arm rest attachment 412g, an arm rest support 417g, a left-hand landing bracket 432g, a first spring assembly 1000g, a right-hand landing bracket 433g and a second spring assembly 1000g. In addition to the components described with regard to FIG. 1E, the left-hand standard 460g may include an arm rest attachment 412g, an arm rest support 417g, an arm rest pivot ring 418g, an end-cap 419g, a left-hand landing bracket 464g, a spring assembly 1000g and a right-hand landing bracket 465g. The remaining reference numbers of FIG. 1G relate to similarly identified components of FIG. 1E having the “e” replaced with an “g”.

Turning to FIG. 1H, a front profile view of the two example rocker style chairs with pivoting seats 100h is depicted. The two rocker style chairs with pivoting seats 100h of FIG. 1H may be similar to the two rocker style chairs with pivoting seats 115b, 150b of FIG. 1B. The first rocker style chair with pivoting seat 115h may include a right-hand standard assembly 400h, a chair seat assembly 116h and a chair back assembly 235h. The second rocker style chair with pivoting seat 150h may include a left-hand standard assembly 460h, a chair seat assembly 151h and a chair back assembly 270h. The first rocker style chair with pivoting seat 115h and the second rocker style chair with pivoting seat 150h may share a center standard assembly 430h.

With further reference to FIG. 1H, the right-hand standard assembly 400h may include a cup holder 191h, a debris cover 196h, a first mounting foot 403h and a second mounting foot 404h. The chair seat assemblies 116h, 151h may include a decorative bottom 318h, a right-hand seat pivot assembly 900h and a left-hand seat pivot assembly 800h. The center standard assembly 430h may include a cup holder 193h, a debris cover 197h and a mounting foot 431h. The left-hand standard assembly 460h may include a cup holder 194h, a debris cover 198h, a first mounting foot 462h and a second mounting foot 463h.

Turning to FIG. 1J, a rear profile view of the two example rocker style chairs with pivoting seats 100j is depicted. The two rocker style chairs with pivoting seats 100j of FIG. 1J may be similar to the two rocker style chairs with pivoting seats 115b, 150b of FIG. 1B. The first rocker style chair with pivoting seat 115j may include a right-hand standard assembly 400j, a chair seat assembly 116j and a chair back assembly 235j. The second rocker style chair with pivoting seat 150j may include a left-hand standard assembly 460j, a chair seat assembly 151j and a chair back assembly 270j. The first rocker style chair with pivoting seat 115j and the second rocker style chair with pivoting seat 150j may share a center standard assembly 430j.

With further reference to FIG. 1J, the right-hand standard assembly 400j may include an arm rest 190j, a cup holder 191j, a debris cover 196j, a horizontal structural member 402j, a first mounting foot 403j and a second mounting foot 404j. The chair seat assemblies 116j, 151j may include a decorative bottom 318j. The center standard assembly 430j may include an arm rest 192j, a first spring assembly 1000j, a second spring assembly 1000j and a mounting foot 431j. The left-hand standard assembly 460j may include an arm rest 194j, a cup holder 194j, a debris cover 198j, a horizontal structural member 461j, a first mounting foot 462j and a second mounting foot 463j.

Turning to FIG. 1K, a left-side profile view of the two example rocker style chairs with pivoting seats 100k is depicted. The two rocker style chairs with pivoting seats 100k may be similar to the two example rocker style chairs with pivoting seats 115b, 150b of FIG. 1B. The two rocker style chairs with pivoting seats 100k may include a first chair seat assembly 116k with a decorative bottom 318k, a second chair seat assembly 151k with a decorative bottom 318k, a chair back assembly 150k with decorative back 238k, a center standard assembly 430k with a mounting foot 431k and a left-hand standard assembly 460k. The left-hand standard assembly 460k may include a right-hand landing bracket 465k, an end cover 199k, a horizontal structural member 461k, a first mounting foot 462k and a second mounting foot 463k.

Turning to FIG. 1L, a right-side profile view of the two example rocker style chairs with pivoting seats 100l is depicted. The two rocker style chairs with pivoting seats 100l may be similar to the two example rocker style chairs with pivoting seats 115b, 150b of FIG. 1B. The two rocker style chairs with pivoting seats 100l may include a first chair seat assembly 116l with a decorative bottom 318l, a second chair seat assembly 151l with a decorative bottom 318l, a chair back assembly 235l with decorative back 238l, a center standard assembly 430l with a mounting foot 431l and a right-hand standard assembly 400l. The right-hand standard assembly 400l may include a left-hand landing bracket 405l, an end cover 113l, a horizontal structural member 402l, a first mounting foot 403l and a second mounting foot 404l.

Turning now to FIG. 2A, a front perspective view of an example modular chair back assembly 235a is depicted. The modular chair back assembly 235a may be similar to either of the chair back assemblies 136d or 170d FIG. 1D. Generally, the modular chair back assembly 235a may be constructed similar to the chair back assembly as described in commonly assigned U.S. patent application Ser. No. 61/868,547, filed Aug. 21, 2013, the entire disclosure of which is incorporated by reference herein. The modular chair back assembly 235a may include a back cushion 236a, a chair back structural member 237a and a decorative chair back panel 238a. The decorative chair back panel 238a may be fixed to the chair back structural member 237a via a first back fastener 239a and a second back fastener 240a. The modular chair back assembly 235a may further include a right-hand back bracket 705a and a left-hand back bracket 605a. While the right-hand back bracket 705a is depicted in FIG. 2A on a right side of the modular chair back assembly 235a and the left-hand back bracket 605a is depicted in FIG. 2A on a left side of the modular chair back assembly 235a, the right-hand back bracket 705a and the left-hand back bracket 605a may be non-handed (i.e., the right-hand back bracket 705a and the left-hand back bracket 605a may be the same as one another). The modular chair back assembly 235b may include a fabric cover (not shown in FIG. 2B) that at least substantially encapsulates the back cushion 236a and the chair back structural member 237a, and secure the back cushion 236a in a desired position relative the chair back structural member 237a. The chair back structural member 237a may provide chair rigidity and support for a chair occupant.

FIG. 2B depicts a rear perspective view of an example modular chair back assembly 235b. The modular chair back assembly 235b may be similar to the modular chair back assembly 235a of FIG. 2A. In particular, the modular chair back assembly 235b may include a back cushion 236b, a decorative chair back panel 238a, a left-hand back bracket 605b and a right-hand back bracket 705b.

Turning to FIG. 2C, an exploded, front perspective view of an example chair back assembly 235c is depicted. The modular chair back assembly 235c may be similar to the modular chair back assembly 235a of FIG. 2A. The modular chair back assembly 235c may include a back cushion 236c, a chair back structural member 237c and a chair back decorative panel 238c. The modular chair back assembly 235c may further include a left-hand back wing 251c, a left-hand back bracket 605c, a right-hand back wing 255c and a right-hand back bracket 705c. The left-hand back wing 251c may be fixed to the left-hand back bracket 605c via a first fastener (not shown in FIG. 2C) extending through a first left-hand back wing hole 256c and a first left-hand back bracket hole 606c and a second fastener (not shown in FIG. 2C) extending through a second left-hand back wing hole 257c and a second left-hand back bracket hole 607c. The left-hand back wing 251c may be fixed to the chair back structural member 237c via a third fastener 242c extending through a first chair back structural member hole 248c and a third left-hand back wing hole (not shown in FIG. 2C), and a fourth fastener 240c extending through a second chair back structural member hole 246c and a fourth left-hand back wing hole (not shown in FIG. 2C). The right-hand back wing 260c may be fixed to the right-hand back bracket 705c via a fifth fastener (not shown in FIG. 2C) extending through a first right-hand back wing hole 254c and a first right-hand back bracket hole 706c and a sixth fastener (not shown in FIG. 2C) extending through a second right-hand back wing hole 255c and a second left-hand back bracket hole 707c. The right-hand back wing 260c may be fixed to the chair back structural member 237c via a seventh fastener 241c extending through a third chair back structural member hole 247c and a third right-hand back wing hole 252c, and an eighth fastener 239c extending through a fourth chair back structural member hole 245c and a fourth right-hand back wing hole 253c. The left-hand back bracket 605c may be placed on either side of the left-hand back wing 251c and/or the right-hand back bracket 705c may be placed on either side of the right-hand back wing 260c to adapt the modular chair back assembly 235c to different overall chair widths without the need for any additional, or different, parts. All of the components and parts depicted in FIG. 2C may be pre-assembled at a site remote from an associated rocker chair installation site and the modular chair back assembly 235c may be delivered to the installation site as shown in FIGS. 2A-2D.

Turning to FIG. 2D an exploded, rear perspective view of an example chair back assembly 235d is depicted. The modular chair back assembly 235d may be similar to the modular chair back assembly 235b of FIG. 2B. The modular chair back assembly 235d may include a back cushion 236d, a chair back structural member 237d and a chair back decorative panel 238d. The modular chair back assembly 235d may further include a left-hand back wing 251d, a left-hand back bracket 605d, a right-hand back wing 255d and a right-hand back bracket 705d. The left-hand back wing 251d may be fixed to the left-hand back bracket 605d via a first fastener (not shown in FIG. 2D) extending through a first left-hand back wing hole (not shown in FIG. 2D) and a first left-hand back bracket hole 606d and a second fastener (not shown in FIG. 2D) extending through a second left-hand back wing hole (not shown in FIG. 2D) and a second left-hand back bracket hole 607d. The left-hand back wing 251d may be fixed to the chair back structural member 237d via a third fastener 242d extending through a first chair back structural member hole 248d and a third left-hand back wing hole 270d, and a fourth fastener 240d extending through a second chair back structural member hole 246d and a fourth left-hand back wing hole 259d. The right-hand back wing 260d may be fixed to the right-hand back bracket 705d via a fifth fastener (not shown in FIG. 2D) extending through a first right-hand back wing hole 254d and a first right-hand back bracket hole 706d and a sixth fastener (not shown in FIG. 2D) extending through a second right-hand back wing hole 255d and a second left-hand back bracket hole 707d. The right-hand back wing 260d may be fixed to the chair back structural member 237d via a seventh fastener 241d extending through a third chair back structural member hole 247d and a third right-hand back wing hole 252d, and an eighth fastener 239d extending through a fourth chair back structural member hole 245d and a fourth right-hand back wing hole 253d. The left-hand back bracket 605d may be placed on either side of the left-hand back wing 251d and/or the right-hand back bracket 705d may be placed on either side of the right-hand back wing 260d to adapt the modular chair back assembly 235d to different overall chair widths without the need for any additional, or different, parts.

Turning to FIG. 3A a front, top, perspective view of an example modular chair seat assembly 316a is depicted. The modular chair seat assembly 316a may be similar to either of the modular chair seat assemblies 116d, 151d of FIG. 1D. Generally, the modular chair seat assembly 316a may be constructed similar to a chair seat assembly as described in commonly assigned U.S. patent application Ser. No. 61/868,547, filed Aug. 21, 2013, the entire disclosure of which is incorporated by reference herein. The modular chair seat assembly 316a may include a chair seat cushion 317a, a chair seat decorative panel 318a and a left-hand seat pivot assembly 800a. The left-hand seat pivot assembly 800a may include a mounting hole 812a. The modular chair seat assembly 316a may include a fabric cover (not shown in FIG. 2A) that substantially encapsulates the chair seat cushion 317a and may secure the chair seat cushion 317a to a chair seat structural frame (not shown in FIG. 3A). As reflected in throughout the figures (e.g., FIGS. 4H and 4K), the pivot assembly (e.g., 800a, 900b, 800h, 900h, 800k) may be positioned toward a rear portion of the modular chair seat assembly (e.g., 316a and 316b) to limit associated pinch points.

With reference to FIG. 3B, a front, bottom, perspective view of an example modular chair seat assembly 316b is depicted. The modular chair seat assembly 316b may be similar to the modular chair seat assembly 316a of FIG. 3A. The modular chair seat assembly 316b may include a chair seat cushion 317b, a seat bottom decorative panel 318b, a left-hand seat pivot assembly 800b and a right-hand seat pivot assembly 900b. The left-hand seat pivot assembly 800b may include a seat mounting hole 812b and the right-hand seat pivot assembly 900b may include a seat mounting hole 912b. The seat bottom decorative panel 318b may include a first fastener 319b and a second fastener 320b that may secure the seat bottom decorative panel 318b to a chair seat structural frame (not shown in FIG. 3B).

Turning to FIG. 3C, a front profile view of an example modular chair seat assembly 316c is depicted that may reflect an associated position when an occupant is setting in the corresponding rocker style chair. The modular chair seat assembly 316c may be similar to the modular chair seat assembly 316b of FIG. 3B. The modular chair seat assembly 316c may include a chair seat cushion 317c, a seat bottom decorative panel 318c, a left-hand seat pivot assembly 800c and a right-hand seat pivot assembly 900c.

With reference to FIG. 3D a bottom profile view of an example modular chair seat assembly 316d is depicted. The modular chair seat assembly 316d may be similar to the modular chair seat assembly 316c of FIG. 3C. The modular chair seat assembly 316d may include a chair seat cushion 317d, a seat bottom decorative panel 318d, a left-hand seat pivot assembly 800d and a right-hand seat pivot assembly 900d. The left-hand seat pivot assembly 800d may include a seat mounting hole 812d and the right-hand seat pivot assembly 900d may include a seat mounting hole 912d. The seat bottom decorative panel 318d may include a first fastener 319d and a second fastener 320d that may secure the seat bottom decorative panel 318d to a chair seat structural frame (not shown in FIG. 3D).

Turning to FIG. 3E, a front profile view of an example modular chair seat assembly 316e is depicted that may reflect an associated position when no occupant is setting in the corresponding rocker style chair. The modular chair seat assembly 316e may be similar to the modular chair seat assembly 316d of FIG. 3D. The modular chair seat assembly 316e may include a chair seat cushion 317e, a seat bottom decorative panel 318e, a left-hand seat pivot assembly 800e and a right-hand seat pivot assembly 900e.

With reference to FIG. 3F, a left-side profile view of an example modular chair seat assembly 316f is depicted. The modular chair seat assembly 316f may be similar to the modular chair seat assembly 316e of FIG. 3E. The modular chair seat assembly 316f may include a seat chair cushion 317f, a seat bottom decorative panel 318f and a left-hand seat pivot assembly 800f.

Turning to FIG. 3G a top profile view of an example modular chair seat assembly 316g is depicted. The modular chair seat assembly 316g may be similar to the modular chair seat assembly 316f of FIG. 3F. The modular chair seat assembly 316g may include a chair seat cushion 317g, a left-hand seat pivot assembly 800g and a right-hand seat pivot assembly 900g. The left-hand seat pivot assembly 800g may include a seat mounting hole 812g and the right-hand seat pivot assembly 900g may include a seat mounting hole 912g.

With reference to FIG. 3H an exploded front, top, perspective view of an example modular chair seat assembly 316h is depicted. The modular chair seat assembly 316h may be similar to the modular chair seat assembly 316a of FIG. 3A. The modular chair seat assembly 316h may include a chair seat cushion 317h, a chair seat structural frame assembly 331h, a seat bottom decorative panel 318h, a left-hand seat pivot assembly 800h and a right-hand seat pivot assembly 900h. The seat bottom decorative panel 318h may include a first fastener 319h that cooperates with a first seat structural frame hole (not shown in FIG. 3H), a second fastener 320h that cooperates with a second seat structural frame hole (not shown in FIG. 3H), a third fastener 321h that cooperates with a first seat structural frame tong 336h and a fourth fastener 322h that cooperates with a second seat structural frame tong 337h to secure the seat bottom decorative panel 318h to the chair seat structural frame assembly 331h. The chair seat structural frame assembly 331h may include a plurality of seat support springs 327h that extend between a plurality of first spring supports 323h and a plurality of second spring supports 325h. Each of the first spring supports 323h and each of the second spring supports 325h may include a rubber spring bushing 324h, 326h that substantially prevent the seat support springs 327 from making noise when an occupant sets on the modular chair seat assembly 316h. The modular chair seat assembly 316h may include a fabric cover (not shown in FIG. 3H) that substantially encapsulates the chair seat cushion 317h and the chair seat structural frame assembly 331h and may secure the chair seat cushion 317h proximate the seat structural frame assembly 331h. The left-hand seat pivot assembly 800h may include a left-hand seat connector 801h and a chair seat mounting hole 812h. The right-hand seat pivot assembly 900h may include a right-hand seat connector 901h and a chair seat mounting hole 912h. All of the components and parts depicted in FIG. 3H may be pre-assembled at a site remote from an associated rocker chair installation site and the modular chair seat assembly 316h may be delivered to the installation site as shown in FIGS. 3A-3H and 3J.

With reference to FIG. 3J an exploded front, bottom, perspective view of an example modular chair seat assembly 316j is depicted. The modular chair seat assembly 316j may be similar to the modular chair seat assembly 316b of FIG. 3B. The modular chair seat assembly 316j may include a chair seat cushion 317j, a chair seat structural frame assembly 331j, a seat bottom decorative panel 318j, a left-hand seat pivot assembly 800j and a right-hand seat pivot assembly 900j. The seat bottom decorative panel 318j may include a first fastener 319j that cooperates with a right-hand seat connector hole 338j, a second fastener 320j that cooperates with a left-hand seat connector hole 339j, a third fastener (not shown in FIG. 3J) that cooperates with a first seat structural frame tong 336j and a fourth fastener (not shown in FIG. 3J) that cooperates with a second seat structural frame tong 337j to secure the seat bottom decorative panel 318j to the chair seat structural frame assembly 331j. The chair seat structural frame assembly 331j may include a plurality of seat support springs 327j that extend between a plurality of first spring supports (not shown in FIG. 3J) and a plurality of second spring supports 325j. The modular chair seat assembly 316j may include a fabric cover (not shown in FIG. 3J) that substantially encapsulates the chair seat cushion 317j and the chair seat structural frame assembly 331j and may secure the chair seat cushion 317j proximate the seat structural frame assembly 331j. The left-hand seat pivot assembly 800j may include a left-hand seat connector 801j and a chair seat mounting hole 812j. The left-hand seat connector 801j may be connected to a left-hand seat frame structure connector 330j via a first fastener (not shown in FIG. 3J) extending through a first left-hand seat connector hole 805j and a first left-hand seat frame structure connector 332j and a second fastener (not shown in FIG. 3J) extending through a second left-hand seat connector hole (not shown in FIG. 3J) and a second left-hand seat frame structure connector 333j. The left-hand seat frame structure connector 330j may include a bumper hole 341j. The right-hand seat frame structure connector 329j may include a bumper hole 340j. The right-hand seat pivot assembly 900j may include a right-hand seat connector 901j and a chair seat mounting hole 912j. The right-hand seat connector 901j may be connected to a right-hand seat frame structure connector 329j via a third fastener (not shown in FIG. 3J) extending through a first right-hand seat connector hole 905j and a first right-hand seat frame structure connector 334j and a fourth fastener (not shown in FIG. 3J) extending through a second right-hand seat connector hole (not shown in FIG. 3J) and a second right-hand seat frame structure connector 335j.

Turning to FIGS. 3K and 3L, a top, front perspective, exploded view of an example seat assembly 316k is depicted along with a bottom, front perspective, exploded view 316L. The seat assembly 316k, 316l may include a seat cushion 317k, 317l, a right-hand seat connector 901k, 901l, a left-hand seat connector 801k, 801l, a seat frame assembly 331k, 331l and a seat bottom decorative panel 318k, 318l. The right-hand seat connector 901k, 901l may include a pivot post 900k, 900l, a chair seat mounting hole 912k, 912l and a first seat bottom decorative panel attachment 960k, 960l. The left-hand seat connector 801k, 801l may include a pivot post 800k, 800l, a chair seat mounting hole 812k, 812l and a second seat bottom decorative panel attachment 860k, 860l. The first seat bottom decorative panel attachment 960k, 960l may cooperate with a first seat bottom decorative panel fastener 319k, 319l to secure the seat bottom decorative panel 318k, 318l to the seat assembly 316k, 316l. The second seat bottom decorative panel attachment 860k, 860l may cooperate with a second seat bottom decorative panel fastener 320k, 320l to further secure the seat bottom decorative panel 318k, 318l to the seat assembly 316k, 316l. The seat frame assembly 331k, 331l may include a first seat frame assembly attachment 336k, 336l that may cooperate with a first seat bottom decorative panel attachment 321k to secure the seat bottom decorative panel 318k, 318l to the seat frame assembly 331k, 331l. The seat frame assembly 331k, 331l may include a second seat frame assembly attachment 337k, 337l that may cooperate with a second seat bottom decorative panel attachment 322k to further secure the seat bottom decorative panel 318k, 318l to the seat frame assembly 331k, 331l. The seat bottom decorative panel 318k, 318l may include a first pivot post 350k on a first sidewall 351k of the seat bottom decorative panel 318k, 318l and a second pivot post 355k on a second sidewall of the seat bottom decorative panel 318k, 318l configured to interact with attachments 336k, 336l, 337k, 337l, 321k, 322k and fasteners 960k, 960l, 860k, 860l, 319k, 319l, 320k, 320l. The pivot posts 350k, 355k may be attached to sidewall 351k of seat bottom decorative panel 318k, 318l which may also incorporate side-to-side locators configured to align the seat bottom decorative panel 318k, 318l with the seat bottom assembly 316k, 316l. The pivot post 355k may be located a first distance 356k from the second seat bottom decorative panel attachment 322k and a second distance 357k from the seat bottom decorative panel fastener 320k. The second distance 357k may be greater than the first distance 356k. Alternatively, the second distance 357k may be greater than or equal to twice the first distance 356k. In any event, the second distance 357k and the first distance 356k may be selected such that when the seat bottom decorative panel fastener 320k is tightened, the second seat bottom decorative panel attachment 322k is biased against the second seat frame assembly attachment 337k. The pivot post 350k may be similarly positioned with respect to the first seat bottom decorative panel attachment 321k and the seat bottom decorative panel attachment 319k. Thereby, the seat bottom decorative panel 318k may be firmly secured to the seat frame assembly 331k.

Turning to FIG. 4A, a front, top, perspective view of example modular standard assemblies 400a is depicted. The right-side modular standard assembly 400a of FIG. 4A may be similar to the right-side modular standard assembly 400d of FIG. 1D. The center modular standard assembly 430a of FIG. 4A may be similar to the center modular standard assembly 430d of FIG. 1D. The left-side modular standard assembly 460a of FIG. 4A may be similar to the left-side modular standard assembly 460d of FIG. 1D. The right-side modular standard assembly 400a may include a horizontal structural member 402a, a first mounting foot 403a, a second mounting foot 404a, a left-hand landing bracket 405a and a right-hand landing bracket 406a. The right-side modular standard assembly 400a may also include an arm rest and cup holder (not shown in FIG. 4A), an arm rest attachment 412a, an arm rest support 417a, an arm rest pivot ring 418a and an end cap 419a. The right-side modular standard assembly 400a may further include a right-hand seat bracket 715a and a spring assembly (not shown in FIG. 4A). For illustrative purposes, a right-hand seat pivot assembly 900a having a right-hand seat connector 901a is depicted proximate the right-side modular standard assembly 400a (i.e., as described with regard to FIG. 3H, the right-hand seat pivot assembly 900a may be incorporated within a modular chair seat assembly 316h). For further illustration, a right-hand back bracket 705a and a right-hand chair back wing 250a are depicted proximate the right-side modular standard assembly 400a (i.e., as described with reference to FIG. 2C, the right-hand back bracket 705a and the right-hand chair back wing 250a may be incorporated within a modular chair back assembly 235c).

With further reference to FIG. 4A, the center modular standard assembly 430a may include a mounting foot 431a, a left-hand landing bracket 432a and a right-hand landing bracket 433a. The center modular standard assembly 430a may also include an arm rest and cup holder (not shown in FIG. 4A), an arm rest attachment 412a, an arm rest pivot ring 418a and an end cap 419a. The center modular standard assembly 430a may further include a left-hand seat bracket 615a, a right-hand seat bracket 715a, a first spring assembly 1000a and a second spring assembly 1000a. For illustrative purposes, a left-hand seat pivot assembly 800a having a left-hand seat connector 801a and a right-hand seat pivot assembly 900a having a right-hand seat connector 901a are depicted proximate the center modular standard assembly 430a (i.e., as described with regard to FIG. 3H, the left-hand seat pivot assembly 800a and the right-hand seat pivot assembly 900a may be incorporated within a modular chair seat assembly 316h). For further illustration, a left-hand back bracket 605a, a right-hand back bracket 705a and a right-hand chair back wing 250a having a first back wing fastener hole 252a and a second back wing fastener hole 253a are depicted proximate the center modular standard assembly 430a (i.e., as described with reference to FIG. 2C, the left-hand back bracket 605a, the right-hand back bracket 705a and the right-hand chair back wing 250a may be incorporated within a modular chair back assembly 235c).

With yet further reference to FIG. 4A, the left-side modular standard assembly 460a may include a horizontal structural member 461a, a first mounting foot 462a, a second mounting foot 463a, a left-hand landing bracket 464a and a right-hand landing bracket 465a. The left-side modular standard assembly 460a may also include an arm rest and cup holder (not shown in FIG. 4A), an arm rest attachment 412a, an arm rest pivot ring 418a and an end cap 419a. The left-side modular standard assembly 460a may further include a left-hand seat bracket 615a and a spring assembly 1000a. For illustrative purposes, a left-hand seat pivot assembly 800a having a left-hand seat connector 801a is depicted proximate the left-side modular standard assembly 460a (i.e., as described with regard to FIG. 3H, the left-hand seat pivot assembly 800a may be incorporated within a modular chair seat assembly 316h). For further illustration, a left-hand back bracket 605a is depicted proximate the left-side modular standard assembly 460a (i.e., as described with reference to FIG. 2C, the left-hand back bracket 605a may be incorporated within a modular chair back assembly 235c).

The left-hand landing brackets 405a, 432a, 464a may be the same as one another. Furthermore, each left-hand landing bracket 405a, 432a, 464a may be stamped out of a substantially flat sheet of metal with the various surfaces being formed at substantially a right-angle with respect to adjoining surfaces. The right-hand landing brackets 406a, 433a, 465a may be the same as one another. Furthermore, each right-hand landing bracket 406a, 433a, 465a may be stamped out of a substantially flat sheet of metal with the various surfaces being formed at substantially a right-angle with respect to adjoining surfaces. The holes within the landing brackets 405a, 406a, 432a, 433a, 464a, 465a may be drilled in the associated substantially flat sheet of metal prior to the individual surfaces being bent. As can be seen in FIG. 4A, there is a substantially open area between the left-hand landing bracket 432a and the right-hand landing bracket 433a, a substantially open area between the left-hand landing bracket 432a and the seat connector 801a and a substantially open area between the right-hand landing bracket 433a and the seat connector 901a. These substantially open areas minimize debris buildup in, and around, the corresponding spring assemblies 1000a and chair seat pivots 800a, 900a.

Turning to FIG. 4B, a rear, profile view of example modular standard assemblies 400b is depicted. The modular standard assemblies 400b may be similar to the modular standard assemblies 400a of FIG. 4A. The right-side modular standard assembly 400b may include a first mounting foot 403b and a second mounting foot 404b. The right-side modular standard assembly 400b may also include an arm rest and cup holder (not shown in FIG. 4B), an arm rest attachment 412b, a right-hand arm rest pivot mount 411b and a left-hand arm rest pivot mount 415b. The right-side modular standard assembly 400b may further include a right-hand seat bracket (not individually identified in FIG. 4B). For illustrative purposes, a right-hand seat pivot assembly 900b having a right-hand seat connector 901b is depicted proximate the right-side modular standard assembly 400b (i.e., as described with regard to FIG. 3H, the right-hand seat pivot assembly 900b may be incorporated within a modular chair seat assembly 316h). For further illustration, a right-hand back bracket (not individually identified in FIG. 4B) and a right-hand chair back wing 250b are depicted proximate the right-side modular standard assembly 400b (i.e., as described with reference to FIG. 2C, the right-hand back bracket (not individually identified in FIG. 4B) and the right-hand chair back wing 250b may be incorporated within a modular chair back assembly 235c).

With further reference to FIG. 4B, the center modular standard assembly 430b may include a mounting foot 431b. The center modular standard assembly 430b may also include an arm rest and cup holder (not shown in FIG. 4B), an arm rest attachment 412b, a right-hand arm rest pivot mount 411b and a left-hand arm rest pivot mount 415b. The center modular standard assembly 430b may further include a left-hand seat bracket (not individually identified in FIG. 4B), a right-hand seat bracket (not individually identified in FIG. 4B), a first spring assembly 1000b and a second spring assembly 1000b. For illustrative purposes, a left-hand seat pivot assembly 800b having a left-hand seat connector 801b and a right-hand seat pivot assembly 900b having a right-hand seat connector 901b are depicted proximate the center modular standard assembly 430b (i.e., as described with regard to FIG. 3H, the left-hand seat pivot assembly 800b and the right-hand seat pivot assembly 900b may be incorporated within a modular chair seat assembly 316h). For further illustration, a left-hand back bracket (not individually identified in FIG. 4B), a right-hand back bracket (not individually identified in FIG. 4B) and a right-hand chair back wing 250b and a left-hand chair back wing 251b are depicted proximate the center modular standard assembly 430b (i.e., as described with reference to FIG. 2C, the left-hand back bracket (not individually identified in FIG. 4B), the right-hand back bracket (not individually identified in FIG. 4B), the right-hand chair back wing 250b and the left-hand chair back wing 251b may be incorporated within a modular chair back assembly 235c).

With yet further reference to FIG. 4B, the left-side modular standard assembly 460b may include a first mounting foot 462b, a second mounting foot 463b, a left-hand landing bracket (not individually identified in FIG. 4B) and a right-hand landing bracket (not individually identified in FIG. 4B). The left-side modular standard assembly 460b may also include an arm rest and cup holder (not shown in FIG. 4B), an arm rest attachment 412b, a right-hand arm rest pivot mount 411b and a left-hand arm rest pivot mount 415b. The left-side modular standard assembly 460b may further include a left-hand seat bracket (not individually identified in FIG. 4B). For illustrative purposes, a left-hand seat pivot assembly 800b having a left-hand seat connector 801b is depicted proximate the left-side modular standard assembly 460b (i.e., as described with regard to FIG. 3H, the left-hand seat pivot assembly 800b may be incorporated within a modular chair seat assembly 316h). For further illustration, the left-hand back bracket 605b is depicted proximate the left-side modular standard assembly 460b (i.e., as described with reference to FIG. 2C, the left-hand back bracket 605b may be incorporated within a modular chair back assembly 235c).

Turning to FIG. 4C a bottom, profile view of example modular standard assemblies 400c is depicted. The module standard assemblies 400c may be similar to the modular standard assemblies 400b of FIG. 4B. The right-side modular standard assembly 400c may include a horizontal structural member 402c, a second mounting foot 404c, a left-hand landing bracket 405c and a right-hand landing bracket 406c. The right-side modular standard assembly 400c may also include an arm rest and cup holder (not shown in FIG. 4C, a first arm rest support 409c and a second arm rest support 417c. The right-side modular standard assembly 400c may further include a right-hand seat bracket (not individually identified in FIG. 4C) and a spring assembly (not shown in FIG. 4C). For illustrative purposes, a right-hand seat pivot assembly 900c having a right-hand seat connector 901c is depicted proximate the right-side modular standard assembly 400c (i.e., as described with regard to FIG. 3H, the right-hand seat pivot assembly 900c may be incorporated within a modular chair seat assembly 316h). For further illustration, the right-hand back bracket 705c and the right-hand chair back wing 250c are depicted proximate the right-side modular standard assembly 400c (i.e., as described with reference to FIG. 2C, the right-hand back bracket 705c and the right-hand chair back wing 250c may be incorporated within a modular chair back assembly 235c).

With further reference to FIG. 4C, the center modular standard assembly 430c may include a mounting foot 431c, a left-hand landing bracket 432c and a right-hand landing bracket 433c. The center modular standard assembly 430c may also include an arm rest and cup holder (not shown in FIG. 4C). The center modular standard assembly 430c may further include a left-hand seat bracket (not individually identified in FIG. 4C) and a right-hand seat bracket (not individually identified in FIG. 4C). For illustrative purposes, a left-hand seat pivot assembly 800c having a left-hand seat connector 801c and a right-hand seat pivot assembly 900c having a right-hand seat connector 901c are depicted proximate the center modular standard assembly 430c (i.e., as described with regard to FIG. 3H, the left-hand seat pivot assembly 800c and the right-hand seat pivot assembly 900c may be incorporated within a modular chair seat assembly 316h). For further illustration, a left-hand back bracket (not individually identified in FIG. 4C), a right-hand back bracket (not individually identified in FIG. 4C), a left-hand chair back wing 251c and a right-hand chair back wing 250c are depicted proximate the center modular standard assembly 430c (i.e., as described with reference to FIG. 2C, the left-hand back bracket (not individually identified in FIG. 4C), the right-hand back bracket (not individually identified in FIG. 4C), the left-hand chair back wing 251c and the right-hand chair back wing 250c may be incorporated within a modular chair back assembly 235c).

With yet further reference to FIG. 4C, the left-side modular standard assembly 460c may include a horizontal structural member 461c, a second mounting foot 463c, a left-hand landing bracket 464c and a right-hand landing bracket 465c. The left-side modular standard assembly 460c may also include an arm rest and cup holder (not shown in FIG. 4C), a first arm rest support 409c and a second arm rest support 417c. The left-side modular standard assembly 460c may further include a left-hand seat bracket (not individually identified in FIG. 4C). For illustrative purposes, a left-hand seat pivot assembly 800c having a left-hand seat connector 801c is depicted proximate the left-side modular standard assembly 460c (i.e., as described with regard to FIG. 3H, the left-hand seat pivot assembly 800c may be incorporated within a modular chair seat assembly 316h). For further illustration, a left-hand back bracket 605c and a left-hand chair back wing 251c are depicted proximate the left-side modular standard assembly 460c (i.e., as described with reference to FIG. 2C, the left-hand back bracket 605c and the left-hand chair back wing 251c may be incorporated within a modular chair back assembly 235c).

Turning to FIG. 4D, a front, profile view of example modular standard assemblies 400d is depicted. The modular standard assemblies 400d may be similar to the modular standard assemblies 400c of FIG. 3C. The right-side modular standard assembly 400d may include a first mounting foot 403d, a second mounting foot 404d, a left-hand landing bracket 405d and a right-hand landing bracket 406d. The right-side modular standard assembly 400d may also include an arm rest and cup holder (not shown in FIG. 4D), an arm rest attachment 412d, a right-hand arm rest pivot mount 411d and a left-hand arm rest pivot mount 415d. The right-side modular standard assembly 400d may further include a right-hand seat bracket (not individually identified in FIG. 4D) and a spring assembly 1000d. For illustrative purposes, a right-hand seat pivot assembly 900d having a right-hand seat connector 901d is depicted proximate the right-side modular standard assembly 400d (i.e., as described with regard to FIG. 3H, the right-hand seat pivot assembly 900d may be incorporated within a modular chair seat assembly 316h). For further illustration, a right-hand back bracket 705d and a right-hand chair back wing 250d are depicted proximate the right-side modular standard assembly 400d (i.e., as described with reference to FIG. 2C, the right-hand back bracket 705d and the right-hand chair back wing 250d may be incorporated within a modular chair back assembly 235c).

With further reference to FIG. 4D, the center modular standard assembly 430d may include a mounting foot 431d, a left-hand landing bracket 432d and a right-hand landing bracket 433d. The center modular standard assembly 430d may also include an arm rest and cup holder (not shown in FIG. 4D), an arm rest attachment 412d, a right-hand arm rest pivot mount 411d and a left-hand arm rest pivot mount 415d. The center modular standard assembly 430d may further include a left-hand seat bracket (not individually identified in FIG. 4D), a right-hand seat bracket (not individually identified in FIG. 4D), a first spring assembly 1000d and a second spring assembly 1000d. For illustrative purposes, a left-hand seat pivot assembly 800d having a left-hand seat connector 801d and a right-hand seat pivot assembly 900d having a right-hand seat connector 901d are depicted proximate the center modular standard assembly 430d (i.e., as described with regard to FIG. 3H, the left-hand seat pivot assembly 800d and the right-hand seat pivot assembly 900d may be incorporated within a modular chair seat assembly 316h). For further illustration, a left-hand back bracket 605d, a left-hand chair back wing 251d, a right-hand back bracket 705d and a right-hand chair back wing 250d are depicted proximate the center modular standard assembly 430d (i.e., as described with reference to FIG. 2C, the left-hand back bracket 605d, the left-hand chair back wing 251d, the right-hand back bracket 705d and the right-hand chair back wing 250d may be incorporated within a modular chair back assembly 235c).

With yet further reference to FIG. 4D, the left-side modular standard assembly 460d may include a first mounting foot 462d, a second mounting foot 463d, a left-hand landing bracket 464d and a right-hand landing bracket 465d. The left-side modular standard assembly 460d may also include an arm rest and cup holder (not shown in FIG. 4D), an arm rest attachment 412d, a right-hand arm rest pivot mount 411d and a left-hand arm rest pivot mount 415d. The left-side modular standard assembly 460d may further include a left-hand seat bracket (not individually identified in FIG. 4D) and a spring assembly 1000d. For illustrative purposes, a left-hand seat pivot assembly 800d having a left-hand seat connector 801d is depicted proximate the left-side modular standard assembly 460d (i.e., as described with regard to FIG. 3H, the left-hand seat pivot assembly 800d may be incorporated within a modular chair seat assembly 316h). For further illustration, a left-hand back bracket 605d and a left-hand chair back wing 251d are depicted proximate the left-side modular standard assembly 460d (i.e., as described with reference to FIG. 2C, the left-hand back bracket 605d and the left-hand chair back wing 251d may be incorporated within a modular chair back assembly 235c).

Turning to FIG. 4E, a top, profile view of example modular standard assemblies 400e is depicted. The modular standard assemblies 400e may be similar to the modular standard assemblies 400d of FIG. 4D. The right-side modular standard assembly 400e may include a horizontal structural member 402e and a first mounting foot 403e. The right-side modular standard assembly 400e may also include an arm rest and cup holder (not shown in FIG. 4E) and an arm rest attachment 412e. The right-side modular standard assembly 400e may further include a right-hand seat bracket 715e. For illustrative purposes, a right-hand seat pivot assembly 900e having a right-hand seat connector 901e is depicted proximate the right-side modular standard assembly 400e (i.e., as described with regard to FIG. 3H, the right-hand seat pivot assembly 900e may be incorporated within a modular chair seat assembly 316h). For further illustration, a right-hand back bracket 705e and a right-hand chair back wing 250e with a first back wing fastening hole 252e and a second back wing fastening hole 253e are depicted proximate the right-side modular standard assembly 400e (i.e., as described with reference to FIG. 2C, the right-hand back bracket 705e and the right-hand chair back wing 250e may be incorporated within a modular chair back assembly 235c).

With further reference to FIG. 4E, the center modular standard assembly 430e may include an arm rest and cup holder (not shown in FIG. 4E) and an arm rest attachment 412b. The center modular standard assembly 430d may further include a left-hand seat bracket 615e and a right-hand seat bracket 715e. For illustrative purposes, a left-hand seat pivot assembly 800e having a left-hand seat connector 801e and a right-hand seat pivot assembly 900e having a right-hand seat connector 901e are depicted proximate the center modular standard assembly 430e (i.e., as described with regard to FIG. 3H, the left-hand seat pivot assembly 800e and the right-hand seat pivot assembly 900e may be incorporated within a modular chair seat assembly 316h). For further illustration, a left-hand back bracket 605e, a right-hand back bracket 705e, a right-hand chair back wing 250e with a first back wing fastening hole 252e and a second back wing fastening hole 253e and a left-hand chair back wing 251b with a first back wing fastening hole 259e and a second back wing fastening hole 260e are depicted proximate the center modular standard assembly 430e (i.e., as described with reference to FIG. 2C, the left-hand back bracket 605e, the right-hand back bracket 705e, the right-hand chair back wing 250e and the left-hand chair back wing 251e may be incorporated within a modular chair back assembly 235c).

With yet further reference to FIG. 4E, the left-side modular standard assembly 460e may include a first mounting foot 462e, an arm rest and cup holder (not shown in FIG. 4E) and an arm rest attachment 412e. The left-side modular standard assembly 460e may further include a left-hand back bracket 605e and a left-hand seat bracket 615e. For illustrative purposes, a left-hand seat pivot assembly 800e having a left-hand seat connector 801e is depicted proximate the left-side modular standard assembly 460e (i.e., as described with regard to FIG. 3H, the left-hand seat pivot assembly 800e may be incorporated within a modular chair seat assembly 316h). For further illustration, the left-hand back bracket 605e and the left-hand chair back wing 251e with a first back wing fastening hole 259e and a second back wing fastening hole 260e depicted proximate the left-side modular standard assembly 460e (i.e., as described with reference to FIG. 2C, the left-hand back bracket 605e and the left-hand chair back wing 251e may be incorporated within a modular chair back assembly 235c).

Turning to FIG. 4F, a front, top, perspective view of an example modular right-side standard assembly 400f is depicted. The modular right-side standard assembly 400f may be similar to the modular right-side standard assembly 400a of FIG. 4A. The right-side modular standard assembly 400f may include a vertical structural member 401f, a horizontal structural member 402f, a first mounting foot 403f and a second mounting foot 404f. The right-side modular standard assembly 400f may also include an arm rest and cup holder (not shown in FIG. 4F), an arm rest attachment 412f, an arm rest support 417f, a left-hand arm rest pivot mount 411f, a right-hand arm rest pivot mount 415f, an arm rest pivot ring 418f and an arm rest end cap 415f. The right-side modular standard assembly 400f may further include a left-hand landing bracket 405f, a right-hand landing bracket 406f, a spring assembly 1000f and a right-hand seat bracket 715f. The spring assembly 1000f may include a first fastener 1019f and a second fastener (not shown in FIG. 4F) that may attach the right-hand seat bracket 715f to the spring assembly 1000f. The spring assembly 1000f may further include a third fastener 1020f and a fourth fastener 1022f that may attach the spring assembly 1000f to the right-hand landing bracket 406f. While not shown in FIG. 4F, the modular right-hand standard 400f may further include a debris cover 196f, an end cover 113f and a host of fasteners for securing the various components and assemblies to one another. For illustrative purposes, a right-hand back bracket 705f is depicted proximate the right-side modular standard assembly 400f (i.e., as described with reference to FIG. 2C, the right-hand back bracket 705f may be incorporated within a modular chair back assembly 235c).

With reference to FIG. 4G, a front, top, exploded, perspective view of an example right-side modular standard 400g is depicted. The right-side modular standard 400g may be similar to the modular right-side standard 400f of FIG. 4F. The right-side modular standard assembly 400g may include a vertical structural member 401g, a horizontal structural member 402g, a first mounting foot 403g and a second mounting foot 404g. The right-side modular standard assembly 400g may also include an arm rest and cup holder (not shown in FIG. 4G), a left-hand arm rest pivot end cap 407g, a left-hand arm rest pivot ring 408g, a left-hand arm rest pivot support 409g, a left-hand arm rest pivot plate 410g, a left-hand arm rest pivot mount 411g, an arm rest attachment 412g, an arm rest pivot spacer 413g, an arm rest pivot shim 414g, a right-hand arm rest pivot mount 415g, a right-hand arm pivot plate 416g, a right-hand arm rest pivot support 417g, a right-hand arm rest pivot ring 418g and a right-hand arm rest pivot end cap 419g. The right-hand arm rest pivot plate 416g may include a first post 423g that may extend through a first right-hand arm rest support hole 425g, and a second post 424g that may extend through a second right-hand arm rest support hole 426g that may align the right-hand arm rest pivot plate 416g with the right-hand arm rest support 417g. The right-side modular standard assembly 400g may further include a left-hand landing bracket 405g, a right-hand landing bracket 406g, a spring assembly 1000g and a right-hand seat bracket 715g. The spring assembly 1000g may include a first fastener 1019g that extends through a first right-hand seat bracket hole 717g and a second fastener 1020g that extends through a second right-hand seat bracket hole (not shown in FIG. 4G), and that may attach the right-hand seat bracket 715g to the spring assembly 1000g. The spring assembly 1000g may further include a third fastener 1020g that may extend through a first right-hand landing bracket hole 422g and a fourth fastener 1022g that may extend through a second right-hand landing bracket hole 421g, and that may attach the spring assembly 1000g to the right-hand landing bracket 406g. While not shown in FIG. 4G, the modular right-hand standard 400g may further include a debris cover 196g, an end cover 113g and a host of fasteners that may secure the various components and assemblies to one another. For illustrative purposes, a right-hand back bracket 705g is depicted proximate the right-side modular standard assembly 400g (i.e., as described with reference to FIG. 2C, the right-hand back bracket 705g may be incorporated within a modular chair back assembly 235c). The right-hand chair back bracket 705g may be secured to the right-hand chair seat bracket 715g via a fastener (not shown in FIG. 4G) extending through the hole 710g and the opening 713g.

Turning to FIG. 4H, a front, top, perspective view of an example center modular standard assembly 430h is depicted. The center modular standard assembly 430h may be similar to the center modular standard assembly 430a of FIG. 4A. The center modular standard assembly 430h may include a vertical structural member 434h and a mounting foot 431h. The center modular standard assembly 430h may also include an arm rest and cup holder (not shown in FIG. 4H), an arm rest attachment 412h, a left-hand arm rest pivot mount 411h, a right-hand arm rest pivot mount 415h, a right-hand arm rest pivot ring 418h and a right-hand arm rest pivot end cap 419h. The center modular standard assembly 430h may further include a left-hand landing bracket 432h, a right-hand landing bracket 433h, a left-hand seat bracket 615h, a right-hand seat bracket 715h, a first spring assembly 1000h with a first fastener 1019h and a second spring assembly 1000h. While not shown in FIG. 4H, center modular standard assembly 430h may also include a debris cover and a host of fasteners for securing the various components and assemblies to one another. For illustrative purposes, a left-hand seat pivot assembly 800h having a left-hand seat connector 801h and a left-hand seat pivot assembly mounting hole 812h, and a right-hand seat pivot assembly 900h having a right-hand seat connector 901h are depicted proximate the center modular standard assembly 430h (i.e., as described with regard to FIG. 3H, the left-hand seat pivot assembly 800h and the right-hand seat pivot assembly 900h may be incorporated within a modular chair seat assembly 316h). For further illustration, a left-hand back bracket 605h, a right-hand back bracket 705h, a right-hand chair back wing 250h with a first back wing fastening hole 252h and a second back wing fastening hole 253h, and a left-hand chair back wing 251h are depicted proximate the center modular standard assembly 430h (i.e., as described with reference to FIG. 2C, the left-hand back bracket 605h, the right-hand back bracket 705h, the right-hand chair back wing 250h and the left-hand chair back wing 251h may be incorporated within a modular chair back assembly 235c).

With reference to FIG. 4J, a front, top, exploded, perspective view of an example center modular standard assembly 430j is depicted. The center modular standard assembly 430j may be similar to the center modular standard assembly 430h of FIG. 4H. The center modular standard assembly 430j may include a vertical structural member 434j and a mounting foot 431j. The mounting foot 431j may include a plurality of mounting holes 429j, for receiving respective fasteners (not shown in FIG. 4J) for securing the center modular standard assembly 430j within an installation, and an opening 435j for receiving the vertical structural member 434j. The center modular standard assembly 430h may also include an arm rest and cup holder (not shown in FIG. 4J), a left-hand arm rest pivot end cap 407j, a left-hand arm rest pivot ring 408j, a left-hand arm rest pivot support 409j, a left-hand arm rest pivot plate 410j, a left-hand arm rest pivot mount 411j, an arm rest attachment 412j, an arm rest pivot spacer 413j, an arm rest pivot shim 414j, a right-hand arm rest pivot mount 415j, a right-hand arm pivot plate 416j, a right-hand arm rest pivot support 417j, a right-hand arm rest pivot ring 418j and a right-hand arm rest pivot end cap 419j. The center modular standard assembly 430j may further include a left-hand landing bracket 432j, a right-hand landing bracket 433j, a left-hand seat bracket 615j, a right-hand seat bracket 715j, a first spring assembly 1000j with a first fastener 1019j and a second spring assembly 1000j. The left-hand landing bracket 405j may include a first hole 427j and a second hole 436j that may receive a fastener (not shown in FIG. 4J) for fastening the left-hand landing bracket 405j to the vertical structural member 434j. The left-hand landing bracket 405j may also include a third hole 428j for receiving a fastener (not shown in FIG. 4J) for fastening a debris cover (not shown in FIG. 4J) to the left-hand landing bracket 405j. The left-hand seat bracket 615j may include a seat mounting bolt hole 614j. The right-hand landing bracket 406j may include a first hole 422j and a second hole 423j that may receive a fastener (not shown in FIG. 4J) for fastening the right-hand landing bracket 406j to the vertical structural member 434j. The right-hand landing bracket 406j may also include a third hole 424j for receiving a fastener (not shown in FIG. 4J) for fastening a debris cover (not shown in FIG. 4J) to the right-hand landing bracket 406j. The right-hand seat bracket 715j may include a seat mounting bolt hole 714j. The first spring assembly 1000j may include a first fastener 1019j that extends through a first left-hand seat bracket hole 617j and a second fastener 1020j that extends through a second left-hand seat bracket hole 616j, and that may attach the left-hand seat bracket 715j to the first spring assembly 1000j. The first spring assembly 1000j may further include a third fastener 1020j that may extend through a first left-hand landing bracket hole 425j and a fourth fastener 1022j that may extend through a second left-hand landing bracket hole 426j, and that may attach the first spring assembly 1000j to the left-hand landing bracket 406j. The second spring assembly 1000j may include a first fastener 1019j that extends through a first right-hand seat bracket hole 717j and a second fastener 1020j that extends through a second right-hand seat bracket hole 716j, and that may attach the right-hand seat bracket 715j to the second spring assembly 1000j. The second spring assembly 1000j may further include a third fastener 1020j that may extend through a first right-hand landing bracket hole 420j and a fourth fastener 1022j that may extend through a second right-hand landing bracket hole 421j, and that may attach the second spring assembly 1000j to the right-hand landing bracket 406j. While not shown in FIG. 4J, center modular standard assembly 430j may also include a debris cover 196j and a host of fasteners for securing the various components and assemblies to one another. For illustrative purposes, a left-hand back bracket 605j and a right-hand back bracket 705j are depicted proximate the center modular standard assembly 430j (i.e., as described with reference to FIG. 2C, the left-hand back bracket 605j and the right-hand back bracket 705j may be incorporated within a modular chair back assembly 235c). The right-hand chair back bracket 705j may be secured to the right-hand chair seat bracket 715j via a fastener (not shown in FIG. 4J) extending through the hole 710j and the opening 713j, and with the right-hand chair seat bracket alignment tab 712j received within the right-hand chair back bracket pocket 709j.

Turning to FIG. 4K, a front, top, perspective view of an example modular left-side standard assembly 460k is depicted. The modular left-side standard assembly 460k may be similar to the modular left-side standard assembly 460a of FIG. 4A. The left-side modular standard assembly 460k may include a vertical structural member 466k, a horizontal structural member 461k, a first mounting foot 462k, a second mounting foot 463k, a left-hand landing bracket 464k and a right-hand landing bracket 465k. The left-side modular standard assembly 460k may also include an arm rest and cup holder (not shown in FIG. 4K), an arm rest attachment 412k, a right-hand arm rest pivot mount 415k, a right-hand arm rest pivot ring 418k and a right-hand arm rest pivot end cap 419k. The left-side modular standard assembly 460k may further include a left-hand seat bracket 615k and a spring assembly 1000k with a first spring fastener 1019k extending through a first left-hand seat bracket hole (not individually identified in FIG. 4K), and a second spring fastener 1020k extending through a second left-hand seat bracket hole (not individually identified in FIG. 4K). For illustrative purposes, a left-hand seat pivot assembly 800k having a left-hand seat connector 801k is depicted proximate the left-side modular standard assembly 460k (i.e., as described with reference to FIG. 3H, the left-hand seat pivot assembly 800k may be incorporated within a modular chair seat assembly 316H). For further illustration, a left-hand back bracket 605k and a left-hand chair back wing 251k are depicted proximate the left-side modular standard assembly 460k (i.e., as described with reference to FIG. 2C, the left-hand back bracket 605k and the left-hand chair back wing 251k may be incorporated within a modular chair back assembly 235c).

With reference to FIG. 4L, a front, top, exploded, perspective view of an example modular left-side standard assembly 460l is depicted. The modular left-side standard assembly 460l may be similar to the modular left-side standard assembly 460l of FIG. 4L. The left-side modular standard assembly 460l may include a vertical structural member 466l, a horizontal structural member 461l, a first mounting foot 462l, a second mounting foot 463l, a left-hand landing bracket 464l and a right-hand landing bracket 465l. The left-hand landing bracket 464l may include a first hole 468l and a second hole 469l that may receive a fastener (not shown in FIG. 4L) for fastening the left-hand landing bracket 464l to the vertical structural member 466l. The left-hand landing bracket 464l may also include a third hole 474l for receiving a fastener (not shown in FIG. 4L) for fastening a debris cover (not shown in FIG. 4L) to the left-hand landing bracket 464l. The right-hand landing bracket 465l may include a first hole 472l and a second hole (not shown in FIG. 4L) that may receive a fastener (not shown in FIG. 4L) for fastening the right-hand landing bracket 465l to the vertical structural member 466l. The right-hand landing bracket 465l may also include a third hole 475l for receiving a fastener (not shown in FIG. 4L) for fastening a debris cover (not shown in FIG. 4L) to the right-hand landing bracket 465l. The left-side modular standard assembly 460l may also include an arm rest and cup holder (not shown in FIG. 4L), a left-hand arm rest pivot end cap 407l, a left-hand arm rest pivot ring 408l, a left-hand arm rest pivot support 409l, a left-hand arm rest pivot plate 410l, a left-hand arm rest pivot mount 411l, an arm rest attachment 412l, an arm rest pivot spacer 413l, an arm rest pivot shim 414l, a right-hand arm rest pivot mount 415l, a right-hand arm pivot plate 416l, a right-hand arm rest pivot support 417l, a right-hand arm rest pivot ring 418l and a right-hand arm rest pivot end cap 419l. While not shown in FIG. 4L, the modular left-hand standard 460l may further include a debris cover 198l, an end cover 199l and a host of fasteners that may secure the various components and assemblies to one another. The left-side modular standard assembly 460l may further include a left-hand seat bracket 615l and a spring assembly 1000l with a first spring fastener 1019l extending through a first left-hand seat bracket hole 617l and a second spring fastener 1020l extending through a second left-hand seat bracket hole 614l. For illustrative purposes, a left-hand seat pivot assembly 800l having a left-hand seat connector 801l and a left-hand seat pivot assembly mounting hole 812l is depicted proximate the left-side modular standard assembly 460l (i.e., as described with reference to FIG. 3H, the left-hand seat pivot assembly 800l may be incorporated within a modular chair seat assembly 316H). For further illustration, a left-hand back bracket 605l and a left-hand chair back wing 251l are depicted proximate the left-side modular standard assembly 460l (i.e., as described with reference to FIG. 2C, the left-hand back bracket 605l and the left-hand chair back wing 251l may be incorporated within a modular chair back assembly 235c). The left-hand chair back wing 251l may include a first fastener 240l and a second fastener 242l that may be received within a respective first hole 259l and second hole 260l to secure a chair back structural member (not shown in FIG. 4L) to the left-hand chair back wing 251l. The left-hand chair back wing 251l may be secured to the left-hand chair back bracket 605l via a first fastener (not shown in FIG. 4L) extending through a third chair back wing hole 256l and a first chair back bracket hole 606l, and a second fastener (not shown in FIG. 4L) extending through a fourth chair back wing hole 257l and a second chair back bracket hole 607l The right-hand chair back bracket 605l may be secured to the right-hand chair seat bracket 615l via a fastener (not shown in FIG. 4L) extending through the hole 610l and the opening 613l.

Turning to FIG. 4M, a front, top, perspective view of an example modular right-side standard assembly 400m is depicted. The modular right-side standard assembly 400m may be similar to the modular right-side standard assembly 400a of FIG. 4A. The right-side modular standard assembly 400m may include a vertical structural member 401m, a first mounting foot 403m and a second mounting foot 404m. The first mounting foot 403m may be substantially similar to the second mounting foot 404m and the two may be configured such that the right-hand standard assembly 400m may be level with respect to an associated mounting surface during installation. The right-side modular standard assembly 400m may also include an arm rest 190m, cup holder 191m, a left-hand arm rest pivot mount 411m, an arm rest pivot ring 408m and an arm rest pivot end cap 407m. The right-side modular standard assembly 400m may further include an end panel 405m, a right-hand landing bracket 406m, a spring assembly 1000m and a right-hand seat bracket 715m. The spring assembly 1000m may include a first fastener 1019f with related first nut 437m and a second fastener 1020m with related second nut 436m that may attach the right-hand seat bracket 715m to the spring assembly 1000m. The spring assembly 1000m may further include a third fastener (not shown in FIG. 4M) and a fourth fastener (not shown in FIG. 4M) that may attach the spring assembly 1000m to the right-hand landing bracket 406m. The right-side modular standard assembly 400m may further include a seat pivot mounting bolt 438m for securing a chair seat assembly (not shown in FIG. 4M) to the right-side modular standard assembly 400m. While not shown in FIG. 4M, the modular right-hand standard 400m may further include a debris cover 196m and a host of fasteners for securing the various components and assemblies to one another.

With reference to FIG. 4N, a front, top, exploded, perspective view of an example right-side modular standard 400n is depicted. The right-side modular standard 400n may be similar to the modular right-side standard 400m of FIG. 4M. The right-side modular standard assembly 400n may include a vertical structural member 401n, a first mounting foot 403n and a second mounting foot 404n. The right-side modular standard assembly 400n may also include an arm rest 190n, a cup holder 191n, a left-hand arm rest pivot end cap 407n, a left-hand arm rest pivot ring 408n, a left-hand arm rest pivot support 409n, a left-hand arm rest pivot plate 410n, a left-hand arm rest pivot mount 411n, an arm rest attachment 412n, an arm rest pivot spacer 413n, an arm rest pivot shim 414n, a right-hand arm rest pivot mount 415n, a right-hand arm pivot plate 416n, a right-hand arm rest pivot support 417n, a right-hand arm rest pivot ring 418n, a right-hand arm rest pivot end cap 419n and an arm rest cover 435n. The arm rest cover 435n may be secured to the arm rest attachment 412n via a first fastener 440n extending through a first arm rest cover hole 436n and a first arm rest attachment hole 444n, a second fastener 441n extending through a second arm rest cover hole 437n and a second arm rest attachment hole 445n, a third fastener 442n extending through a third arm rest cover hole 438n and a third arm rest attachment hole 446n, and a fourth fastener 443n extending through a fourth arm rest cover hole 439n and a fourth arm rest attachment hole 447n. The right-side modular standard assembly 400n may further include an end plate 405n, a right-hand landing bracket 406n, a debris cover attachment 407n, a spring assembly 1000n, a right-hand seat bracket 715n and a seat pivot mounting bolt 429n. The spring assembly 1000n may include a first fastener 1019n that extends through a first right-hand seat bracket hole 717n to a first nut 434n and a second fastener 1020n that extends through a second right-hand seat bracket hole (not shown in FIG. 4N) to a second nut 432n, and that may attach the right-hand seat bracket 715n to the spring assembly 1000n. The spring assembly 1000n may further include a third fastener 1021n that may extend through a first right-hand landing bracket hole 422n to a third nut 431n and a fourth fastener 1022n that may extend through a second right-hand landing bracket hole 421n to a fourth nut 430n, and that may attach the spring assembly 1000n to the right-hand landing bracket 406n. The spring assembly 1000n may also include an over-travel bolt 426n that may extend through a related washer 427n through the spring assembly 1000n to a nut 428n to limit the distance that the associated rocker style chair can rock backward. While not shown in FIG. 4N, the modular right-hand standard 400n may further include a debris cover 196n and a host of fasteners that may secure the various components and assemblies to one another.

Turning to FIG. 4P, a front, top, perspective view of an example center modular standard assembly 430p is depicted. The center modular standard assembly 430p may be similar to the center modular standard assembly 430a of FIG. 4A. The center modular standard assembly 430p may include a vertical structural member 434p, a first mounting foot 431p and a second mounting foot 432p. The center modular standard assembly 430p may also include an arm rest 192p, a cup holder 193p, a right-hand arm rest pivot mount 415p, a left-hand arm rest pivot ring 408p and a left-hand arm rest pivot end cap 407p. The center modular standard assembly 430p may further include a left-hand landing bracket 405p, a right-hand landing bracket (not shown in FIG. 4P), a debris cover attachment 433p, a left-hand seat bracket 615p, a right-hand seat bracket 715p, a first spring assembly 1000p and a second spring assembly 1000p. The center modular standard assembly 430p may further include first and second seat assembly attachment bolts 454p for attaching respective seat assemblies (not shown in FIG. 4P) to the center modular standard assembly 430p. The first spring assembly 1000p may include a fourth fastener 1022p and nut 440p and a first over-travel bolt 438p with related washer 439p. The second spring assembly 1000p may include a first fastener 1019p with related nut 437p and a second fastener 1020p with related nut 436p. While not shown in FIG. 4P, center modular standard assembly 430p may also include a debris cover and a host of fasteners for securing the various components and assemblies to one another.

With reference to FIG. 4Q, a front, top, exploded, perspective view of an example center modular standard assembly 430q is depicted. The center modular standard assembly 430q may be similar to the center modular standard assembly 430p of FIG. 4P. The center modular standard assembly 430q may include a vertical structural member 434q, a first mounting foot 431q, a second mounting foot 432q and a debris cover attachment 433q. The center modular standard assembly 430q may also include an arm rest 192q, a cup holder 193q, a left-hand arm rest pivot end cap 407q, a left-hand arm rest pivot ring 408q, a left-hand arm rest pivot support 409q, a left-hand arm rest pivot plate 410q, a left-hand arm rest pivot mount 411q, an arm rest attachment 412q, an arm rest pivot spacer 413q, an arm rest pivot shim 414q, a right-hand arm rest pivot mount 415q, a right-hand arm pivot plate 416q, a right-hand arm rest pivot support 417q, a right-hand arm rest pivot ring 418q, a right-hand arm rest pivot end cap 419q and arm rest cover 441q. The arm rest cover 441q may be secured to the arm rest attachment 412q via a first fastener 446q extending through a first arm rest cover hole 442q and a first arm rest attachment hole 450q, a second fastener 447q extending through a second arm rest cover hole 443q and a second arm rest attachment hole 451q, a third fastener 448q extending through a third arm rest cover hole 444q and a third arm rest attachment hole 452q and a fourth fastener 449q extending through a fourth arm rest cover hole 445q and a fourth arm rest attachment hole 453q. The center modular standard assembly 430q may further include a left-hand landing bracket 405q, a right-hand landing bracket 406q, a left-hand seat bracket 615q, a right-hand seat bracket 715q, a first spring assembly 1000q and a second spring assembly 1000q. The first spring assembly 1000q may include a first fastener 1019q that extends through a first right-hand seat bracket hole (not individually identified in FIG. 4Q) to a first nut 437q and a second fastener 1020q that extends through a second right-hand seat bracket hole (not individually identified in FIG. 4Q) to a second nut 436q, and that may attach the right-hand seat bracket 715q to the first spring assembly 1000q. The first spring assembly 1000q may further include a third fastener 1021q that may extend through a first right-hand landing bracket hole 422q to a third nut 435q and a fourth fastener 1022q that may extend through a second right-hand landing bracket hole 423q to a fourth nut 455q, and that may attach the first spring assembly 1000q to the left-hand landing bracket 405q. The first spring assembly 1000q may also include an over-travel bolt 438q that may extend through a related washer 439q through the first spring assembly 1000q to a nut 440q to limit the distance that the associated rocker style chair can rock backward. The second spring assembly 1000q may include a first fastener 1019q that extends through a first right-hand seat bracket hole 717q to a first nut 437q and a second fastener 1020q that extends through a second right-hand seat bracket hole (not shown in FIG. 4Q) to a second nut 436q, and that may attach the right-hand seat bracket 715q to the second spring assembly 1000q. The second spring assembly 1000q may further include a third fastener 1021q that may extend through a first right-hand landing bracket hole 420q to a third nut 435q and a fourth fastener 1022q that may extend through a second right-hand landing bracket hole 421q to a fourth nut 455q, and that may attach the second spring assembly 1000q to the right-hand landing bracket 406q. The second spring assembly 1000q may also include an over-travel bolt 438q that may extend through a related washer 439q through the second spring assembly 1000q to a nut 440q to limit the distance that the associated rocker style chair can rock backward. The center modular standard assembly 430q may include a first chair seat assembly mounting bolt 454q for attaching a first chair seat assembly (not shown in FIG. 4Q) to the center modular standard assembly 430q and a second chair seat assembly mounting bolt 454q extending through a right-hand chair bracket hole 714q for attaching a second chair seat assembly (not shown in FIG. 4Q) to the center modular standard assembly 430q. While not shown in FIG. 4Q, center modular standard assembly 430q may also include a debris cover and a host of fasteners for securing the various components and assemblies to one another.

Turning to FIGS. 4R and 4S, a front, right-side perspective view of an example center standard 430r is shown along with a front, right-side, exploded, perspective view 430s. The reference numbers shown in FIGS. 4R and 4S are generally similar to previous FIGS. 4A-4H and 4J-4Q aside from the first zip-tie 460r, 460s, the second zip-tie 461s, the first zip-tie hole 630r, 630s, the second zip-tie hole 506r, 506s, the third zip-tie hole 730s and the fourth zip-tie hole 473s. The first zip-tie 460r, 460s, the first zip-tie hole 630r, 630s and the second zip-tie hole 506r, 506s may be configured to function as a forward over travel limiter to prevent an associated rocker style chair from rocking too far forward. The second zip-tie 461s, the third zip-tie hole 730s and the fourth zip-tie hole 473s may be configure to further function as a forward over travel limiter. Accordingly, the zip-ties 460r, 460s, 461r, 461s may prevent damage to a corresponding spring assembly 1000r, 1000s.

Turning to FIGS. 4T and 4U, a front, right-side perspective view of an example center standard 430t is shown along with a front, right-side, exploded, perspective view 430u. The reference numbers shown in FIGS. 4T and 4U are generally similar to previous FIGS. 4A-4H and 4J-4Q aside from the first forward over-travel bolt 460t, 460u, the second over-travel bolt 461t, 461u, the over-travel bolt hole (not individually identified in FIG. 4T or 4U), the second over-travel bolt hole (not individually identified in FIG. 4T or 4U), the third over-travel bolt hole (not individually identified in FIG. 4T or 4U) and the fourth over-travel bolt hole (not individually identified in FIG. 4T or 4U). The first over-travel bolt 460t, 460u, the first over-travel bolt hole (not individually identified in FIG. 4T or 4U) and the second over-travel bolt hole (not individually identified in FIG. 4T or 4U) may be configured to function as a forward over travel limiter to prevent an associated rocker style chair from rocking too far forward. The second over-travel bolt 461t, 461u, the third over-travel bolt hole (not individually identified in FIG. 4T or 4U) and the fourth over-travel bolt hole (not individually identified in FIG. 4T or 4U) may be configure to further function as a forward over travel limiter. Accordingly, the over-travel bolts 460t, 460u, 461t, 461u may prevent damage to a corresponding spring assembly 1000t, 1000u.

Turning to FIGS. 4V-4Y, an example standard assembly 430v, 430w, 430x, 430y is depicted. The example standard assembly 430v, 430w, 430x, 430y may include a single piece standard 401v, 401w, 401x, 401y that may be constructed from a metal casting, an aluminum casting, an iron casting, a molded plastic, a blow-molded plastic, a composite material or the like. In any event, the standard assembly 430v, 430w, 430x, 430y may include a mounting foot 431v, 431w, 431x, 430y, an arm rest 190v, 190w, 190x, 190y, a decorative end panel 196v, 196w, 196x, 196y, a left-hand seat mount hole 405v, 405w, 405x, 405y and a right-hand seat mount hole 406v, 406w, 406x, 406y.

While the standard assembly 430v, 430w, 430x, 430y is described herein as a part of a rocker style chair, the standard assembly 430v, 430w, 430x, 430y may be used in conjunction with a non-rocker style chair. The key areas of the standard assembly 430v, 430w, 430x, 430y are: 1) a chair back may be held in position on the standard 401v, 401w, 401x, 401y by features 261w, 261x, 261y, 262w, 262x, 262y, 263w, 263x, 263y, 264w, 264x, 264y on the wing 260w, 260x, 260y and standard 418w, 418y, 419w, 419y which cooperate to allow an associated seat back to be held in a location facilitating unassisted installation, thereby, reducing installation labor, materials, time and cost while allowing seat back angle adjustment. Features which cooperate to effect the standard assembly 430v, 430w, 430x, 430y are: a) Slot 261w, 261x, 261y, 262w, 262x, 262y, 263w, 263x, 263y on the wing 260w, 260x, 260y which engages the post 419w, 419y on the casting 401v, 401w, 401x, 401y which limits seat back movement and b) Wing 260w, 260x, 260y offset 264w, 264x, 264y which engages a rib 418w, 418y on the standard 401v, 401w, 401x, 401y which limits seat back movement.

While the standard assembly 430v, 430w, 430x, 430y is illustrated with a cast standard and stamping 401v, 401w, 401x, 401y, those skilled in the art may devise cooperating features in components made with other materials or process. For example, a standard 401v, 401w, 401x, 401y made from sheet metal with features which cooperate to limit back movement is contemplated. While the standard assembly 430v, 430w, 430x, 430y is illustrated with a wing 260w, 260x, 260y which may engage the standard 401v, 401w, 401x, 401y at the bottom of the wing 264w, 264x, 264y, those skilled in the art may devise cooperating features located at other relative positions between the cooperation components. The end panel 196v, 196w, 196x, 196y may be held in position by interlocking features 197w, 197y, 409w, 409y, 198w, 198y, 417w, 417y 199w, 199y, 405w, 405y and limited number of fasteners (not shown in FIGS. 4V-4Y). While the standard assembly 430v, 430w, 430x, 430y is illustrated with a cast standard 401v, 401w, 401x, 401y and end panel 196v, 196w, 196x, 196y, those skilled in the art may devise cooperating features in components made with other materials or process.

Turning to FIGS. 4Z1-4Z2, various views of an example right-end standard assembly 400z1, 400z2, 400z3, 400z4 are depicted. The right-end standard assembly 400z1, 400z2, 400z3, 400z4 may include a right-hand standard 405z1, 405z2, 405z3, 405z4, a right-hand debris cover 410z1, 410z2, 410z3, 410z4 and a right-hand end panel 415z1, 415z2, 415z3, 415z4. While only a right-hand standard assembly 400z1, 400z2, 400z3, 400z4 is depicted in FIGS. 4Z1-4Z2, a left-hand standard assembly may be similar to a mirror image of the right-hand standard assembly 400z1, 400z2, 400z3, 400z4.

With reference to FIG. 5A, a rear, top, perspective view of an example left-side assembly 500a is depicted to include a spring assembly 1000a in proximity to a left-hand seat bracket 615a and a left-hand landing bracket 505a for illustrative purposes. The left-side assembly 500a may also include a seat assembly attachment bolt 518a. The left-hand seat bracket 615a may include a securing slot 613a between an alignment tab 612a and lip 611a. As described herein, the spring assembly 1000a, the left-hand seat bracket 615a and the left-hand landing bracket 505a may be incorporated within various modular standard assemblies. While a left-hand seat bracket 615a and the left-hand landing bracket 505a are depicted in FIG. 5A, a spring assembly 1000a may be combined with a right-hand seat bracket and a right-hand landing bracket in a similar manner. The spring assembly 1000a may include a first fastener 1019a that may extend through a first left-hand seat bracket hole (not individually identified in FIG. 5A) to a first nut 516a and a second fastener 1020a that may extend through a second left-hand seat bracket hole (not individually identified in FIG. 5A) to a second nut 517a to secure the left-hand seat bracket 615a to the spring assembly 1000a. The left-side assembly 500a may also include an over-travel bolt 519a in proximity with a left-hand seat bracket hole 614a. The left-hand landing bracket 505a may include a horizontal surface 510a extending at substantially ninety-degree angle with respect to a vertical surface 511a. The left-hand landing bracket 505a may further include a first mounting hole 506a, a second mounting hole 507a, a third hole 508a and a notch 509a.

Turning to FIG. 5B, an exploded, perspective, view of an example left-side assembly 500b is depicted to include a spring assembly 1000b in proximity to a left-hand seat bracket 615b and a left-hand landing bracket 505b for illustrative purposes. The left-side assembly 500b may be similar to the left-side assembly 500a of FIG. 5A. The left-side assembly 500b may also include a seat assembly attachment bolt 518b that may extend through a left-side seat bracket hole 614b. The left-hand seat bracket 615b may include an alignment tab 612b. The spring assembly 1000b may include a first fastener 1019b that may extend through a first left-hand seat bracket hole 617b to a first nut 516b and a second fastener 1020b that may extend through a second left-hand seat bracket hole 616b to a second nut 517b to secure the left-hand seat bracket 615b to the spring assembly 1000b. The left-side assembly 500b may also include an over-travel bolt 519b extending through a washer 520b and extending through a passage 1011b in a spring assembly bushing 1010b to a nut 521b. The nut 521b may be trapped within left-hand seat bracket hole 618b. The spring assembly 1000b may also include a third fastener 1021b that may extend through a first left-hand landing bracket hole 512b to a third nut 514b and a fourth fastener 1022b that may extend through a second left-hand landing bracket hole 513b to a fourth nut 515b to secure the spring assembly 1000b to the left-hand landing bracket 505b. The left-hand landing bracket 505b may include horizontal surfaces 510b extending at substantially a ninety-degree angle with respect to a vertical surface 511b. The left-hand landing bracket 505b may further include a third hole 508b and a notch 509b. The notch 509b may accommodate the over-travel bolt 519b being placed within the spring assembly 1000b and the left-hand seat bracket 615b prior to the spring assembly 1000b being secured to the left-hand landing bracket 505b.

As reflected in FIG. 5B, the left-hand seat bracket 615b may include a substantially flat bottom surface 534b configured to rest on a substantially flat top surface 533b of a spring assembly 1000b. The spring assembly 1000b may further include a substantially flat lower surface 532b configured to rest on a substantially flat upper surface 531b of a left-hand landing bracket 505b. The substantially flat surfaces 531b-534b increase rigidity and stability of the left-side assembly 500b when compared to alternate non-flat surfaces.

FIG. 5C depicts a front, bottom, perspective view of a left-side assembly 500c is depicted to include a spring assembly 1000c in proximity to a left-hand seat bracket 615c and a left-hand landing bracket 505c for illustrative purposes. The left-side assembly 500c may be similar to the left-side assembly 500a of FIG. 5A. The left-side assembly 500c may also include a seat assembly attachment bolt 518c. The left-hand seat bracket 615c may include a securing slot 613c between an alignment tab 612c and lip 611c. The spring assembly 1000c may include a first fastener 1019c that may extend through a first left-hand seat bracket hole (not individually identified in FIG. 5C) to a first nut 516c to secure the left-hand seat bracket 615c to the spring assembly 1000c. The left-side assembly 500c may also include an over-travel bolt 519c extending through a washer 520c and extending through the spring assembly 1000c. The spring assembly 1000c may also include a third fastener 1021c that may extend through a first left-hand landing bracket hole (not individually identified in FIG. 5C) to a third nut 514c and a fourth fastener 1022c that may extend through a second left-hand landing bracket hole (not individually identified in FIG. 5C) to a fourth nut 515c to secure the spring assembly 1000c to the left-hand landing bracket 505c. The left-hand landing bracket 505c may include horizontal surfaces 510c extending at substantially a ninety-degree angle with respect to a vertical surface 511c. The left-hand landing bracket 505c may further include a first mounting hole 506c, a second mounting hole 507c, a third hole 508c and a notch (not individually identified in FIG. 5C) for receiving a spring assembly rubber bushing 1015c.

Turning to FIG. 5D, an exploded, perspective, view of an example left-side assembly 500d is depicted to include a spring assembly 1000d in proximity to a left-hand seat bracket 615d and a left-hand landing bracket 505d for illustrative purposes. The left-side assembly 500d may be similar to the left-side assembly 500a of FIG. 5A. The left-side assembly 500d may also include a seat assembly attachment bolt 518d that may extend through a left-side seat bracket hole (not individually identified in FIG. 5D). The left-hand seat bracket 615d may include a securing slot 613d between an alignment tab 612d and lip 612d. The spring assembly 1000d may include a first fastener 1019d that may extend through a first left-hand seat bracket hole 617d to a first nut 516d and a second fastener 1020d that may extend through a second left-hand seat bracket hole 616d to a second nut 517d to secure the left-hand seat bracket 615d to the spring assembly 1000d. The left-side assembly 500d may also include an over-travel bolt 519d extending through a washer 520d and extending through a passage 1040d in a spring assembly bushing 1010d, 1015d to a nut 521d. The nut 521d may be trapped within left-hand seat bracket hole (not individually identified in FIG. 5D). The spring assembly 1000d may also include a third fastener 1021d that may extend through a first left-hand landing bracket hole 512d to a third nut 514d and a fourth fastener 1022d that may extend through a second left-hand landing bracket hole 513d to a fourth nut 515d to secure the spring assembly 1000d to the left-hand landing bracket 505d. The left-hand landing bracket 505d may include horizontal surfaces 510d extending at substantially a ninety-degree angle with respect to a vertical surface 511d. The left-hand landing bracket 505d may further include a first mounting hole 506d, a second mounting hole 507d, a third hole 508d and a notch 509d.

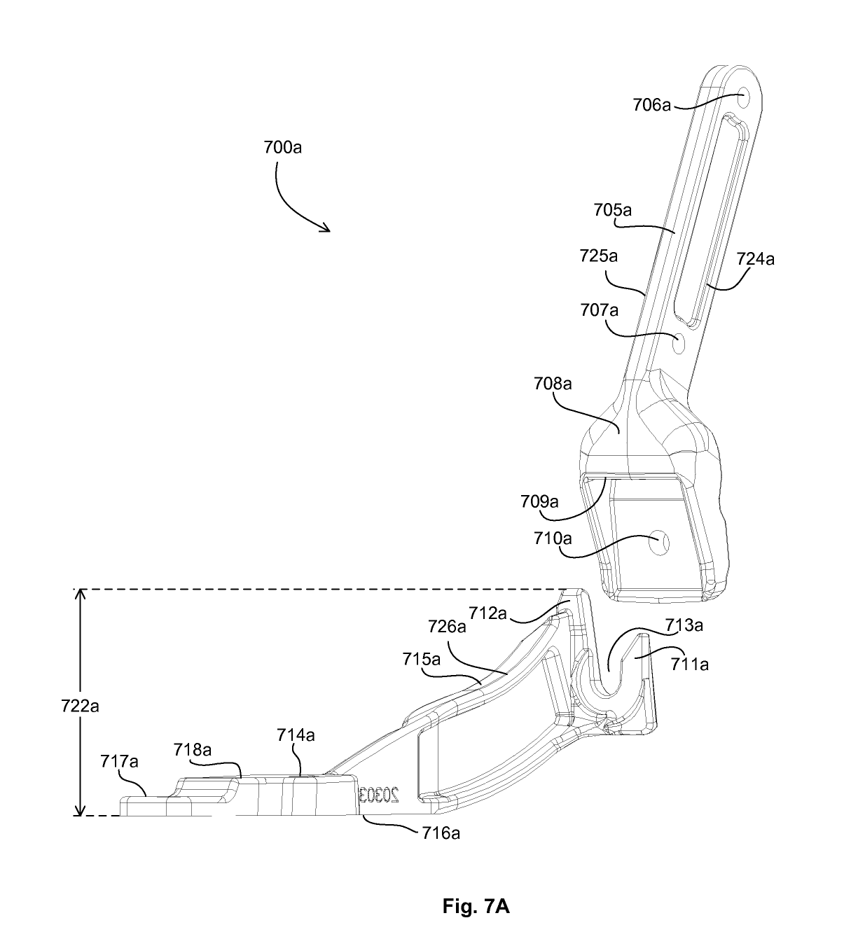

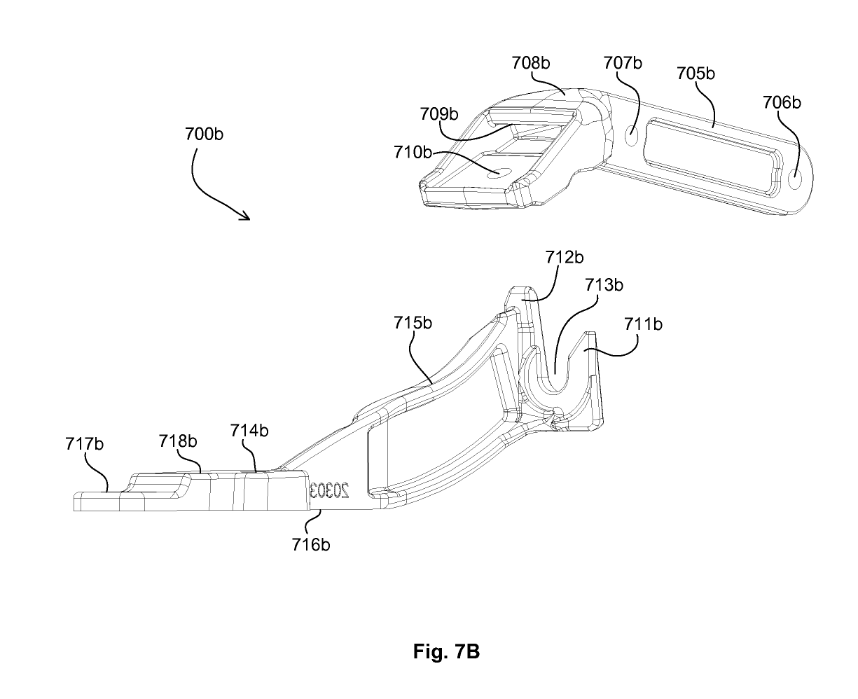

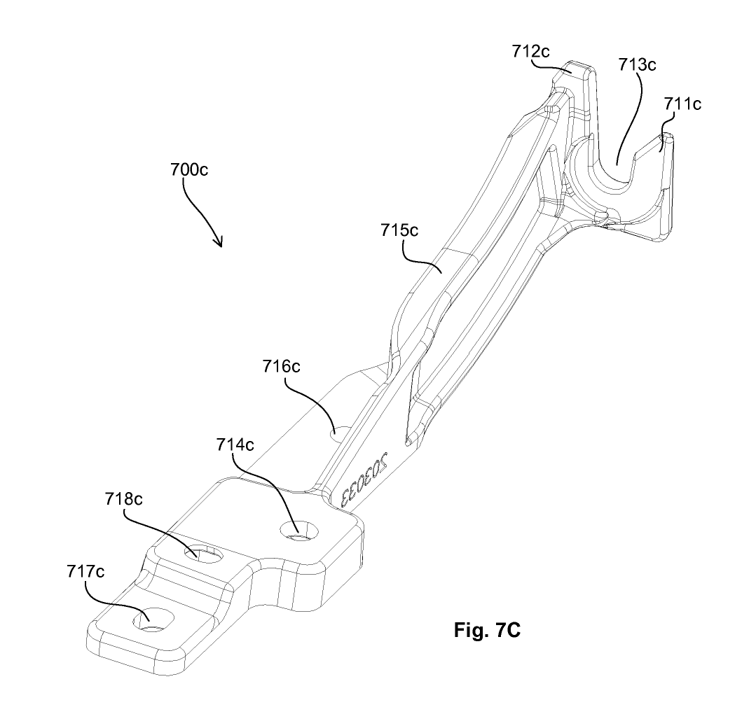

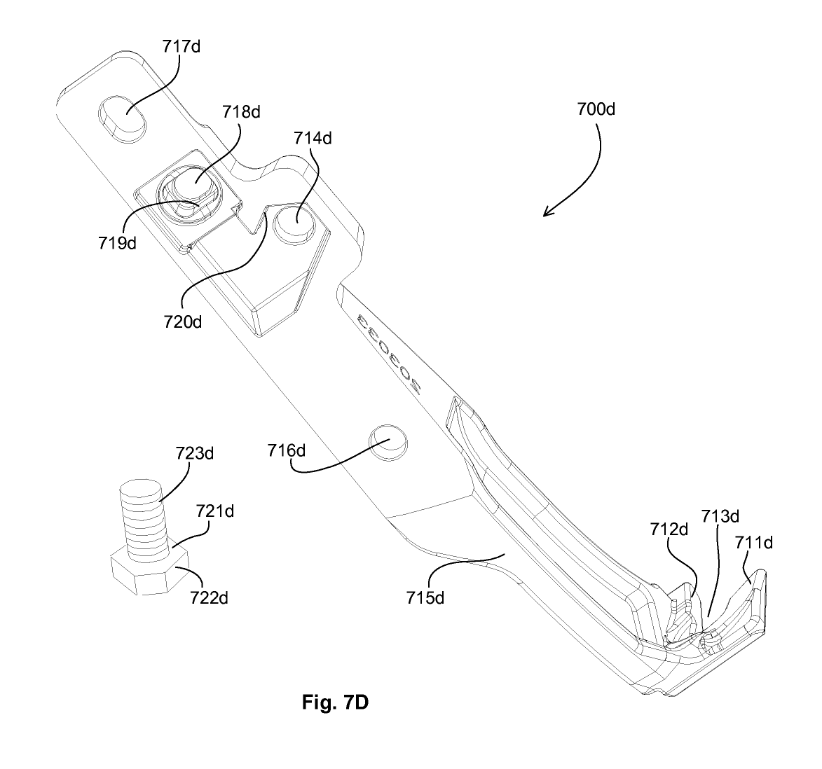

As reflected in FIG. 5D, the left-hand seat bracket 615d may include a substantially flat bottom surface 534d configured to rest on a substantially flat top surface 533d of a spring assembly 1000d. The spring assembly 1000b may further include a substantially flat lower surface 532d configured to rest on a substantially flat upper surface 531d of a left-hand landing bracket 505d. The substantially flat surfaces 531d-534d increase rigidity and stability of the left-side assembly 500d when compared to alternate non-flat surfaces. The bolt head and nut trapping features (e.g., 720d and 719d of FIG. 7D) of the left-hand seat bracket 615d facilitates engagement of the substantially flat bottom surface 534d with the substantially flat top surface 533d.

Turning to FIG. 5E, a top, plan, view of the example left-side assembly 500e is depicted to include a spring assembly 1000e in proximity to a left-hand seat bracket 615e and a left-hand landing bracket 505e for illustrative purposes. The left-hand seat bracket 615e may include a securing slot 613e between an alignment tab 612e and lip 611e along with a seat assembly mounting bolt hole 614e. As described herein, the spring assembly 1000e, the left-hand seat bracket 615e and the left-hand landing bracket 505e may be incorporated within various modular standard assemblies. While a left-hand seat bracket 615e and the left-hand landing bracket 505e are depicted in FIG. 5E, a spring assembly 1000e may be combined with a right-hand seat bracket and a right-hand landing bracket in a similar manner. The spring assembly 1000e may include a first fastener 1019e that may extend through a first left-hand seat bracket hole (not individually identified in FIG. 5E) to a first nut 516e and a second fastener 1020e that may extend through a second left-hand seat bracket hole (not individually identified in FIG. 5E) to a second nut 517e to secure the left-hand seat bracket 615e to the spring assembly 1000e. The left-side assembly 500e may also include an over-travel bolt 519e in proximity with a left-hand seat bracket hole 618e.

With reference to FIG. 5F, a side, plan, section view of the example left-side assembly 500f is depicted. The left-side assembly 500f section is taken along section-line 5F-5F of FIG. 5E. The left-side assembly 500f may include a spring assembly 1000f in proximity to a left-hand seat bracket 615f and a left-hand landing bracket 505f. The left-side assembly 500f may also include a seat assembly attachment bolt 518f that may extend through a left-side seat bracket hole (not individually identified in FIG. 5F) with a seat assembly bolt head 530f being trapped within a similarly shaped first opening 620f within the left-hand seat bracket 615f. The left-hand seat bracket 615f may include an alignment tab 612f. The spring assembly 1000f may include a first fastener 1019f that may extend through a first left-hand seat bracket hole 617f to a first nut 516f and a second fastener 1020f that may extend through a second left-hand seat bracket hole 616f to a second nut 517f to secure the left-hand seat bracket 615f to the spring assembly 1000f. The left-side assembly 500f may also include an over-travel bolt 519f extending through a washer 520f and extending through a passage 1040f through the spring assembly 1000f to a nut 521f that is trapped within a similarly shaped second opening 621f. The over-travel bolt 519f may limit the spring assembly 1000f stretch distance 531f. The spring assembly 1000f may also include a third fastener 1021f that may extend through a first left-hand landing bracket hole 512f to a third nut 514f and a fourth fastener 1022f that may extend through a second left-hand landing bracket hole 513f to a fourth nut 515f to secure the spring assembly 1000f to the left-hand landing bracket 505f. As can be seen in FIG. 5F, the seat assembly bolt head 530f, the over-travel nut 521f and the top bushing 1010d are received within respective recesses in the underside of the seat bracket 615f such that a lower substantially planar surface of the seat bracket 615f firmly, and evenly, rests on a substantially planar top surface of a top cap of the spring assembly 1000f.

Having an over-travel bolt 519f extending through a washer 520f and extending through a passage 1040f through the spring assembly 1000f to a nut 521f, such that the nut 521f is trapped within the second opening 621f, in cooperation with the alignment tab 612f, reduces wear of the spring assembly 1000f when the spring assembly 1000f travels over the stretch distance 531f when the associated rocker style chair 100c moves between a forward position 116c1, 136c1 and a rearward position 116c2, 136c2. This configuration also reduces noise associated with the rocking the rocker style chair 100c.

Turning to FIGS. 5G and 5H, a left-hand rocker assembly 500g, 500h may include a left-hand landing bracket 505g, 505h, a spring assembly 1000g, 1000h and a left-hand seat bracket 615g, 615h. The left-hand rocker assembly 500g, 500h may further include a zip-tie 560g, 560h, looped through a first zip-tie hole 506g, 506h in the left-hand landing bracket 505g, 505h and a second zip-tie hole 630g, 630h in the left-hand seat bracket 615g, 615h, that is configured to limit a forward rocking motion of an associated rocker style chair. The left-hand rocker assembly 500g, 500h may also include a seat assembly mounting bolt 518g, 518h. The left-hand rocker assembly 500g, 500h may further include features, such as a rearward over-travel bolt 519b, as described with regard to FIG. 5A-5F.

Turning to FIGS. 5J and 5K, a right-hand rocker assembly 500j, 500k may include a right-hand landing bracket 505j, 505k, a spring assembly 1000j, 1000k and a right-hand seat bracket 715j, 715k. The right-hand rocker assembly 500j, 500k may further include a forward over-travel limiting bolt 560j, 560k, extending through a first bolt hole 541j, 541k in the right-hand landing bracket 505j, 505k and a second bolt hole 730j, 730k in the right-hand seat bracket 715j, 715k, that is configured to limit a forward rocking motion of an associated rocker style chair. The right-hand rocker assembly 500j, 500k may also include a seat assembly mounting bolt 518j, 518k. The right-hand rocker assembly 500j, 500k may further include features, such as a rearward over-travel bolt 519b, as described with regard to FIG. 5A-5F.

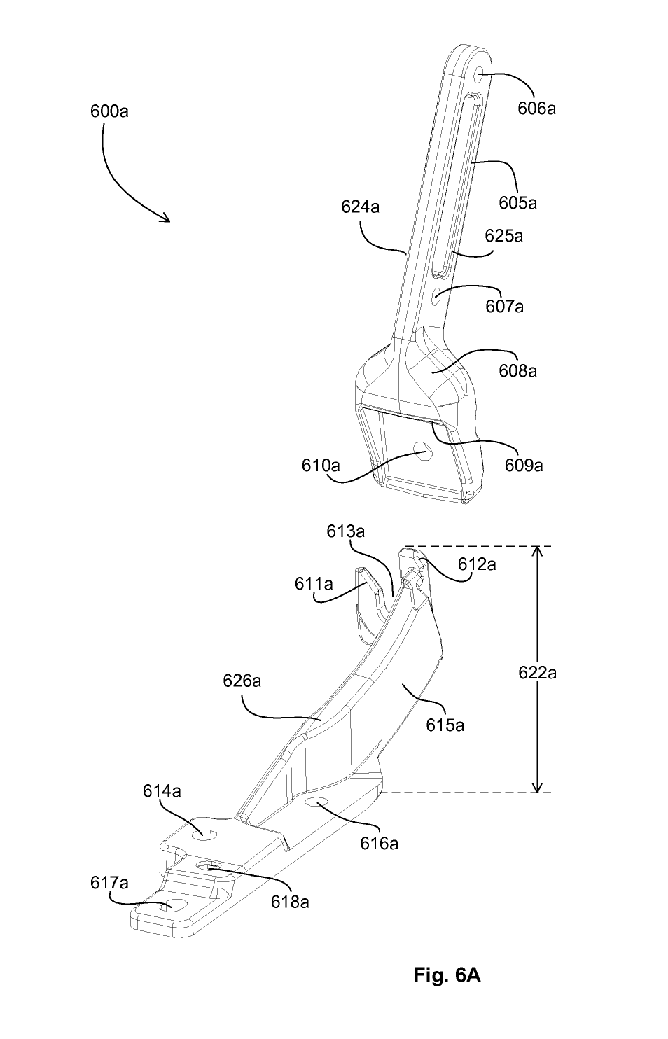

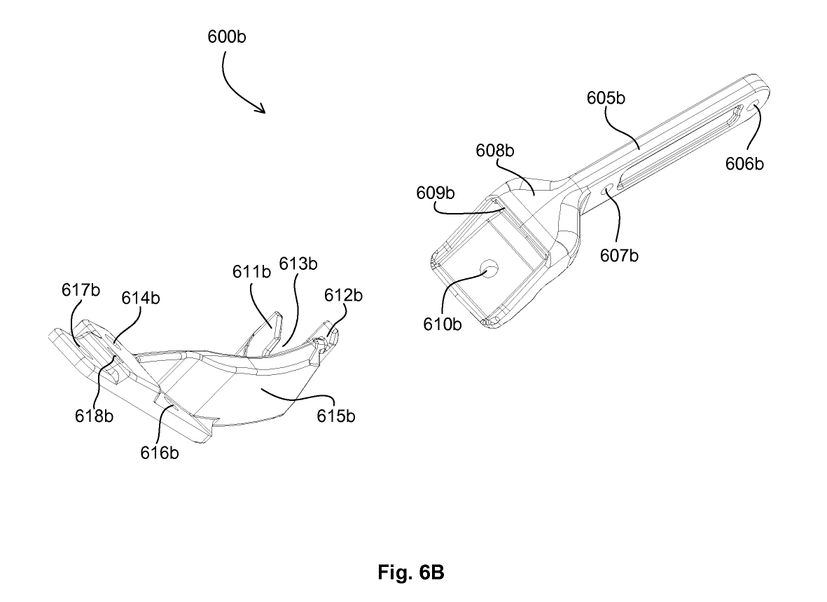

Turning to FIG. 6A, a front, top, perspective view of an example left-hand seat bracket 615a is depicted proximate a left-hand back bracket 605a. The left-hand seat bracket 615a and left-hand back bracket 605a may be used, for example, within the rocker style chairs of FIG. 1B. While the term “left-hand” is used here with regard to the left-hand back bracket 605a, the left-hand back bracket 605a may be used as a “right-hand” back bracket (e.g., right-hand back bracket 705a of FIG. 7A). The left-hand seat bracket 615a and/or the left-hand back bracket 605a may be made of cast iron, cast aluminum, carbon fiber reinforced plastic, composite, fiber glass, metal, steel, forged iron, etc. The left-hand back bracket 605a may include a first fastener hole 606a and a second fastener hole 607a that may cooperate with respective fasteners (not shown in FIG. 6A) to secure a left-hand chair back wing (not shown in FIG. 6A) to the left-hand back bracket 605a. A left-hand chair back wing (not shown in FIG. 6A) may be secured on a first side 624a or a second side 625a of the left-hand back bracket 605a to vary an overall width of a corresponding rocker style chair (e.g., rocker style chair 115b, 150b of FIG. 1B). The left-hand back bracket 605a may further include a left-hand seat bracket engagement 608a. The left-hand seat bracket engagement 608a may include a left-hand seat bracket lip receptacle 609a and a third fastener hole 610a. The seat bracket height 622a may be less than, or greater to, that shown in FIG. 6A to establish a space between a bottom of an associated chair back (e.g., chair back 235b, 270b of FIG. 1B) and a top of a chair seat (e.g., chair seat 116b, 151b of FIG. 1B).

With further reference to FIG. 6A, the left-hand seat bracket 615a may include a seat attachment bolt hole 614a, a first spring assembly fastener hole 616a, a second spring assembly fastener hole 617a and an over-travel bolt hole 618a. The left-hand seat bracket 615a may also include a securing slot 613a between an alignment tab 612a and lip 611a. While the term “left-hand” is used here with regard to the left-hand seat bracket 615a, the left-hand seat bracket 615a may be configured as a “right-hand” seat bracket (e.g., right-hand back bracket 715a of FIG. 7A) by relocating the securing slot 613a, alignment tab 612a and lip 611a. For example, the securing slot 613a, alignment tab 612a and lip 611a, along with the seat attachment bolt hole 614a, the first spring assembly fastener hole 616a, the second spring assembly fastener hole 617a and the over-travel bolt hole 618a, may be concentrically located with respect to the body portion 626a to make the seat bracket “ambidextrous.”

Turning to FIG. 6B, a front, top, perspective view of a left-hand seat bracket 615b and a left-hand back bracket 605b is depicted. The left-hand seat bracket 615b and a left-hand back bracket 605b may be similar to the left-hand seat bracket 615a and the left-hand back bracket 605a of FIG. 6A with the left-hand back bracket 605b rotated with respect to the left-hand seat bracket 615b to reveal further details of the seat bracket alignment tab receptacle 609b and the fastener hole 610b of the seat bracket engagement 608b. The left-hand seat bracket 615b may further include a first fastener hole 606b and a second fastener hole 607b that may cooperate with respective fasteners (not shown in FIG. 6B) to secure a left-hand chair back wing (not shown in FIG. 6B) to the left-hand back bracket 605b.

With further reference to FIG. 6B, the left-hand seat bracket 615b may include a seat attachment bolt hole 614b, a first spring assembly fastener hole 616b, a second spring assembly fastener hole 617b and an over-travel bolt hole 618b. The left-hand seat bracket 615b may also include a securing slot 613b between an alignment tab 612b and lip 611b.

Turning to FIG. 7A, a front, top, perspective view of an example right-hand seat bracket 715a is depicted proximate a right-hand back bracket 705a. The right-hand seat bracket 715a and right-hand back bracket 705a may be used, for example, within the rocker style chairs of FIG. 1B. While the term “right-hand” is used here with regard to the right-hand back bracket 705a, the right-hand back bracket 705a may be used as a “left-hand” back bracket (e.g., left-hand back bracket 605a of FIG. 6A). The right-hand seat bracket 715a and/or the right-hand back bracket 705a may be made of cast iron, cast aluminum, carbon fiber reinforced plastic, composite, fiber glass, metal, steel, forged steel, etc. The right-hand back bracket 705a may include a first fastener hole 706a and a second fastener hole 707a that may cooperate with respective fasteners (not shown in FIG. 7A) to secure a right-hand chair back wing (not shown in FIG. 7A) to the right-hand back bracket 705a. A right-hand chair back wing (not shown in FIG. 7A) may be secured on a first side 724a or a second side 725a of the right-hand back bracket 705a to vary an overall width of a corresponding rocker style chair (e.g., rocker style chair 115b, 150b of FIG. 1B). The right-hand back bracket 705a may further include a right-hand seat bracket engagement 708a. The right-hand seat bracket engagement 708a may include a right-hand seat bracket lip receptacle 709a and a third fastener hole 710a. The seat bracket height 722a may be less than, or greater to, that shown in FIG. 7A to establish a space between a bottom of an associated chair back (e.g., chair back 235b, 270b of FIG. 1B) and a top of a chair seat (e.g., chair seat 116b, 151b of FIG. 1B).

With further reference to FIG. 7A, the right-hand seat bracket 715a may include a seat attachment bolt hole 714a, a first spring assembly fastener hole 716a, a second spring assembly fastener hole 717a and an over-travel bolt hole 718a. The right-hand seat bracket 715a may also include a securing slot 713a between an alignment tab 712a and lip 711a. While the term “right-hand” is used here with regard to the right-hand seat bracket 715a, the right-hand seat bracket 715a may be configured as a “left-hand” seat bracket (e.g., left-hand back bracket 615a of FIG. 6A) by relocating the securing slot 713a, alignment tab 712a and lip 711a. For example, the securing slot 713a, alignment tab 712a and lip 711a, along with the seat attachment bolt hole 714a, the first spring assembly fastener hole 716a, the second spring assembly fastener hole 717a and the over-travel bolt hole 718a, may be concentrically located with respect to the body portion 726a to make the seat bracket “ambidextrous.”

Turning to FIG. 7B, a front, top, perspective view of a right-hand seat bracket 715b and a right-hand back bracket 705b is depicted. The right-hand seat bracket 715b and a right-hand back bracket 705b may be similar to the right-hand seat bracket 715a and the right-hand back bracket 705a of FIG. 7A with the right-hand back bracket 705b rotated with respect to the right-hand seat bracket 715b to reveal further details of the seat bracket alignment tab receptacle 709b and the fastener hole 710b of the seat bracket engagement 708b. The right-hand seat bracket 715b may further include a first fastener hole 706b and a second fastener hole 707b that may cooperate with respective fasteners (not shown in FIG. 7B) to secure a right-hand chair back wing (not shown in FIG. 7B) to the right-hand back bracket 705b.

With further reference to FIG. 7B, the right-hand seat bracket 715b may include a seat attachment bolt hole 714b, a first spring assembly fastener hole 716b, a second spring assembly fastener hole 717b and an over-travel bolt hole 718b. The right-hand seat bracket 715b may also include a securing slot 713b between an alignment tab 712b and lip 711b.

Turning to FIG. 7C, a front, top, perspective view of right-hand seat bracket 715c is depicted. The right-hand seat bracket 715c may be similar to the right-hand seat bracket 715b of FIG. 7B. The right-hand seat bracket 715c may include a seat attachment bolt hole 714c, a first spring assembly fastener hole 716c, a second spring assembly fastener hole 717c and an over-travel bolt hole 718c. The right-hand seat bracket 715c may also include a securing slot 713c between an alignment tab 712c and lip 711c.

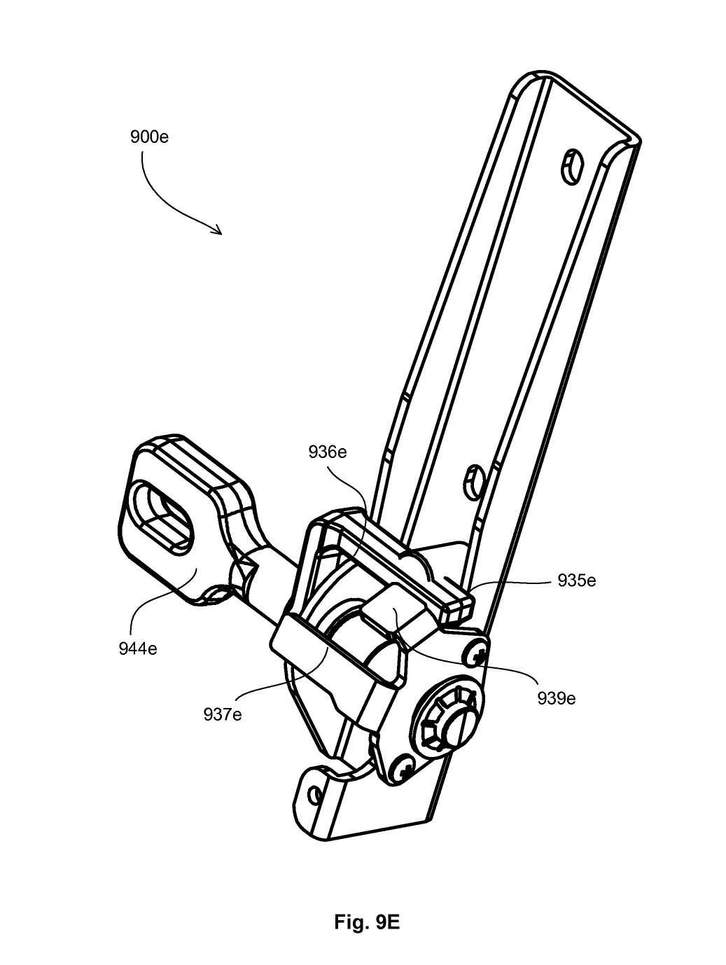

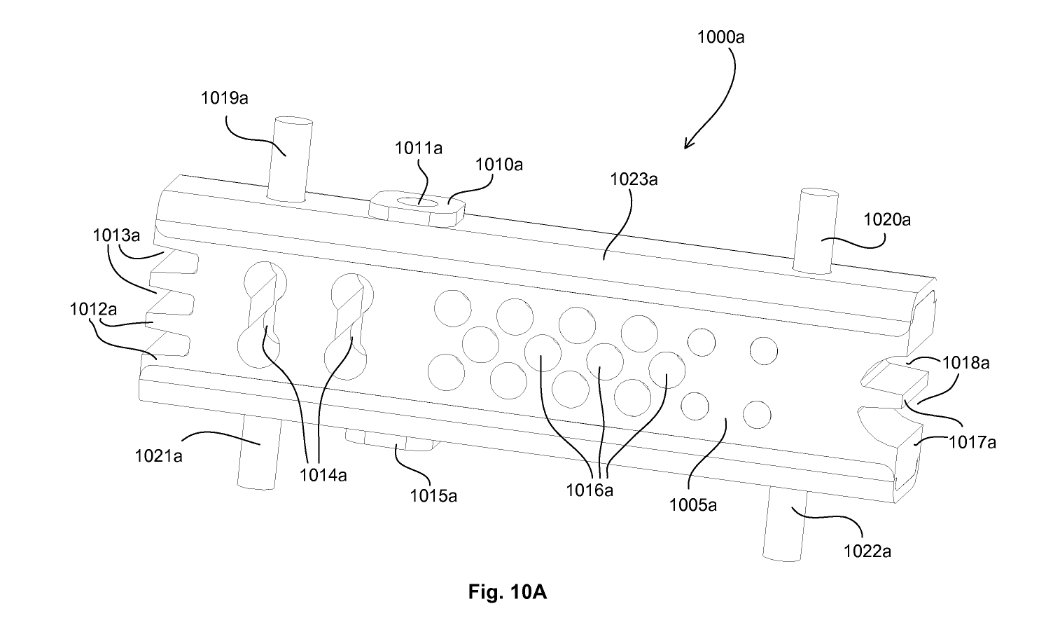

With reference to FIG. 7D, a front, bottom, perspective view of right-hand seat bracket 715d is depicted. The right-hand seat bracket 715d may be similar to the right-hand seat bracket 715c of FIG. 7C. The right-hand seat bracket 715d may include a seat attachment bolt hole 714d, a first spring assembly fastener hole 716d, a second spring assembly fastener hole 717d and an over-travel bolt hole 718d. The right-hand seat bracket 715d may also include a securing slot 713d between an alignment tab 712d and lip 711d. The right-hand seat bracket 715d may further include a seat assembly attachment bolt head receptacle 720d for trapping a head 722d of a seat assembly attachment bolt 721d when the threads 723d are inserted through the seat attachment bolt hole 714d. The right-hand seat bracket 715d may further include an over-travel bolt nut receptacle 719d for trapping an over-travel bolt nut (not shown in FIG. 7D). The term “trapping” is used herein to refer to the fact that an associated bolt head or nut is both prevented from rotating and is prevented from moving linearly when the associated seat bracket (e.g., right-hand seat bracket 615a of FIG. 6A or left-hand seat bracket of FIG. 7A) is secured proximate a corresponding spring assembly (e.g., spring assembly 1000a of FIG. 10A).

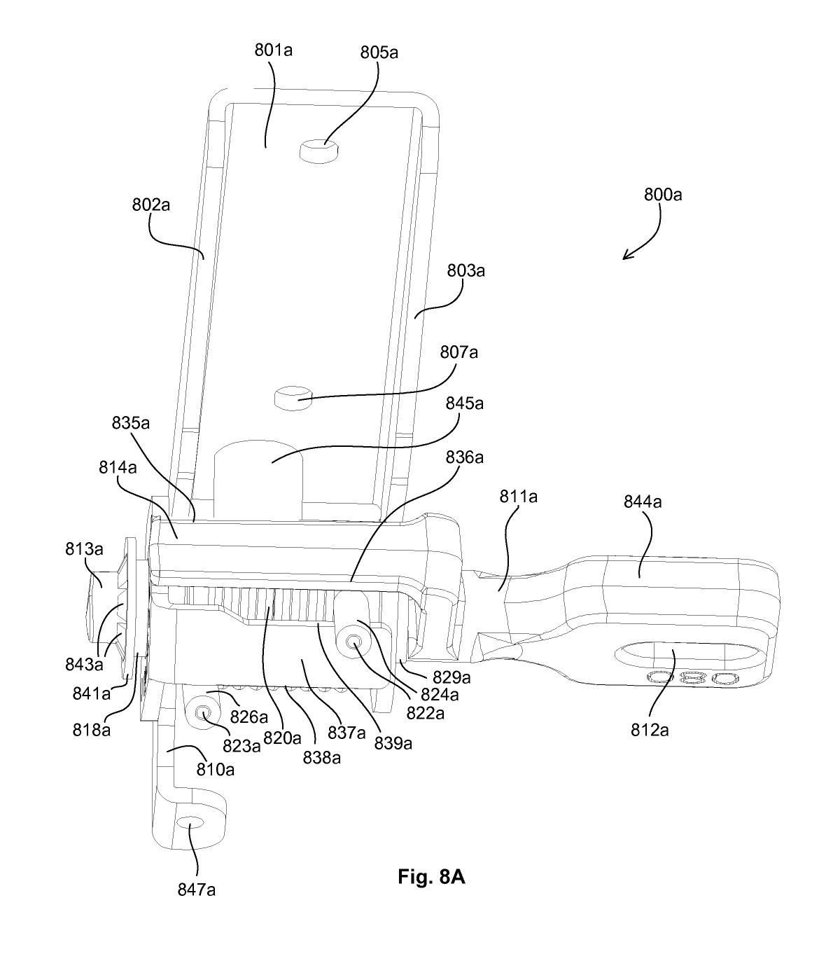

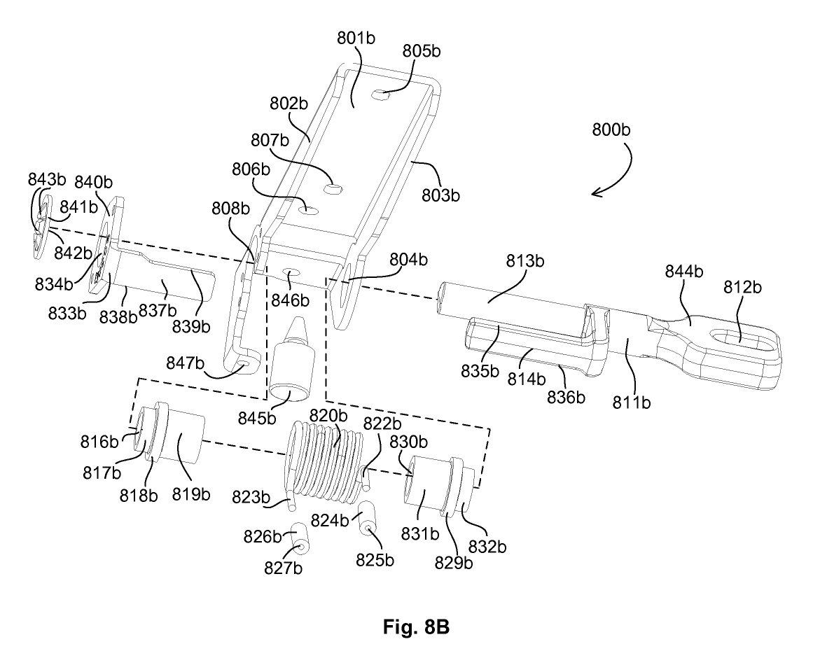

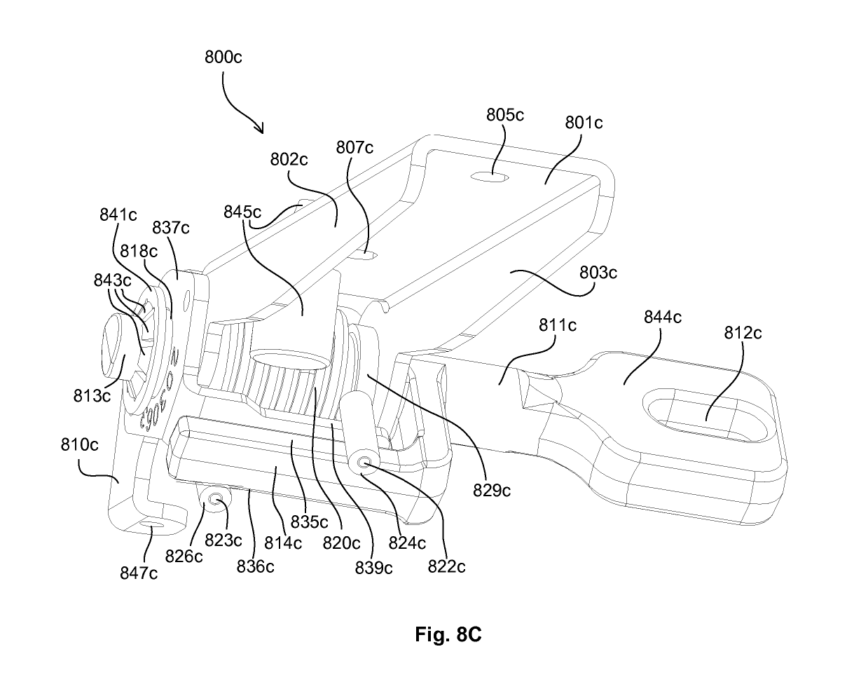

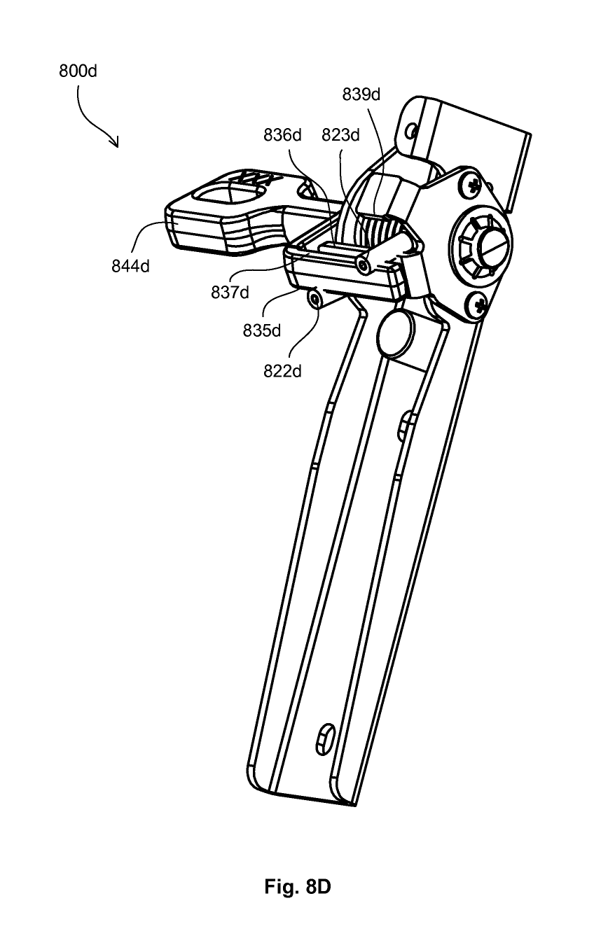

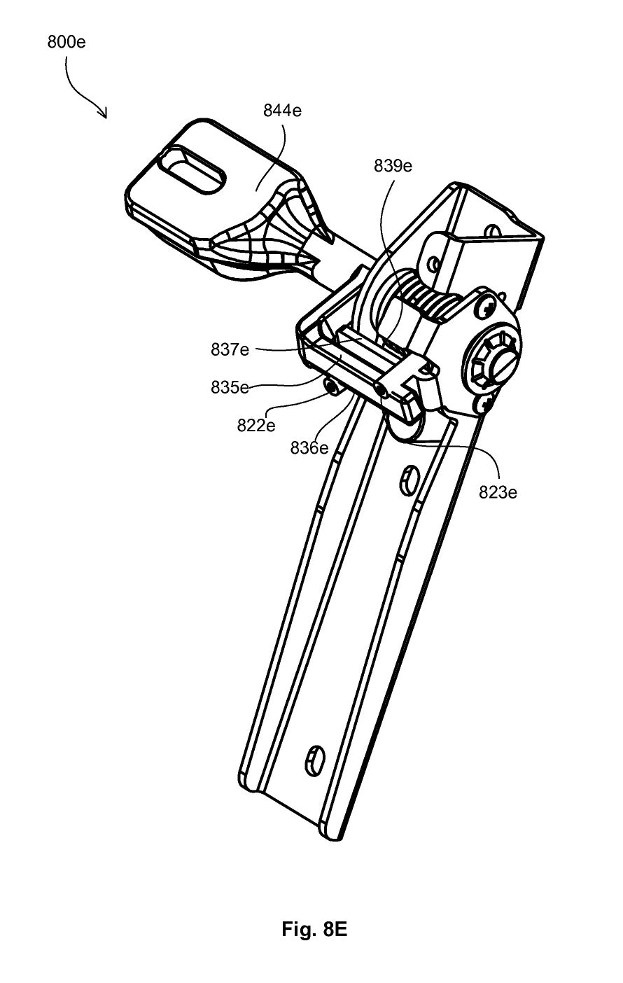

With reference to FIG. 8A, a front, bottom, perspective view of an example left-hand seat pivot assembly 800a is depicted that reflects an occupant is setting on the corresponding seat assembly (e.g., seat assembly 116b, 151b of FIG. 1B). The left-hand seat pivot assembly 800a may be similar to the left-hand seat pivot assembly 800b of FIG. 3B. The left-hand seat pivot assembly 800a may include a left-hand seat connector 801a, a stationary post 811a, a first pivot bearing 818a, a biasing spring 820a, a first bushing 824a, a second bushing 826a, a second pivot bearing 829a, a left-hand pivot arm 837a, a fastener 841a and a bumper 845a. The left-hand seat connector 801a may be connected to a left-hand seat frame structure connector (not shown in FIG. 8A) via a first fastener (not shown in FIG. 8A) extending through a first left-hand seat connector hole 805a and a second fastener (not shown in FIG. 8A) extending through a second left-hand seat connector hole (not shown in FIG. 8A). The left-hand seat connector 801a may include a first side 802a, a second side 803a, an alignment hole 807a and a bottom arm 810a with a decorative bottom fastener hole 847a. The stationary post 811a may be made of cast iron, cast aluminum, forged steel, molded steel, metal, carbon reinforced plastic, fiberglass, aluminum, etc. and may include a chair seat mounting hole 812a in a seat engagement 844a, a distal end 813a and a spring biasing arm 814a having a first surface 835a and a second surface 836a. The left-hand pivot arm 837a may include a first side 838a and a second side 839a. The bushing 824a may be friction fit onto a first spring end 822a and the second bushing 826a may be friction fit onto a second spring end 823a. The fastener 841a may include a plurality of fingers 843a that friction fit to the distal end 813a of the stationary post 811a. The first bushing 824a, the second bushing 826a and the bumper 845a may cooperate to minimize noise when an associated seat assembly (e.g., seat assembly 116b of FIG. 1B) pivots. The first pivot bearing 818a and the second bushing 829a may be made of high impact plastic, ceramic, hardened steel, or the like, to minimize wear and noise when an associated seat assembly (e.g., seat assembly 116b of FIG. 1B) pivots. The pivot post 811a may be cast iron, cast aluminum, forged steel, machined steel, fiberglass, carbon fiber reinforced plastic, composite, etc.

Turning to FIG. 8B, a front, bottom, exploded, perspective view of an example left-hand seat pivot assembly 800b is depicted. The left-hand seat pivot assembly 800b may be similar to the left-hand seat pivot assembly 800a of FIG. 8A. The left-hand seat pivot assembly 800b may include a left-hand seat connector 801b, a stationary post 811b, a first pivot bearing 818b, a biasing spring 820b, a first bushing 824b, a second bushing 826b, a second pivot bearing 829b, a left-hand pivot arm 837b, a fastener 841a and a bumper 845b. The left-hand seat connector 801a may be connected to a left-hand seat frame structure connector (not shown in FIG. 8B) via a first fastener (not shown in FIG. 8B) extending through a first left-hand seat connector hole 805b and a second fastener (not shown in FIG. 8B) extending through a second left-hand seat connector hole 846b. The left-hand seat connector 801b may include a first side 802b, a second side 803b, bumper engagement hole 806b, an alignment hole 807b, a bottom arm 810b. The stationary post 811b may be made of cast iron, cast aluminum, steel, iron, metal, fiberglass, carbon fiber reinforced plastic, composite, etc. and may include a chair seat mounting hole 812b in a seat engagement 844b, a distal end 813b and a spring biasing arm 814b having a first surface 835b and a second surface 836b. The first pivot bearing 818b may include a passage way 816b, a first thinned portion 817b and a second thinned portion 819b. The second pivot bearing 829b may include a passage way 830b, a first thinned portion 832b and a second thinned portion 831b. The left-hand pivot arm 837b may include a hole 834b through a pivot plate 840b that extends at substantially a right-angle with respect to an arm 833b, a first side 838b and a second side 839b. The bushing 824b may include a passageway 825b that may be friction fit onto a first spring end 822b and the second bushing 826b may include a passageway 827b that may be friction fit onto a second spring end 823b. The fastener 841b may include a plurality of fingers 843b surrounding a hole 842b that may friction fit to the distal end 813b of the stationary post 811b.

With reference to FIG. 8C, a front, bottom, perspective view of an example left-hand seat pivot assembly 800c is depicted that reflects no occupant setting on the corresponding seat assembly (e.g., seat assembly 116b, 151b of FIG. 1B). The left-hand seat pivot assembly 800c may be similar to the left-hand seat pivot assembly 800b of FIG. 8B. The left-hand seat pivot assembly 800c may include a left-hand seat connector 801c, a stationary post 811c, a first pivot bearing 818c, a biasing spring 820c, a first bushing 824c, a second bushing 826c, a second pivot bearing 829c, a left-hand pivot arm 837c, a fastener 841c and a bumper 845c. The left-hand seat connector 801c may be connected to a left-hand seat frame structure connector (not shown in FIG. 8C) via a first fastener (not shown in FIG. 8C) extending through a first left-hand seat connector hole 805a and a second fastener (not shown in FIG. 8C) extending through a second left-hand seat connector hole (not shown in FIG. 8C). The left-hand seat connector 801c may include a first side 802c, a second side 803c, an alignment hole 807c and a bottom arm 810c with a decorative bottom fastener hole 847c. The stationary post 811c may be made of cast iron, cast aluminum, aluminum, steel, metal, fiberglass, carbon fiber reinforced plastic, composite, etc. and may include a chair seat mounting hole 812c in a seat engagement 844c, a distal end 813c and a spring biasing arm 814c having a first surface 835c and a second surface 836c. The left-hand pivot arm 837c may include a first side 838c and a second side 839c. The bushing 824c may be friction fit onto a first spring end 822c and the second bushing 826c may be friction fit onto a second spring end 823c. The fastener 841c may include a plurality of fingers 843c that friction fit to the distal end 813c of the stationary post 811c.

The spring 820a, 820b, 820c of the left-hand seat pivot assembly 800a, 800b, 800c may be in a “relaxed” state when the associated chair seat 151l is in an up position. When an occupant sets on the chair seat 116l in a down position, the spring 820a, 820b, 820c may be “charged” or “loaded.” Thereby, the chair seat automatically moves from the position 116l to the position 151l when the occupant exits the chair and the spring 820a, 820b, 820c maintains the seat in the position 151l until an external force causes the seat to pivot toward position 116l.

With reference to FIG. 8D, a left-hand seat pivot assembly 800d may include a left-hand seat connector, a stationary post, a first pivot bearing, a biasing spring, a first bushing, a second bushing, a second pivot bearing, a left-hand pivot arm 837c, a fastener and a bumper. The left-hand seat connector may be connected to a left-hand seat frame structure connector (not shown in FIG. 8D) via a first fastener (not shown in FIG. 8D) extending through a first left-hand seat connector hole and a second fastener (not shown in FIG. 8D) extending through a second left-hand seat connector hole (not shown in FIG. 8D). The left-hand seat connector may include a first side, a second side, an alignment hole and a bottom arm with a decorative bottom fastener hole. The stationary post may be made of cast iron, cast aluminum, aluminum, steel, metal, fiberglass, carbon fiber reinforced plastic, composite, etc. and may include a chair seat mounting hole in a seat engagement 844d, a distal end and a spring biasing arm having a first surface 835d and a second surface 836d. The left-hand pivot arm 837d may include a first side and a second side. The bushing may be friction fit onto a first spring end 822d and the second bushing may be friction fit onto a second spring end 823d. The fastener may include a plurality of fingers that friction fit to the distal end of the stationary post.

As depicted in FIG. 8D, a spring keeper (e.g., spring keeper 2000e, 2000d) with up stop (e.g., up stop 2050e, 2050d) may be incorporated into the pivot assembly 800d. A left-hand spring keeper 2000d may be used on either a left-hand or right-hand side of the pivot assembly 800d depending on the desired function. For example, a neutral position may be changed by how a spring keeper is attached to a hinge base (e.g., 5/8 fold or 3/4-fold). An associated up-stop may, for example, be configured to prevent an associated chair seat from being pushed to full fold. This may keep a chair seat from, for example, interfering with an associated rocker mechanism.

Turning to FIG. 8E, a left-hand seat pivot assembly 800e may include a left-hand seat connector, a stationary post, a first pivot bearing, a biasing spring, a first bushing, a second bushing, a second pivot bearing, a left-hand pivot arm 837c, a fastener and a bumper. The left-hand seat connector may be connected to a left-hand seat frame structure connector (not shown in FIG. 8E) via a first fastener (not shown in FIG. 8E) extending through a first left-hand seat connector hole and a second fastener (not shown in FIG. 8E) extending through a second left-hand seat connector hole (not shown in FIG. 8E). The left-hand seat connector may include a first side, a second side, an alignment hole and a bottom arm with a decorative bottom fastener hole. The stationary post may be made of cast iron, cast aluminum, aluminum, steel, metal, fiberglass, carbon fiber reinforced plastic, composite, etc. and may include a chair seat mounting hole in a seat engagement 844e, a distal end and a spring biasing arm having a first surface 835e and a second surface 836e. The left-hand pivot arm 837e may include a first side and a second side. The bushing may be friction fit onto a first spring end 822e and the second bushing may be friction fit onto a second spring end 823e. The fastener may include a plurality of fingers that friction fit to the distal end of the stationary post.

The pivot assembly 800e may be similar to pivot assembly 800d except with a different hinge pivot casting 844d, 844e to work with other manufacturer's seats. Hinge casting 844e may be, for example, a handed part, whereas hinge casting 844d may be, for example, ambidextrous.

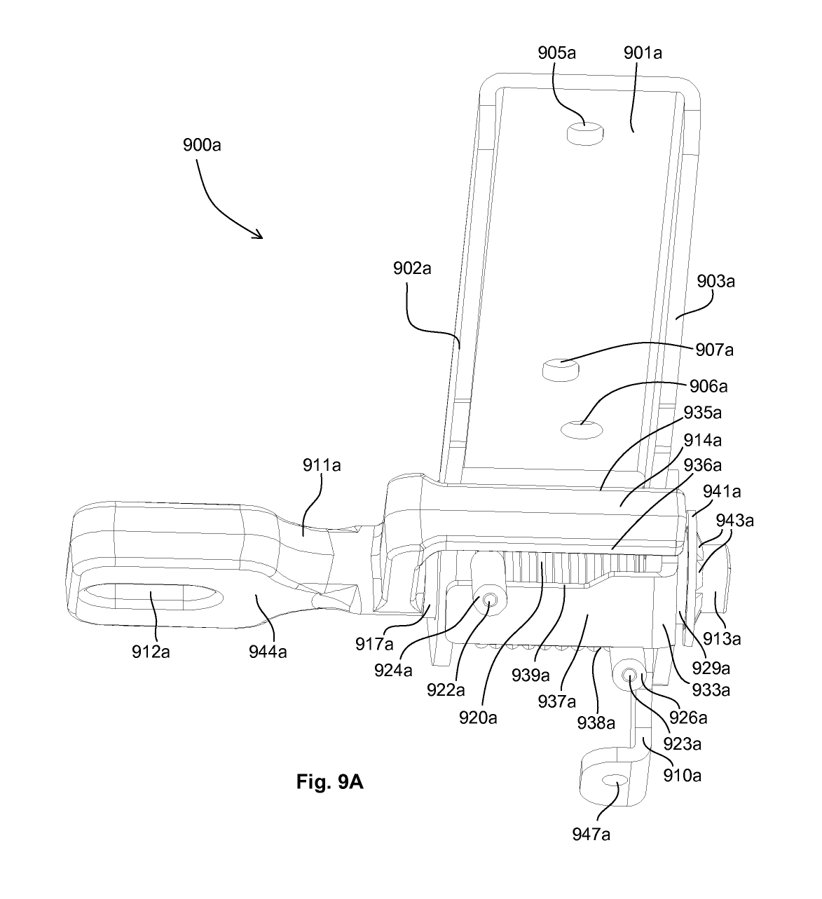

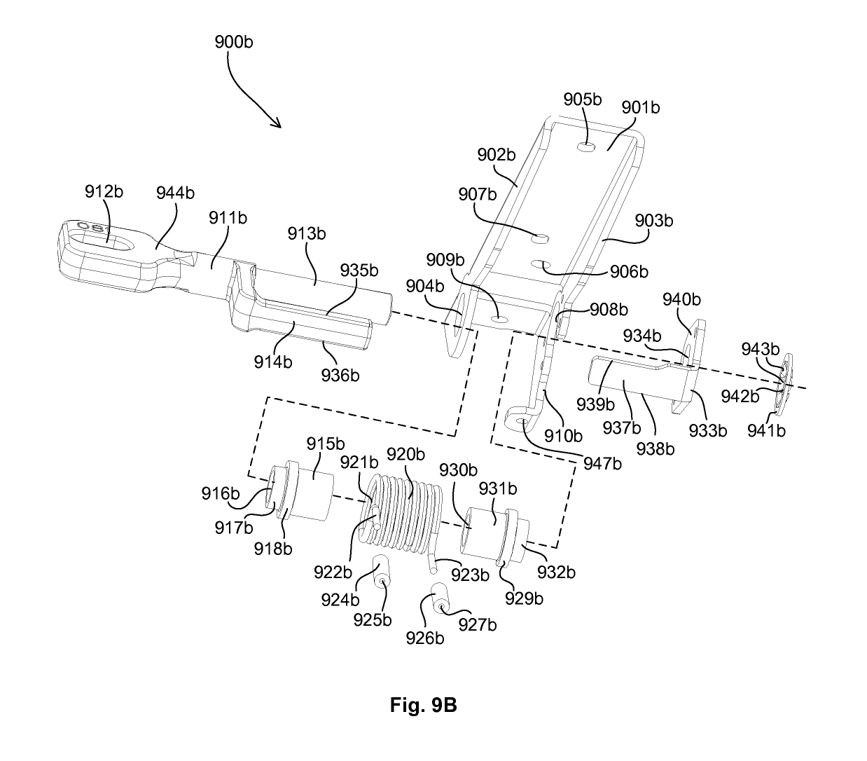

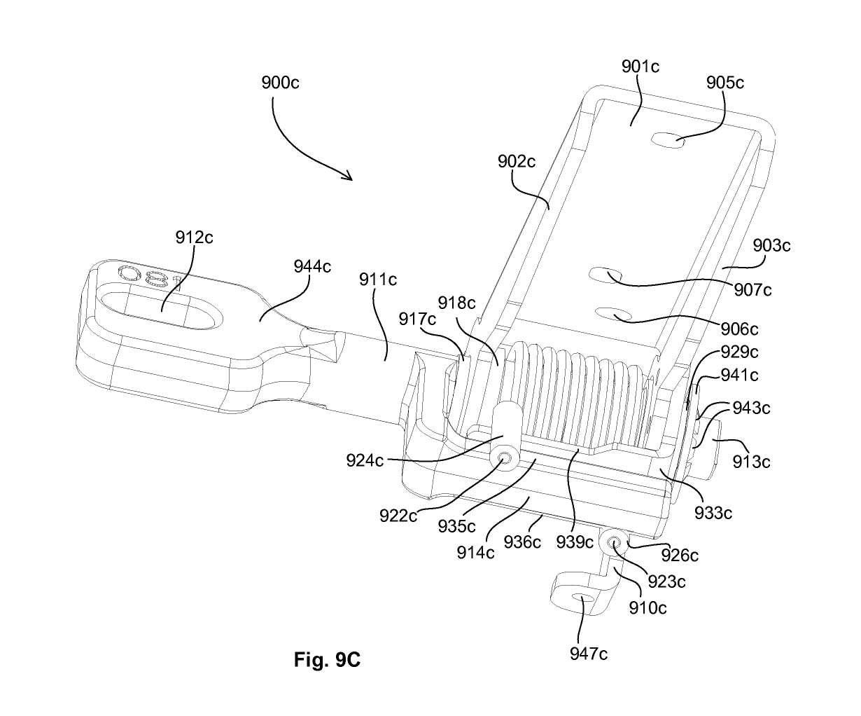

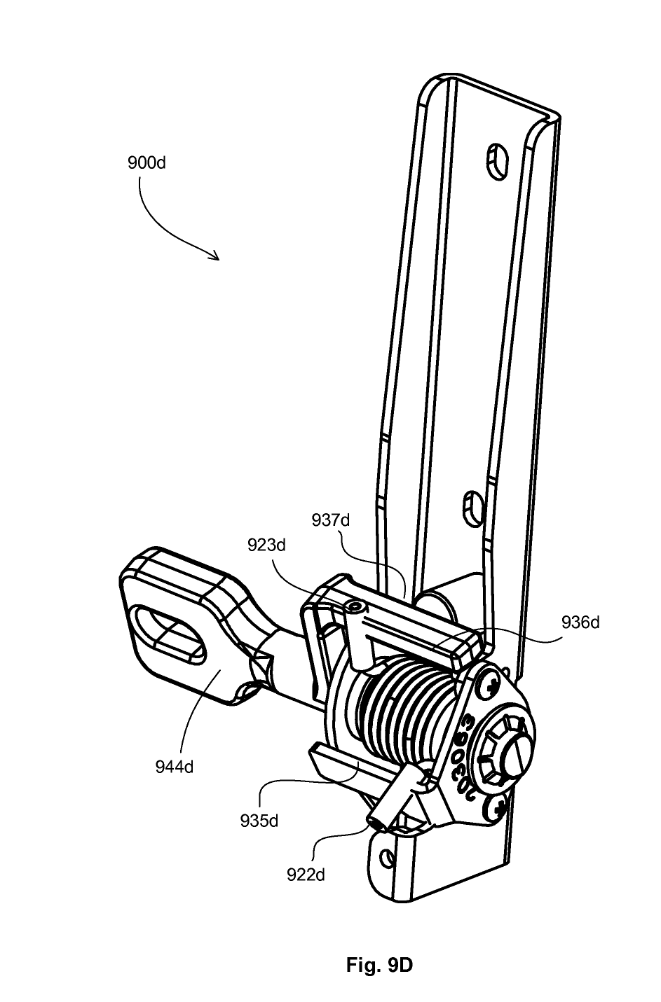

With reference to FIG. 9A, a front, bottom, perspective view of an example right-hand seat pivot assembly 900a is depicted that reflects an occupant is setting on the corresponding seat assembly (e.g., seat assembly 116b, 151b of FIG. 1B). The right-hand seat pivot assembly 900a may be similar to the right-hand seat pivot assembly 900b of FIG. 3B. The right-hand seat pivot assembly 900a may include a right-hand seat connector 901a, a stationary post 911a, a first pivot bearing 918a, a biasing spring 920a, a first bushing 924a, a second bushing 926a, a second pivot bearing 929a, a right-hand pivot arm 937a, a fastener 941a and a bumper (not shown in FIG. 9A). The right-hand seat connector 901a may be connected to a right-hand seat frame structure connector (not shown in FIG. 9A) via a first fastener (not shown in FIG. 9A) extending through a first right-hand seat connector hole 905a and a second fastener (not shown in FIG. 9A) extending through a second right-hand seat connector hole (not shown in FIG. 9A). The right-hand seat connector 901a may include a first side 902a, a second side 903a, an alignment hole 907a and a bottom arm 910a with a decorative bottom fastener hole 947a. The stationary post 911a may be made of cast iron, cast aluminum, aluminum, steel, metal, fiberglass, carbon fiber reinforced plastic, composite, etc. and may include a chair seat mounting hole 912a in a seat engagement 944a, a distal end 913a and a spring biasing arm 914a having a first surface 935a and a second surface 936a. The right-hand pivot arm 937a may include a first side 938a and a second side 939a. The bushing 924a may be friction fit onto a first spring end 922a and the second bushing 926a may be friction fit onto a second spring end 923a. The fastener 941a may include a plurality of fingers 943a that friction fit to the distal end 913a of the stationary post 911a. The first bushing 924a, the second bushing 926a and the bumper 945a may cooperate to minimize noise when an associated seat assembly (e.g., seat assembly 116b of FIG. 1B) pivots. The first pivot bearing 918a and the second bushing 929a may be made of high impact plastic, ceramic, hardened steel, or the like, to minimize wear and noise when an associated seat assembly (e.g., seat assembly 116b of FIG. 1B) pivots. The pivot post 911a may be cast iron, cast aluminum, forged steel, machined steel, etc.

Turning to FIG. 9B, a front, bottom, exploded, perspective view of an example right-hand seat pivot assembly 900b is depicted. The right-hand seat pivot assembly 900b may be similar to the right-hand seat pivot assembly 900a of FIG. 9A. The right-hand seat pivot assembly 900b may include a right-hand seat connector 901b, a stationary post 911b, a first pivot bearing 918b, a biasing spring 920b, a first bushing 924b, a second bushing 926b, a second pivot bearing 929b, a right-hand pivot arm 937b, a fastener 941a and a bumper (not shown in FIG. 9B). The right-hand seat connector 901a may be connected to a right-hand seat frame structure connector (not shown in FIG. 9B) via a first fastener (not shown in FIG. 9B) extending through a first right-hand seat connector hole 905b and a second fastener (not shown in FIG. 9B) extending through a second right-hand seat connector hole 946b. The right-hand seat connector 901b may include a first side 902b, a second side 903b, bumper engagement hole 906b, an alignment hole 907b, a bottom arm 910b. The stationary post 911b may be made of cast iron, cast aluminum, aluminum, steel, metal, fiberglass, carbon fiber reinforced plastic, composite, etc. and may include a chair seat mounting hole 912b in a seat engagement 944b, a distal end 913b and a spring biasing arm 914b having a first surface 935b and a second surface 936b. The first pivot bearing 918b may include a passage way 916b, a first thinned portion 917b and a second thinned portion 919b. The second pivot bearing 929b may include a passage way 930b, a first thinned portion 932b and a second thinned portion 931b. The right-hand pivot arm 937b may include a hole 934b through a pivot plate 940b that extends at substantially a right-angle with respect to an arm 933b, a first side 938b and a second side 939b. The bushing 924b may include a passageway 925b that may be friction fit onto a first spring end 922b and the second bushing 926b may include a passageway 927b that may be friction fit onto a second spring end 923b. The fastener 941b may include a plurality of fingers 943b surrounding a hole 942b that may friction fit to the distal end 913b of the stationary post 911b.

With reference to FIG. 9C, a front, bottom, perspective view of an example right-hand seat pivot assembly 900c is depicted that reflects no occupant setting on the corresponding seat assembly (e.g., seat assembly 116b, 151b of FIG. 1B). The right-hand seat pivot assembly 900c may be similar to the right-hand seat pivot assembly 900b of FIG. 9B. The right-hand seat pivot assembly 900c may include a right-hand seat connector 901c, a stationary post 911c, a first pivot bearing 918c, a biasing spring 920c, a first bushing 924c, a second bushing 926c, a second pivot bearing 929c, a right-hand pivot arm 937c, a fastener 941c and a bumper (not shown in FIG. 9C). The right-hand seat connector 901c may be connected to a right-hand seat frame structure connector (not shown in FIG. 9C) via a first fastener (not shown in FIG. 9C) extending through a first right-hand seat connector hole 905a and a second fastener (not shown in FIG. 9C) extending through a second right-hand seat connector hole (not shown in FIG. 9C). The right-hand seat connector 901c may include a first side 902c, a second side 903c, an alignment hole 907c and a bottom arm 910c with a decorative bottom fastener hole 947c. The stationary post 911c may be made of cast iron, cast aluminum, aluminum, steel, metal, fiberglass, carbon fiber reinforced plastic, composite, etc. and may include a chair seat mounting hole 912c in a seat engagement 944c, a distal end 913c and a spring biasing arm 914c having a first surface 935c and a second surface 936c. The right-hand pivot arm 937c may include a first side 938c and a second side 939c. The bushing 924c may be friction fit onto a first spring end 922c and the second bushing 926c may be friction fit onto a second spring end 923c. The fastener 941c may include a plurality of fingers 943c that friction fit to the distal end 913c of the stationary post 911c.

The spring 920a, 920b, 920c of the left-hand seat pivot assembly 900a, 900b, 900c may be in a “relaxed” state when the associated chair seat 151l is in an up position. When an occupant sets on the chair seat 116l in a down position, the spring 920a, 920b, 920c may be “charged” or “loaded.” Thereby, the chair seat automatically moves from the position 116l to the position 151l when the occupant exits the chair and the spring 920a, 920b, 920c maintains the seat in the position 151l until an external force causes the seat to pivot toward position 116l.

Turning to FIG. 9D, a right-hand seat pivot assembly 900d may include a right-hand seat connector, a stationary post, a first pivot bearing, a biasing spring, a first bushing, a second bushing, a second pivot bearing, a left-hand pivot arm 937c, a fastener and a bumper. The right-hand seat connector may be connected to a right-hand seat frame structure connector (not shown in FIG. 9D) via a first fastener (not shown in FIG. 9D) extending through a first right-hand seat connector hole and a second fastener (not shown in FIG. 9D) extending through a second right-hand seat connector hole (not shown in FIG. 9D). The right-hand seat connector may include a first side, a second side, an alignment hole and a bottom arm with a decorative bottom fastener hole. The stationary post may be made of cast iron, cast aluminum, aluminum, steel, metal, fiberglass, carbon fiber reinforced plastic, composite, etc. and may include a chair seat mounting hole in a seat engagement 944d, a distal end and a spring biasing arm having a first surface 935d and a second surface 936d. The right-hand pivot arm 937d may include a first side and a second side. The bushing may be friction fit onto a first spring end 922d and the second bushing may be friction fit onto a second spring end 923d. The fastener may include a plurality of fingers that friction fit to the distal end of the stationary post. According to the pivot assembly 900d, an associated chair seat may be held in an occupied position by spring force. A left-hand and right-hand keeper 2000d, 2000e may be used on opposite sides with an associated spring holding a respective chair seat in an occupied position. The chair seat may be manually raised for cleaning. Accordingly, an associated spring may return the chair seat to an occupied position.

With reference to FIG. 9E, a right-hand seat pivot assembly 900d may include a right-hand seat connector, a stationary post, a first pivot bearing, a biasing spring, a first bushing, a second bushing, a second pivot bearing, a left-hand pivot arm 937c, a fastener and a bumper. The right-hand seat connector may be connected to a right-hand seat frame structure connector (not shown in FIG. 9D) via a first fastener (not shown in FIG. 9D) extending through a first right-hand seat connector hole and a second fastener (not shown in FIG. 9D) extending through a second right-hand seat connector hole (not shown in FIG. 9D). The right-hand seat connector may include a first side, a second side, an alignment hole and a bottom arm with a decorative bottom fastener hole. The stationary post may be made of cast iron, cast aluminum, aluminum, steel, metal, fiberglass, carbon fiber reinforced plastic, composite, etc. and may include a chair seat mounting hole in a seat engagement 944d, a distal end and a spring biasing arm having a first surface 935d and a second surface 936d. The right-hand pivot arm 937d may include a first side and a second side. The bushing may be friction fit onto a first spring end 922d and the second bushing may be friction fit onto a second spring end 923d. The fastener may include a plurality of fingers that friction fit to the distal end of the stationary post. Accordingly, a chair seat may be held in an occupied position by a keeper 2000d, 2000e. As depicted in FIG. 9D an associated chair seat may not be raised. A left-hand and right-hand keeper may be used on opposite sides with a keeper holding an associated chair seat in an occupied position against a down-stop bumper. The pivot assembly 900d may be similar to, for example, a pivot assembly 900a, 900b, 900c, 900d without spring. In any event, an associated chair seat may stay in an up position when manually raised. This configuration may, for example, make cleaning of an associated theater or stadium easier.

Turning to FIG. 10A, a front, top, perspective view of an example spring assembly 1000a is depicted. The spring assembly 1000a may be similar to any one of the spring assemblies 1000g of FIG. 1G. The spring assembly 1000a may include a molded rubber member 1005a. The molded rubber member 1005a may include a plurality of front-end fins 1012a with intervening front-end slits 1013a, a plurality of substantially dumb-bell shaped passages 1014a, a plurality of substantially cylindrical shaped passages 1016a and a plurality of rear-end fins 1017a with intervening rear-end slits 1018a. The spring assembly 1000a may further include a top cap 1023a and a bottom cap 1028a. The top cap 1023a and the bottom cap 1028a may be made of metal and may be co-molded with the molded rubber member 1005a. A layer of adhesion promotion material (not shown in FIG. 10A) may be applied to a surface of the top cap 1023a and the bottom cap 1028a proximate the molded rubber member 1005a prior to co-molding the top cap 1023a and the bottom cap 1028a with the molded rubber member 1005a. The spring assembly 1000a may also include a top rubber bushing 1010a having a top opening 1011a and a bottom rubber bushing 1015a. The spring assembly 1000a may further include a first fastener 1019a and a second fastener 1020a for attaching the spring assembly 1000a to a seat bracket (not shown in FIG. 10A). The spring assembly 1000a may also include a third fastener 1021a and a fourth fastener 1022a for attaching the spring assembly 1000a to a landing bracket (not shown in FIG. 10A). An enlarged head-end of each fastener 1019a-1022a may be co-molded with the molded rubber member 1005a. When an associated rocker style chair (e.g., rocker style chair 115b or 151b of FIG. 1B) is rocked backward, the front-end slits 1013a and the dumb bell shaped passages 1014a may stretch such that the front-end of the top cap 1023a moves away from the front-end of the bottom cap 1028a and the rear-end slits 1018a and the cylindrical shaped passages 1016a may compress such that the rear-end of the top cap 1023a moves toward the rear-end of the bottom cap 1028a. When an associated rocker style chair (e.g., rocker style chair 115b or 151b of FIG. 1B) is rocked forward, the front-end slits 1013a and the dumb bell shaped passages 1014a may compress such that the front-end of the top cap 1023a moves toward the front-end of the bottom cap 1028a and the rear-end slits 1018a and the cylindrical shaped passages 1016a may stretch such that the rear-end of the top cap 1023a moves away from the rear-end of the bottom cap 1028a. The front-end fins 1012a and/or the rear-end fins 1017a may limit associated pinch points while maintaining the ability of the spring assembly 1000a to flex when the associated rocker style chair 115b, 151b is rocked backward and forward, respectively. The front-end fins 1012a may be configured to limit travel when the associated rocker style chair 115b, 151b is rocked forward. The rear-end fins 1017a may be configured to limit travel when the associated rocker style chair 115b, 151b is rocked backward. The spring assembly 1000a may be ambidextrous, such that the spring assembly 1000a may be incorporated in any of a left-hand modular standard assembly (e.g., left-hand modular standard assembly 400d of FIG. 1D), a center modular standard assembly (e.g., left-hand modular standard assembly 430d of FIG. 1D) and a right-hand modular standard assembly (e.g., left-hand modular standard assembly 460d of FIG. 1D). The spring assembly 1000a may be symmetrical from top to bottom, such that the spring assembly 1000a may be installed upside-down with no change in function.

With reference to FIG. 10B, a back, top, exploded, perspective view of an example spring assembly 1000b is depicted. The spring assembly 1000b may be similar to the spring assembly 1000a of FIG. 10A. The spring assembly 1000b may include a molded rubber member 1005b. The molded rubber member 1005b may include a plurality of front-end fins 1012b with intervening front-end slits 1013b, a plurality of substantially dumb-bell shaped passages 1014b, a plurality of substantially cylindrical shaped passages 1016b and a plurality of rear-end fins 1017b with intervening rear-end slits 1018b. The spring assembly 1000b may further include a top cap 1023b and a bottom cap 1028b. A first top cap side 1033b may align with a first rubber member edge 1034b. A first bottom cap side 1036b may align with a second rubber member edge 1007b and a second bottom cap side 1037b may align with a third rubber member edge 1038b. The top cap 1023b and the bottom cap 1028b may be made of metal and may be co-molded with the molded rubber member 1005b. A layer of adhesion promotion material (not shown in FIG. 10B) may be applied to a bottom surface 1027b of the top cap 1023b and a top surface 1029b of the bottom cap 1028b proximate the molded rubber member 1005b prior to co-molding the top cap 1023b and the bottom cap 1028b with the molded rubber member 1005b. The spring assembly 1000b may also include a top rubber bushing 1010b having a top opening 1011b and a bottom rubber bushing 1015b. When the top cap 1023 and the bottom cap 1028b are co-molded with the molded rubber member 1005b, the top rubber bushing 1010b may protrude through the top cap hole 1025b and the bottom rubber bushing 1015b may protrude through the bottom cap hole 1031b. The spring assembly 1000b may further include a first fastener 1019b extending through a first top cap hole 1026b and a second fastener 1020b extending through a second top cap hole 1024b for attaching the spring assembly 1000b to a seat bracket (not shown in FIG. 10B). The spring assembly 1000b may also include a third fastener 1021b extending through a first bottom cap hole 1030b and a fourth fastener 1022b extending through a second bottom cap hole 1032b for attaching the spring assembly 1000b to a landing bracket (not shown in FIG. 10B). An enlarged head-end of each fastener 1019b-1020b may be co-molded with the molded rubber member 1005b which may form the respective cubs 1009b, 1008b and similar cubs corresponding to fasteners 1021b, 1022b.

A method of manufacturing a spring assembly 1000a, 1000b for use in a rocker style chair may include providing a mold with a first side and a second side. The method may also include providing a top cap with a first fastener hole, a second fastener hole and a top bushing hole. The method may further include inserting a first fastener through the first fastener hole and a second fastener through the second fastener hole. The method may yet further include inserting the top cap, the first fastener and the second fastener within the first side of the mold. The method may even further include providing a bottom cap with a third fastener hole, a fourth fastener hole and a bottom bushing hole. The method may also include inserting a third fastener through the third fastener hole and a fourth fastener through the fourth fastener hole. The method may further include inserting the bottom cap, the first fastener and the second fastener within the first side of the mold. The method may yet further include joining the first side of the mold with the second side of the mold. The method may even further include injecting rubber within the mold. The method may also include separating the first side of the mold from the second side of the mold. The method may further include removing the spring assembly from the mold. At least one of: the first side of the mold or the second side of the mold includes a plurality of posts extending into a mold cavity and wherein each post has a substantially dumbbell shaped cross section. Alternatively, or additionally, at least one of: the first side of the mold or the second side of the mold includes a plurality of posts extending into a mold cavity and wherein each post has a substantially circular shaped cross section. The method may further include the steps of applying a first layer of adhesion promotion material to a bottom surface of the top cap prior to inserting the top cap within the first side of the mold and applying a second layer of adhesion promotion material to a top surface of the bottom cap prior to inserting the bottom cap within the first side of the mold. At least one of: the first side of the mold or the second side of the mold includes front end fins extending into a mold cavity. At least one of: the first side of the mold or the second side of the mold includes rear end fins extending into a mold cavity.

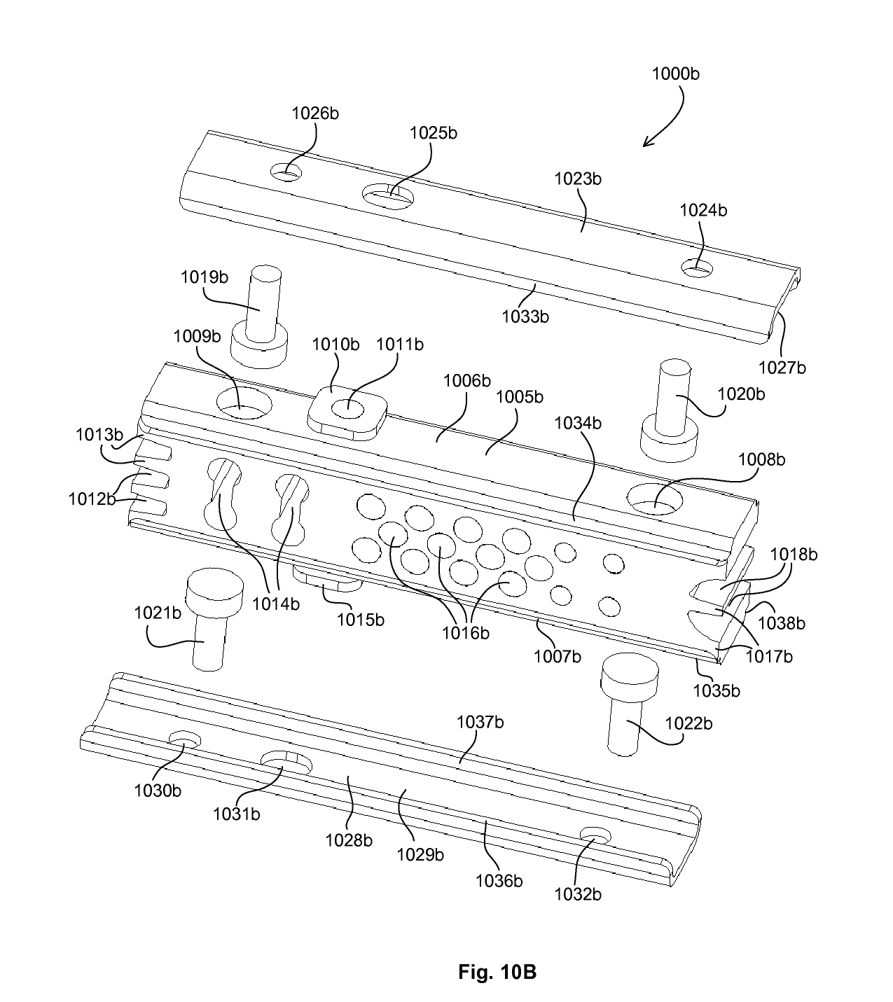

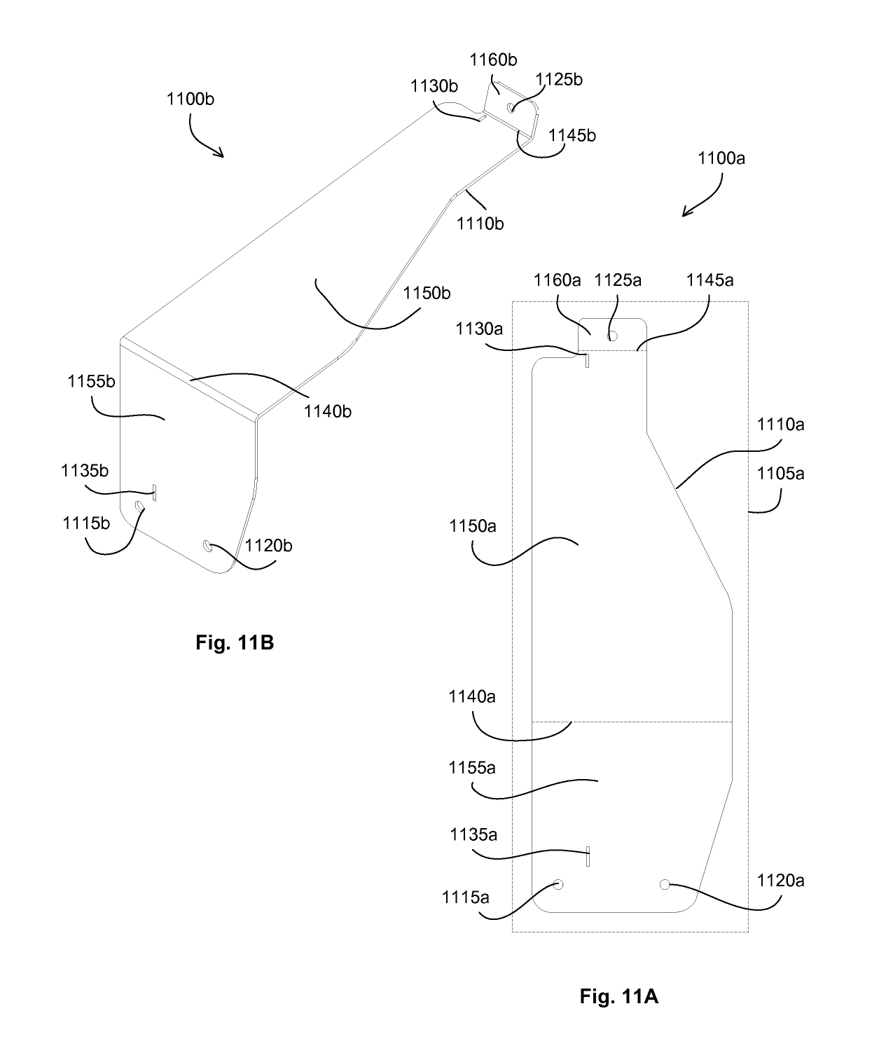

Turning to FIG. 11A, a blank 1100a of a right-hand debris cover 1110a is depicted as being formed in a substantially flat piece of material 1105a. The right-hand debris cover 1110a may be similar to the right-hand debris cover 196d of FIG. 1D. The substantially flat piece of material 1105a may be metal, steel, plastic, carbon reinforced plastic, a laminate material, a composite material, etc. The blank 1100a may include a first mounting hole 1115a, a second mounting hole 1120a and a first end plate tab slot 1135a formed in a first section 1155a. The blank 1100a may further include a second end plate tab slot 1130a formed in a second section 1150a and a third mounting hole 1125a formed in a third section 1160a. The first section 1155a may be distinguished from the second section 1150a via a first bend line 1140a and the second section 1150a may be distinguished from the third section 1160a via a second bend line 1145a.

With reference to FIG. 11B, a perspective view of a right-hand debris cover 1100b is depicted. The right-hand debris cover 1100b may be shaped from the blank 1100a of FIG. 11A. The right-hand debris cover 1100b may include a first mounting hole 1115b, a second mounting hole 1120b and a first end plate tab slot 1135b formed in a first section 1155b. The right-hand debris cover 1100b may further include a second end plate tab slot 1130b formed in a second section 1150b and a third mounting hole 1125b formed in a third section 1160b. The first section 1155b may extend from the second section 1150b at a first angle along a first bend line 1140b and the second section 1150b may extend from the third section 1160b at a second angle along a second bend line 1145b. The first angle and the second angle may be substantially the same such that the second section 1150b is substantially horizontal when the right-hand debris cover 1100b is secured to a right-hand standard (not shown in FIG. 11B).

Turning to FIG. 12A, a blank 1200a of a center debris cover 1210a is depicted as being formed in a substantially flat piece of material 1205a. The center debris cover 1110a may be similar to the center debris cover 197d of FIG. 1D. The substantially flat piece of material 1205a may be metal, steel, plastic, carbon reinforced plastic, a laminate material, a composite material, etc. The blank 1200a may include a first mounting hole 1215a and a second mounting hole 1220a formed in a first section 1245a. The blank 1200a may further include a second section 1240a and a third mounting hole 1225a formed in a third section 1250a. The first section 1245a may be distinguished from the second section 1240a via a first bend line 1230a and the second section 1240a may be distinguished from the third section 1250a via a second bend line 1235a.

With reference to FIG. 12B, a perspective view of a center debris cover 1200b is depicted. The center debris cover 1200b may be shaped from the blank 1200a of FIG. 12A. The center debris cover 1200b may include a first mounting hole 1215b and a second mounting hole 1220b formed in a first section 1245b. The center debris cover 1200b may further include a second section 1240b and a third mounting hole 1225b formed in a third section 1250b. The first section 1245b may extend from the second section 1240b at a first angle along a first bend line 1230b and the second section 1240b may extend from the third section 1250b at a second angle along a second bend line 1235b. The first angle and the second angle may be substantially the same such that the second section 1240b is substantially horizontal when the center debris cover 1200b is secured to a center standard (not shown in FIG. 12B).

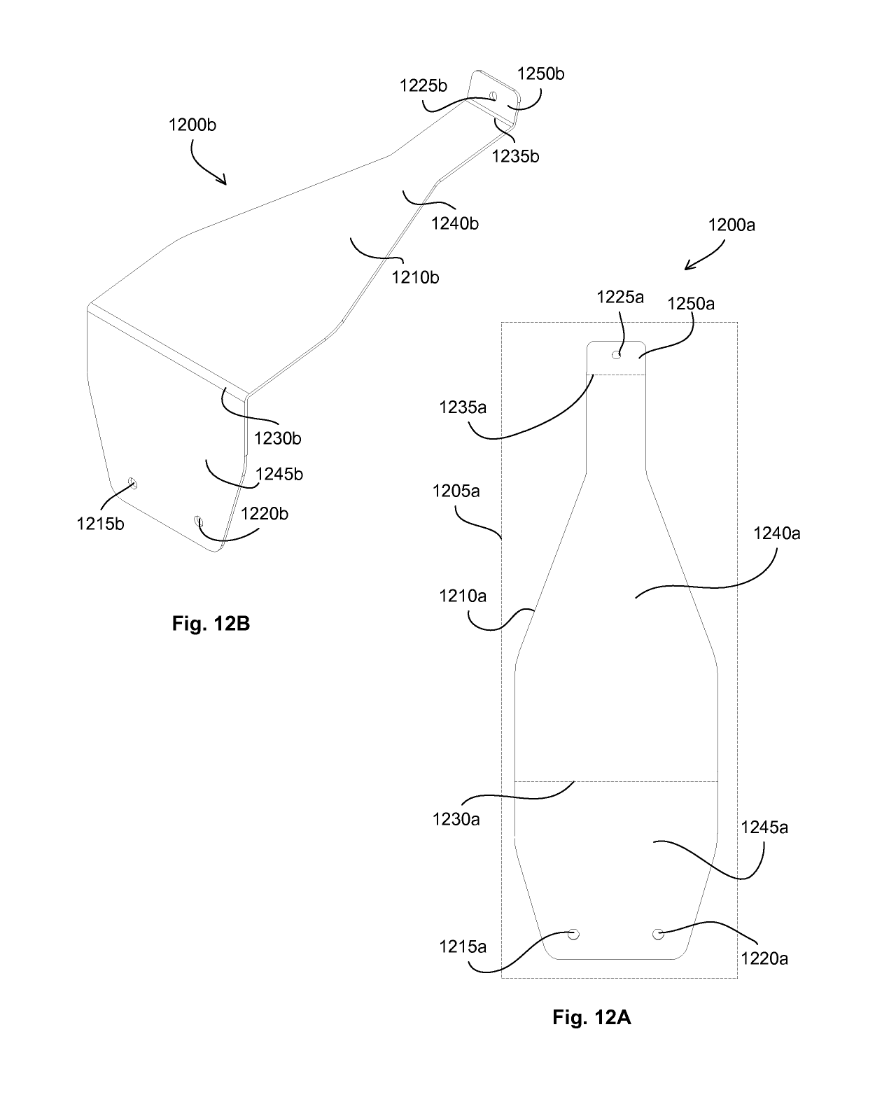

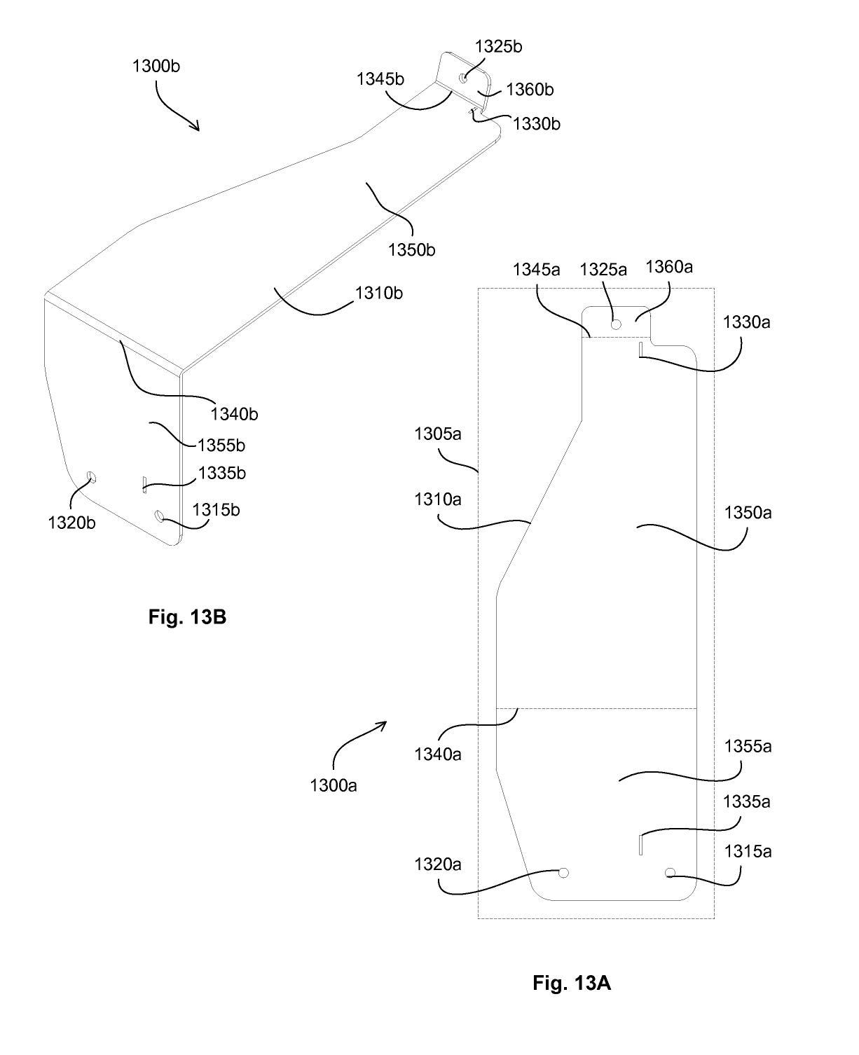

Turning to FIG. 13A, a blank 1300a of a left-hand debris cover 1310a is depicted as being formed in a substantially flat piece of material 1305a. The left-hand debris cover 1110a may be similar to the left-hand debris cover 198d of FIG. 1D. The substantially flat piece of material 1305a may be metal, steel, plastic, carbon reinforced plastic, a laminate material, a composite material, etc. As can be appreciated by comparing FIG. 13A with FIG. 11A, the blank 1300a may be substantially the same as the blank 1100a. The blank 1300a may include a first mounting hole 1315a, a second mounting hole 1320a and a first end plate tab slot 1335a formed in a first section 1355a. The blank 1300a may further include a second end plate tab slot 1330a formed in a second section 1350a and a third mounting hole 1325a formed in a third section 1360a. The first section 1355a may be distinguished from the second section 1350a via a first bend line 1340a and the second section 1350a may be distinguished from the third section 1360a via a second bend line 1345a.

With reference to FIG. 13B, a perspective view of a left-hand debris cover 1300b is depicted. The left-hand debris cover 1300b may be shaped from the blank 1300a of FIG. 13A. The left-hand debris cover 1300b may include a first mounting hole 1315b, a second mounting hole 1320b and a first end plate tab slot 1335b formed in a first section 1355b. The left-hand debris cover 1300b may further include a second end plate tab slot 1330b formed in a second section 1350b and a third mounting hole 1325b formed in a third section 1360b. The first section 1355b may extend from the second section 1350b at a first angle along a first bend line 1340b and the second section 1350b may extend from the third section 1360b at a second angle along a second bend line 1345b. The first angle and the second angle may be substantially the same such that the second section 1350b is substantially horizontal when the left-hand debris cover 1300b is secured to a left-hand standard (not shown in FIG. 13B). When the bends along bend lines 1340b, 1345b are opposite the bends along bend lines 1140b, 1145b, a mirror image of left-hand debris cover 1300b may be formed as a right-hand debris cover 1100b using the same blank 1105a, 1305a.

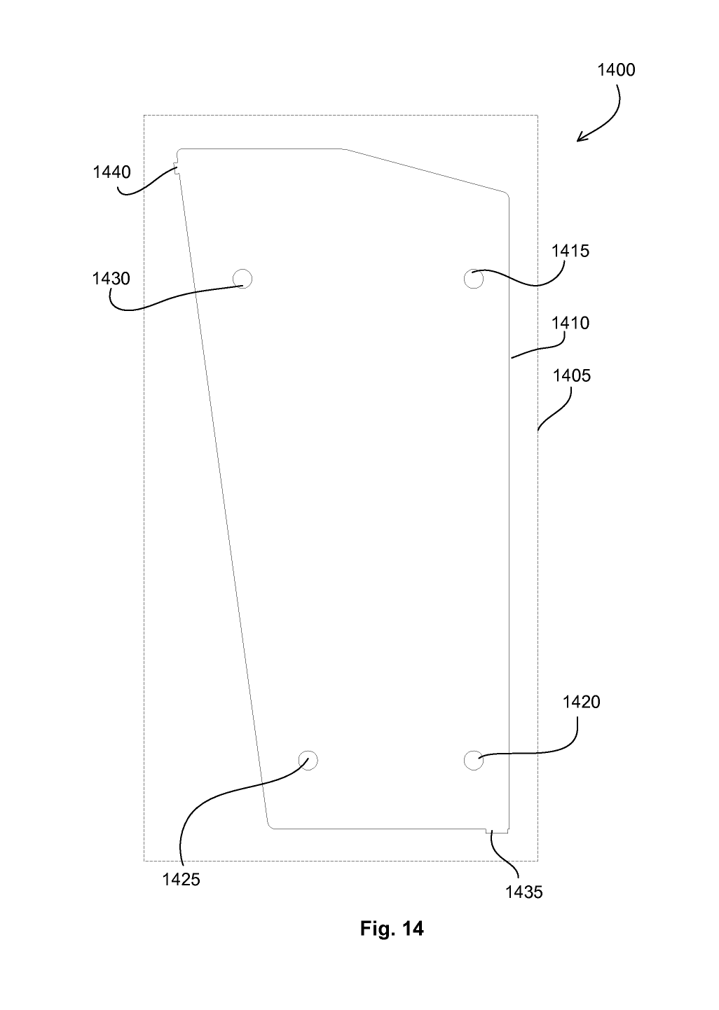

Turning to FIG. 14, a blank 1400 of an end cover 1410 is depicted as being formed from a substantially flat piece of material 1405. The substantially flat piece of material 1405 may be metal, steel, plastic, carbon reinforced plastic, a laminate material, a composite material, etc. The end cover 1410 may include a first tab 1435 and a second tab 1440 that may engage the first end plate tap slot 1135a or 1335a and the second end plate tap slot 1130a or 1330a, respectively, to secure the end cover 1410 to either the right-hand debris cover 1100b or 1300b. The end cover 1410 may also include a first hole 1415, a second hole 1420, a third hole 1425 and a fourth hole 1430 for securing various components (not shown in FIG. 14) to the end cover 1410.

With reference to FIG. 15A, a blank 1500a of a right-hand landing bracket 1510a is depicted as being formed from a substantially flat piece of material 1505a. The right-hand landing bracket 1510a may be similar to the right-hand landing bracket 433g of FIG. 1G. The substantially flat piece of material 1505a may be metal, steel, plastic, carbon reinforced plastic, a laminate material, a composite material, etc. The blank 1500a may include a first mounting hole 1506a, a second mounting hole 1507a and a third hole 1508a formed in a first section 1511a. The blank 1500a may further include a first spring assembly mounting hole 1512a formed in a second section 1525a and a second spring assembly mounting hole 1513a formed in a third section 1515a. The blank 1500a may further include an over-travel bolt opening 1509a and a fourth section 1520a having a debris cover mounting hole 1514a. The first section 1511a may be distinguished from the second section 1525a via a first bend line 1535a. The first section 1511a may be distinguished from the third section 1515a via a second bend line 1530a. The second section 1525a may be distinguished from the fourth section 1520a via a third bend line 1540a.

Turning to FIG. 15B, a perspective view of a right-hand landing bracket 1500b is depicted. The right-hand landing bracket 1500b may be shaped from the blank 1500a of FIG. 15A. The right-hand landing bracket 1500b may include a first mounting hole 1506b, a second mounting hole 1507b and a third hole 1508b formed in a first section 1511b. The right-hand landing bracket 1500b may further include a first spring assembly mounting hole 1512b formed in a second section 1525b and a second spring assembly mounting hole 1513b formed in a third section 1515b. The right-hand landing bracket 1500b may further include an over-travel bolt opening 1509b and a fourth section 1520b having a debris cover mounting hole 1514b. The first section 1511b may extend from the second section 1525a at approximately a ninety degree angle along a first bend line 1535a. The first section 1511a may extend from the third section 1515a at approximately a ninety degree angle along a second bend line 1530a. The second section 1525a may extend from the fourth section 1520a at approximately a ninety degree angle along a third bend line 1540a.

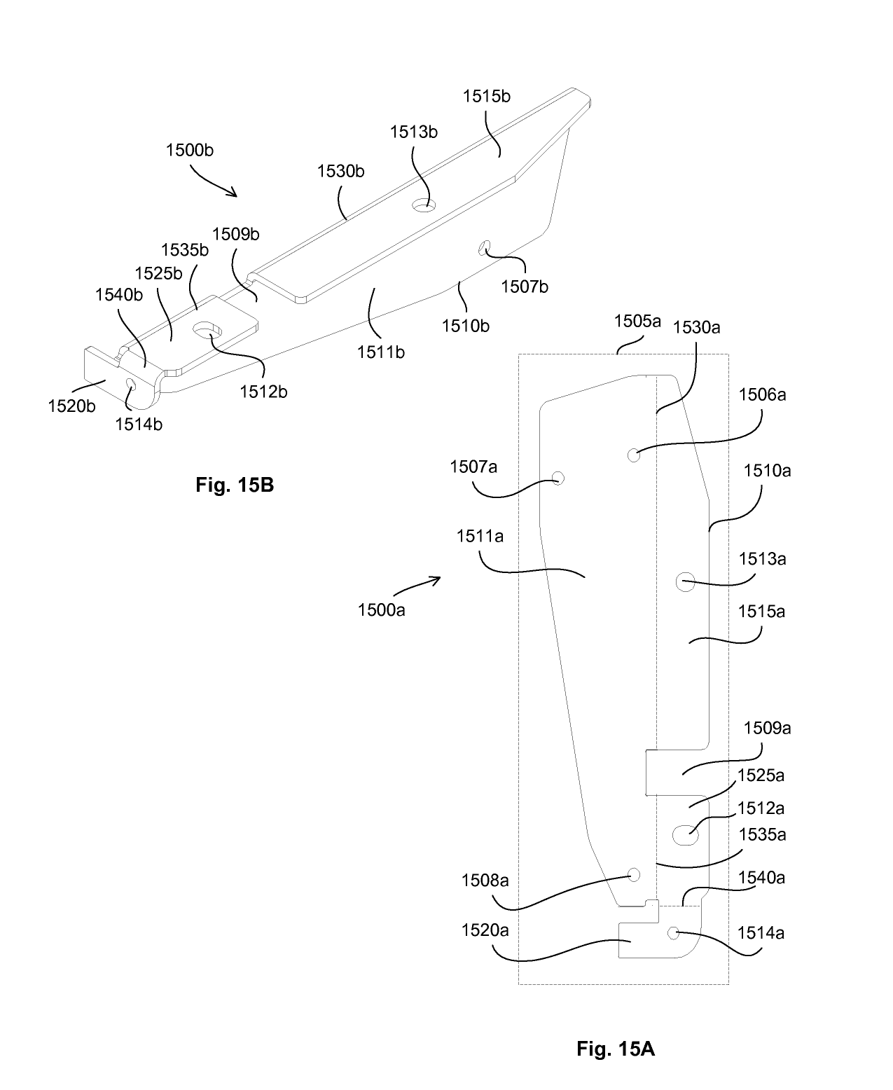

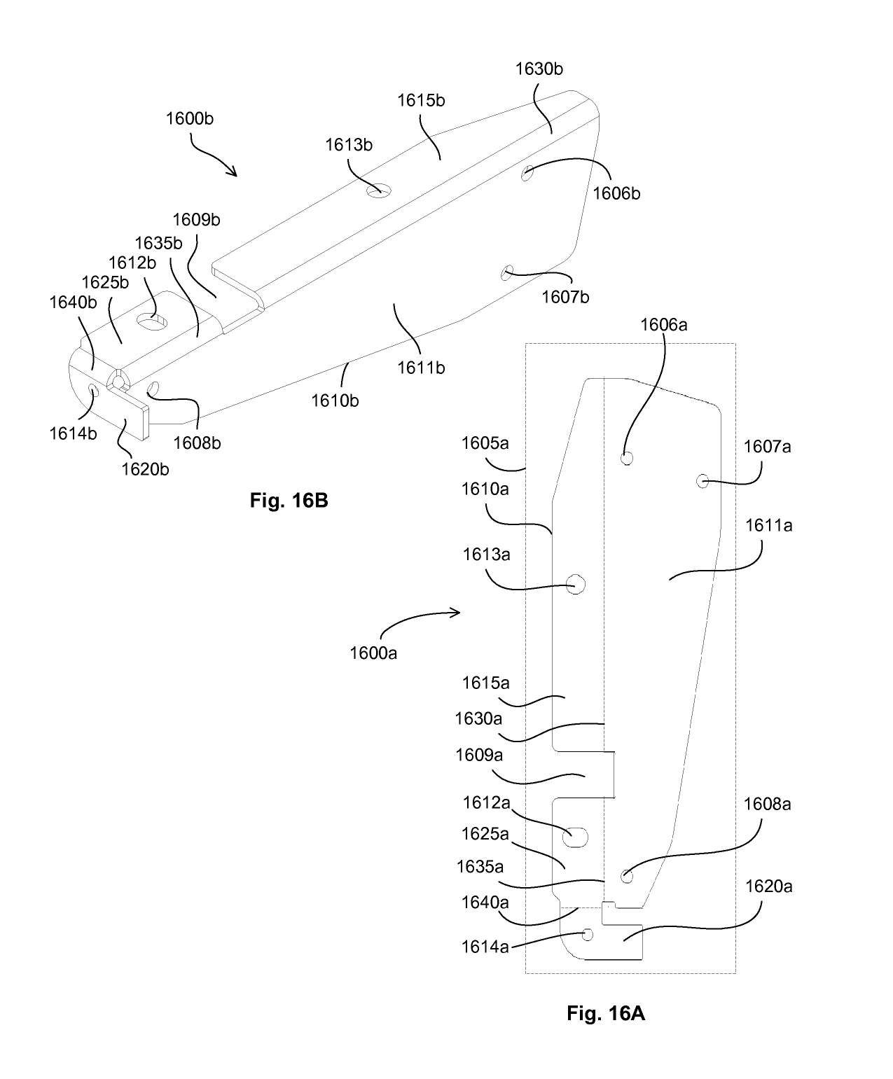

With reference to FIG. 16A, a blank 1600a of a left-hand landing bracket 1610a is depicted as being formed from a substantially flat piece of material 1605a. The left-hand landing bracket 1610a may be similar to the left-hand landing bracket 432g of FIG. 1G. The substantially flat piece of material 1605a may be metal, steel, plastic, carbon reinforced plastic, a laminate material, a composite material, etc. The blank 1600a may include a first mounting hole 1606a, a second mounting hole 1607a and a third hole 1608a formed in a first section 1611a. The blank 1600a may further include a first spring assembly mounting hole 1612a formed in a second section 1625a and a second spring assembly mounting hole 1613a formed in a third section 1615a. The blank 1600a may further include an over-travel bolt opening 1609a and a fourth section 1620a having a debris cover mounting hole 1614a. The first section 1611a may be distinguished from the second section 1625a via a first bend line 1635a. The first section 1611a may be distinguished from the third section 1615a via a second bend line 1630a. The second section 1625a may be distinguished from the fourth section 1620a via a third bend line 1640a.

Turning to FIG. 16B, a perspective view of a left-hand landing bracket 1600b is depicted. The left-hand landing bracket 1600b may be shaped from the blank 1600a of FIG. 16A. The left-hand landing bracket 1600b may include a first mounting hole 1606b, a second mounting hole 1607b and a third hole 1608b formed in a first section 1611b. The left-hand landing bracket 1600b may further include a first spring assembly mounting hole 1612b formed in a second section 1625b and a second spring assembly mounting hole 1613b formed in a third section 1615b. The left-hand landing bracket 1600b may further include an over-travel bolt opening 1609b and a fourth section 1620b having a debris cover mounting hole 1614b. The first section 1611b may extend from the second section 1625a at approximately a ninety degree angle along a first bend line 1635a. The first section 1611a may extend from the third section 1615a at approximately a ninety degree angle along a second bend line 1630a. The second section 1625a may extend from the fourth section 1620a at approximately a ninety degree angle along a third bend line 1640a. When the bends along bend lines 1630b, 1635b, 1640b are opposite the bends along bend lines 1530b, 1530b, 1540b, a mirror image of left-hand landing bracket 1600b may be formed as a right-hand landing bracket 1500b using the same blank 1505a, 1605a.

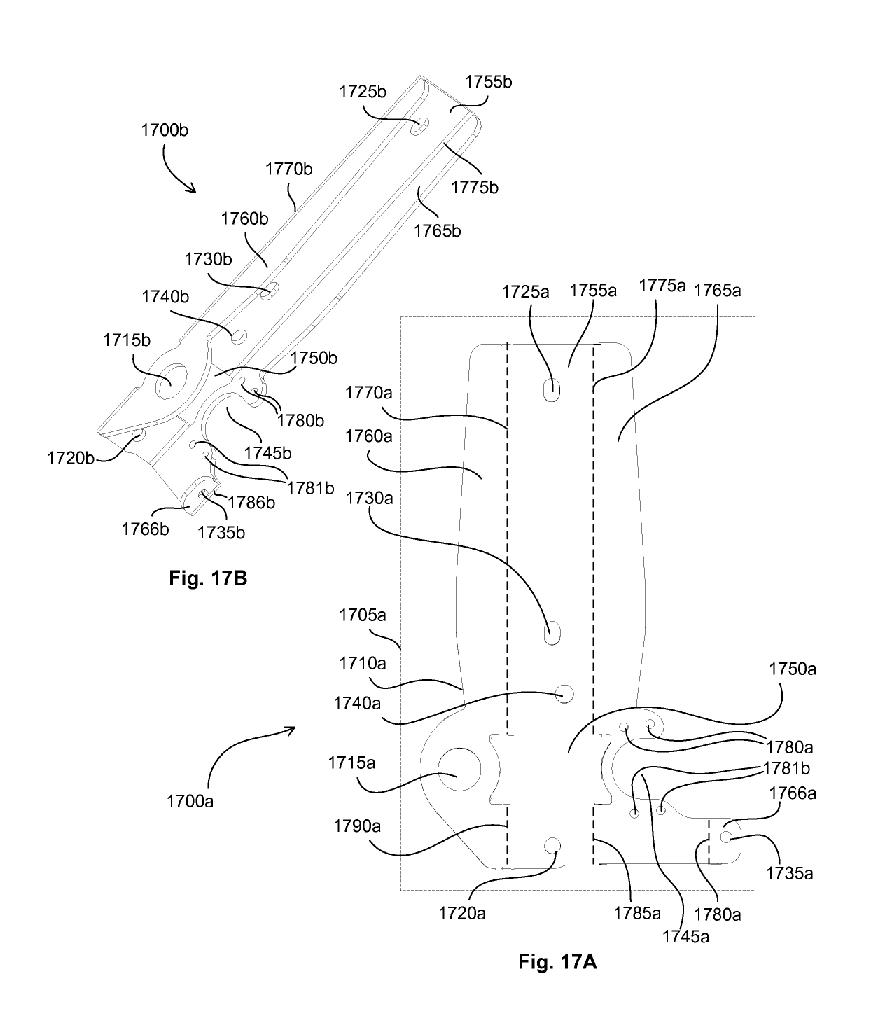

With reference to FIG. 17A, a blank 1700a of a right-hand seat connector 1710a is depicted as being formed in a substantially flat piece of material 1705a. The right-hand seat connector 1710a may be similar to the right-hand seat connector 901a of FIG. 9A. The substantially flat piece of material 1705a may be metal, steel, plastic, carbon reinforced plastic, a laminate material, a composite material, etc. The blank 1700a may include a first right-hand seat bracket attachment hole 1720a and a pivot spring opening 1750a. The blank 1700a may also include a second right-hand seat bracket attachment hole 1725a, a bumper opening 1740a and an alignment opening 1730a formed in a first section 1755a. The blank 1700a may further include a pivot arm hole 1715a formed in a second section 1760a, a pivot arm slot 1745a formed in a third section 1765a and a decorative bottom attachment hole 1735a formed in a fourth section. The second section 1760a may be distinguished from the first section 1755a via a first bend line 1770a, 1790a. The third section 1765a may be distinguished from the first section 1755a via a second bend line 1775a, 1785a. The fourth section 1766a may be distinguished from the third section 1765a via a third bend line 1780a. The right-hand seat connector 1710a may include front pivot arm adjustment holes 1780a and rear pivot arm adjustment holes 1781a. One of the front pivot arm adjustment holes 1780a may cooperate with a front seat connector adjustment hole 1925a and one of the rear pivot arm adjustment holes 1781a may cooperate with a rear seat connector adjustment hole 1920a to adjust the distance the seat pivots (e.g., between position 116l and 151l of FIG. 1L).

Turning to FIG. 17B, a perspective view of a right-hand seat connector 1700b is depicted. The right-hand seat connector 1700b may be shaped from the blank 1700a of FIG. 17A. The right-hand seat connector 1700b may include a first right-hand seat bracket attachment hole 1720b and a pivot spring opening 1750b. The right-hand seat connector 1700b may also include a second right-hand seat bracket attachment hole 1725b, a bumper opening 1740b and an alignment opening 1730b formed in a first section 1755b. The right-hand seat connector 1700b may further include a pivot arm hole 1715b formed in a second section 1760b, a pivot arm slot 1745b formed in a third section 1765a and a decorative bottom attachment hole 1735b formed in a fourth section. The second section 1760b may be extend from the first section 1755a at approximately a ninety degree angle along the first bend line 1770a, 1790a. The third section 1765a may be extend from the first section 1755a at approximately a ninety degree angle along the second bend line 1775a, 1785a. The fourth section 1766a may be extend from the third section 1765a at approximately a ninety degree angle along the third bend line 1780a. The right-hand seat connector 1710b may include front pivot arm adjustment holes 1780b and rear pivot arm adjustment holes 1781b. One of the front pivot arm adjustment holes 1780b may cooperate with a front seat connector adjustment hole 1925b and one of the rear pivot arm adjustment holes 1781b may cooperate with a rear seat connector adjustment hole 1920b to adjust the distance the seat pivots (e.g., between position 116l and 151l of FIG. 1L).

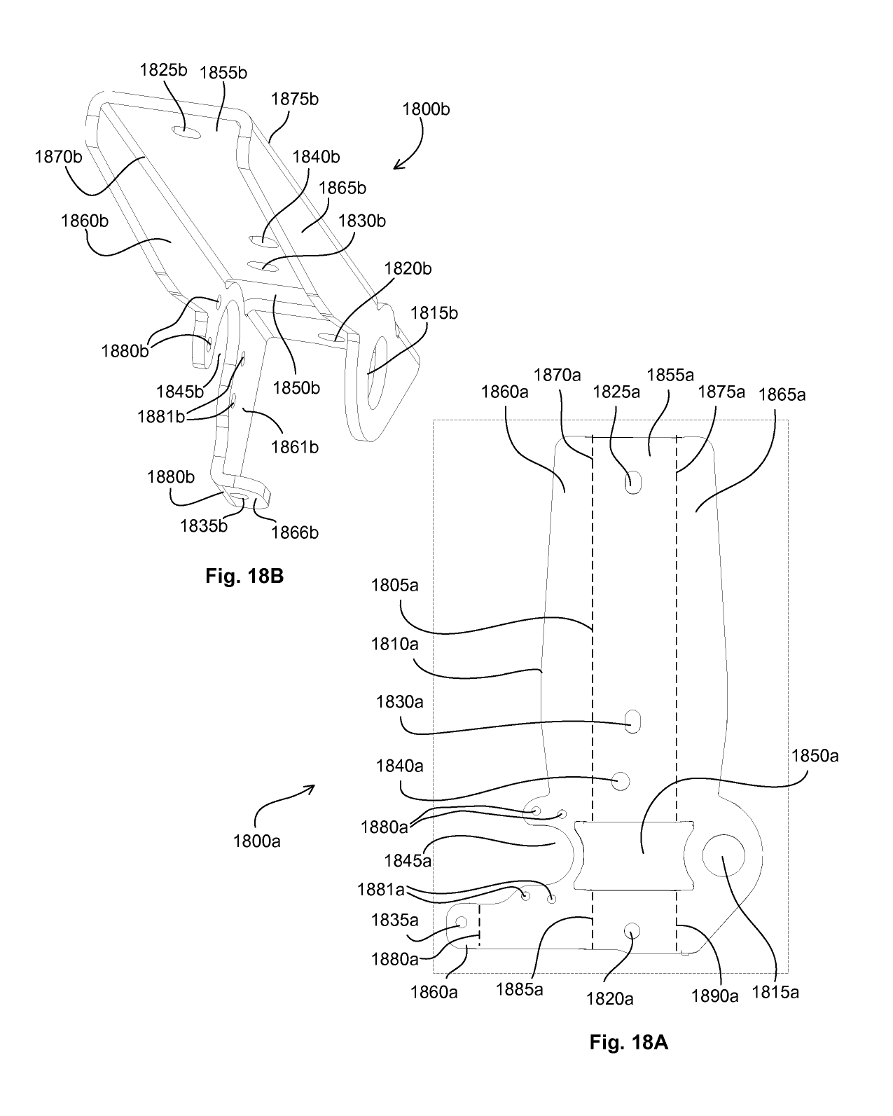

With reference to FIG. 18A, a blank 1800a of a left-hand seat connector 1810a is depicted as being formed in a substantially flat piece of material 1805a. The left-hand seat connector 1810a may be similar to the left-hand seat connector 801a of FIG. 8A. As can be appreciated by comparing FIG. 18A with FIG. 17A, the blank 1800a may be substantially the same as the blank 1700a. The substantially flat piece of material 1805a may be metal, steel, plastic, carbon reinforced plastic, a laminate material, a composite material, etc. The blank 1800a may include a first left-hand seat bracket attachment hole 1820a and a pivot spring opening 1850a. The blank 1800a may also include a second left-hand seat bracket attachment hole 1825a, a bumper opening 1840a and an alignment opening 1830a formed in a first section 1855a. The blank 1800a may further include a pivot arm hole 1815a formed in a second section 1860a, a pivot arm slot 1845a formed in a third section 1865a and a decorative bottom attachment hole 1835a formed in a fourth section. The second section 1860a may be distinguished from the first section 1855a via a first bend line 1870a, 1890a. The third section 1865a may be distinguished from the first section 1855a via a second bend line 1875a, 1885a. The fourth section 1866a may be distinguished from the third section 1865a via a third bend line 1880a. The left-hand seat connector 1810a may include front pivot arm adjustment holes 1880a and rear pivot arm adjustment holes 1881a. One of the front pivot arm adjustment holes 1880a may cooperate with a front seat connector adjustment hole 2025a and one of the rear pivot arm adjustment holes 1881a may cooperate with a rear seat connector adjustment hole 2020a to adjust the distance the seat pivots (e.g., between position 116l and 151l of FIG. 1L).

Turning to FIG. 18B, a perspective view of a left-hand seat connector 1800b is depicted. The left-hand seat connector 1800b may be shaped from the blank 1800a of FIG. 18A. The left-hand seat connector 1800b may include a first left-hand seat bracket attachment hole 1820b and a pivot spring opening 1850b. The left-hand seat connector 1800b may also include a second left-hand seat bracket attachment hole 1825b, a bumper opening 1840b and an alignment opening 1830b formed in a first section 1855b. The left-hand seat connector 1800b may further include a pivot arm hole 1815b formed in a second section 1860b, a pivot arm slot 1845b formed in a third section 1865a and a decorative bottom attachment hole 1835b formed in a fourth section. The second section 1860b may be extend from the first section 1855a at approximately a ninety degree angle along the first bend line 1870a, 1890a. The third section 1865a may be extend from the first section 1855a at approximately a ninety degree angle along the second bend line 1875a, 1885a. The fourth section 1866a may be extend from the third section 1865a at approximately a ninety degree angle along the third bend line 1880a. When the bends along bend lines 1870b, 1875b, 1880b, 1885b, 1890b are opposite the bends along bend lines 1770b, 1775b, 1780b, 1785b, 1790b, a mirror image of left-hand seat connector 1800b may be formed as a left-hand seat connector 1700b using the same blank 1705a, 1805a. The left-hand seat connector 1800b may include front pivot arm adjustment holes 1880b and rear pivot arm adjustment holes 1881b. One of the front pivot arm adjustment holes 1880b may cooperate with a front seat connector adjustment hole 2025b and one of the rear pivot arm adjustment holes 1881b may cooperate with a rear seat connector adjustment hole 2020b to adjust the distance the seat pivots (e.g., between position 116l and 151l of FIG. 1L).

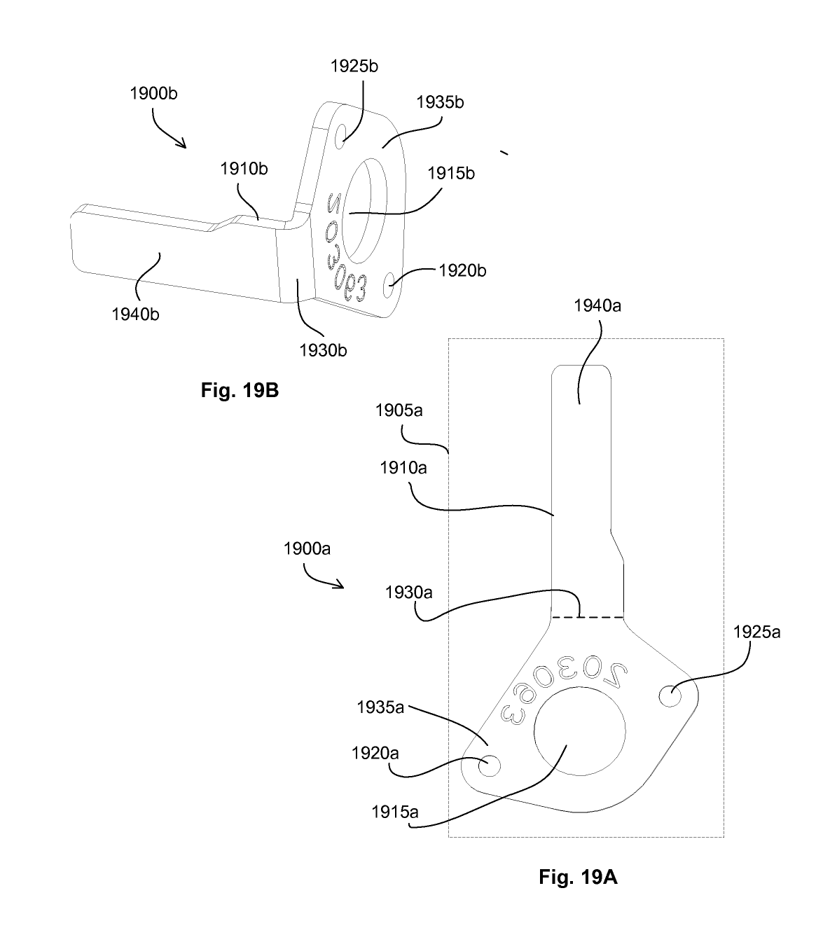

With reference to FIG. 19A, a blank 1900a of a right-hand pivot arm 1910a is depicted as being formed in a substantially flat piece of material 1905a. The right-hand pivot arm 1910 may be similar to the right-hand pivot arm 937a of FIG. 9A. The substantially flat piece of material 1805a may be metal, steel, plastic, carbon reinforced plastic, a laminate material, a composite material, etc. The blank 1900a may include a pivot post hole 1915a, a first hole 1920a and a second hole 1925a formed in a first section 1935a. The blank 1900a may further include a second section 1940a distinguished from the first section 1935a via a bend line 1930a.

Turning to FIG. 19B, a perspective view of a right-hand pivot arm 1900b is depicted. The right-hand pivot arm 1900b may be shaped from the blank 1900a of FIG. 19A. The right-hand pivot arm 1900b may include a pivot post hole 1915b, a first hole 1920b and a second hole 1925b formed in a first section 1935b. The right-hand pivot arm 1900b may further include a second section 1940b extending from the first section 1935b at substantially a ninety degree angle along the bend line 1930b.

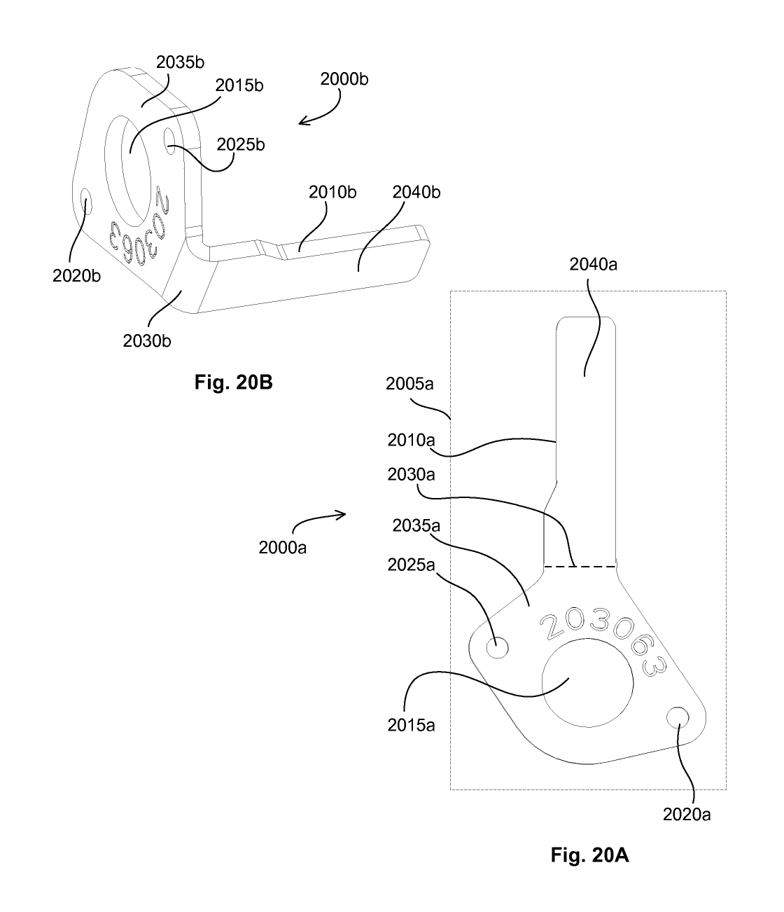

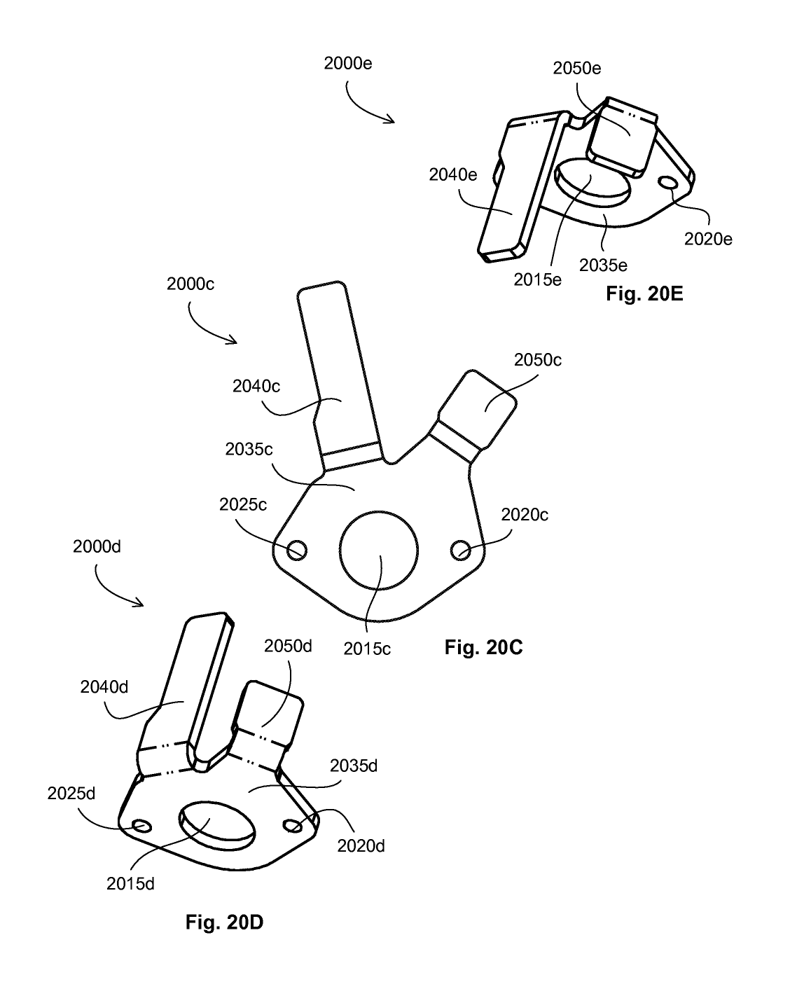

With reference to FIG. 20A, a blank 2000a of a right-hand pivot arm 2010a is depicted as being formed in a substantially flat piece of material 2005a. The right-hand pivot arm 2010 may be similar to the right-hand pivot arm 937a of FIG. 9A. As can be appreciated by comparing FIG. 20A with FIG. 19A, the blank 2000a may be substantially the same as the blank 1900a. The substantially flat piece of material 1805a may be metal, steel, plastic, carbon reinforced plastic, a laminate material, a composite material, etc. The blank 2000a may include a pivot post hole 2015a, a first hole 2020a and a second hole 2025a formed in a first section 2035a. The blank 2000a may further include a second section 2040a distinguished from the first section 2035a via a bend line 2030a.

Turning to FIG. 20B, a perspective view of a right-hand pivot arm 2000b is depicted. The right-hand pivot arm 2000b may be shaped from the blank 2000a of FIG. 20A. The right-hand pivot arm 2000b may include a pivot post hole 2015b, a first hole 2020b and a second hole 2025b formed in a first section 2035b. The right-hand pivot arm 2000b may further include a second section 2040b extending from the first section 2035b at substantially a ninety degree angle along the bend line 2030b. When the bend along bend line 2030b opposite the bend along bend line 1930b, a mirror image of left-hand pivot arm 1900b may be formed as a left-hand pivot arm 2000b using the same blank 1905a, 2005a.

With respect to FIGS. 17A-20B and the related FIGS. 8A-9C, the first holes 1920a, 1920b and 2020a, 2020b cooperate with a respective set of the second holes 1780a, 1781a, 1880a, 1881a to define a relaxed chair seat position (e.g., relaxed chair seat position 151l of FIG. 1L) and/or a charged chair seat position (e.g., charged chair seat position 161l of FIG. 1L). It should be understood that a spring and/or pivot arm may be configured as shown, for example, in FIG. 8D, 8E, 9D or 9E to define alternate relaxed chair seat positions and/or charged chair seat positions.

Turning to FIGS. 20C-20E, an alternate pivot arm configuration 2000c, 2000d, 2000e is depicted. With reference to FIG. 20C, a blank 2000c of a pivot arm is depicted as being formed in a substantially flat piece of material. The pivot arm 2000d may be similar to the right-hand pivot arm 937a of FIG. 9A. As can be appreciated by comparing FIG. 20D with FIG. 20E, the blank 2000c may be substantially the same for either a right-hand pivot arm 2000d and a left-hand pivot arm 2000e. The substantially flat piece of material may be metal, steel, plastic, carbon reinforced plastic, a laminate material, a composite material, etc. The blank 2000c may include a pivot post hole 2015c, a first hole 2020c and a second hole 2025c formed in a first section 2035c. The blank 2000c may further include a second section 2040c distinguished from the first section 2035c via a bend line. The blank 2000c may further include a third section 2050c distinguished from the first section 2035c via a bend line.

FIG. 20D depicts a perspective view of a right-hand pivot arm 2000d. The right-hand pivot arm 2000d may be shaped from the blank 2000c of FIG. 20C. The right-hand pivot arm 2000d may include a pivot post hole 2015d, a first hole 2020d and a second hole 2025d formed in a first section 2035d. The right-hand pivot arm 2000d may further include a second section 2040d extending from the first section 2035d at substantially a ninety degree angle along a first bend line. The right-hand pivot arm 2000d may further include a third section 2050d extending from the first section 2035d at substantially a ninety degree angle along a second bend line. When a bend along the first and second bend lines is opposite a bend along the first and second bend lines, a mirror image of right-hand pivot arm 2000e may be formed as a left-hand pivot arm 2000e using the same blank 2000c.

FIG. 20e depicts a perspective view of a right-hand pivot arm 2000e. The right-hand pivot arm 2000e may be shaped from the blank 2000c of FIG. 20C. The right-hand pivot arm 2000e may include a pivot post hole 2015e, a first hole 2020e and a second hole 2025e formed in a first section 2035e. The right-hand pivot arm 2000e may further include a second section 2040e extending from the first section 2035e at substantially a ninety degree angle along a first bend line. The right-hand pivot arm 2000e may further include a third section 2050e extending from the first section 2035e at substantially a ninety degree angle along a second bend line.

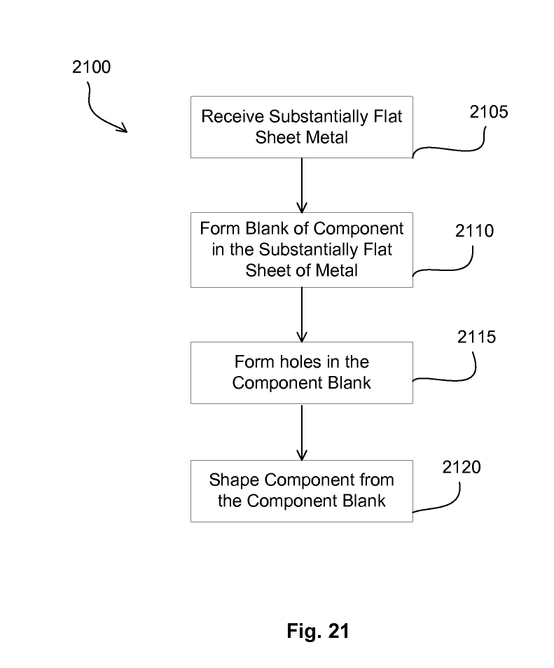

With reference to FIG. 21, a flow diagram of a method of forming a component from a flat piece of material 2100 is depicted. The method 2100 may include receiving a substantially flat sheet of metal (block 2105). The substantially flat piece of material may be metal (e.g., 3 Gauge-12 Gauge), aluminum, steel, plastic, carbon reinforced plastic, a laminate material, a composite material, etc. The method 2100 may also include forming a blank of a component in the substantially flat sheet of material (block 2110). The blank may be formed by stamping, shearing, blade sawing, laser cutting, water-jet cutting, oxy-acetylene cutting, plasma-arc cutting, etc. The method 2100 may further include forming holes and/or openings in the component blank (block 2115). The holes and/or openings may be formed by stamping, drilling, shearing, blade sawing, laser cutting, water-jet cutting, oxy-acetylene cutting, plasma-arc cutting, etc. The method 2100 may yet further include shaping a component from the component blank (block 2120). For example, the shaping may be cold form bending, heat assist bending, break forms, etc. A debris cover 1100b, 1200b, 1300b, an end cover 1400, a landing bracket 1500b, 1600b, a seat connector 1700b, 1800b, a pivot arm 1900b, 2000b and a chair back wing 250a, 251a may, for example, be manufactured using the method 2100.

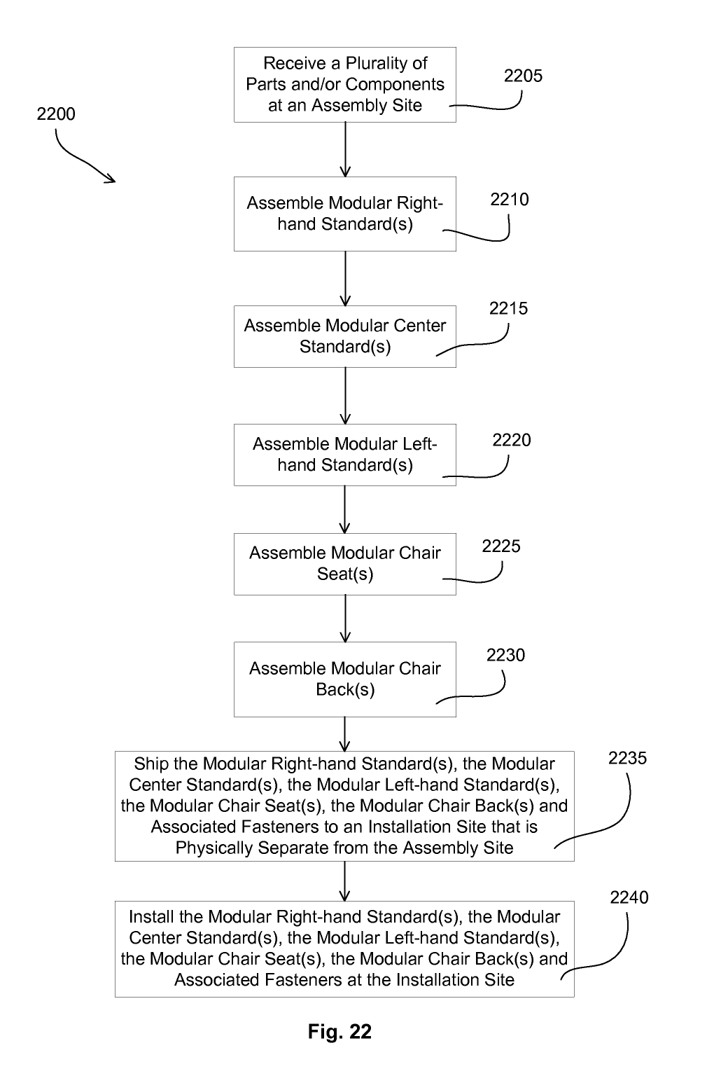

Turning to FIG. 22, a flow diagram of a method of installing a plurality of rocker style chairs 2200 is depicted. The method 2200 may include receiving a plurality of parts and/or components at an assembly site or assembly sites (block 2205). The method 2200 may further include assembling modular right-hand standard(s) from various parts and/or components at a first assembly site (block 2210). The method 2200 may also include assembling modular center standard(s) from various parts and/or components at a second assembly site (block 2215). The method 2200 may further include assembling modular left-hand standard(s) form various parts and/or components at a third assembly site (block 2220). Any two of, or all three of, the first assembly site, the second assembly site and/or the third assembly site may be at the same geographic location. The method 2200 may also include assembling modular chair seat(s) from various parts and/or components at a fourth assembly site (block 2225). The method 2200 may further include assembling modular chair back(s) from various parts and/or components at a fifth assembly site (block 2230). The fourth assembly site and the fifth assembly site may be at the same geographic location and may be further at the same geographic location as one or more of the first assembly site, the second assembly site and/or the third assembly site. The method 2200 may also include shipping the modular right-hand standard(s), the modular center standard(s), the modular left-hand standard(s), the modular chair seat(s), the modular chair back(s) and associated fasteners from the assembly site(s) to an installation site that is at a geographic location that is different than the assembly site(s) (block 2235). The method 2200 may further include installing the modular right-hand standard(s), the modular center standard(s), the modular left-hand standard(s), the modular chair seat(s), the modular chair back(s) and associated fasteners at the installation site (block 2240). Various sub-assemblies of the modular assemblies may be pre-assembled prior to being shipped to a corresponding modular assembly, assembly site.

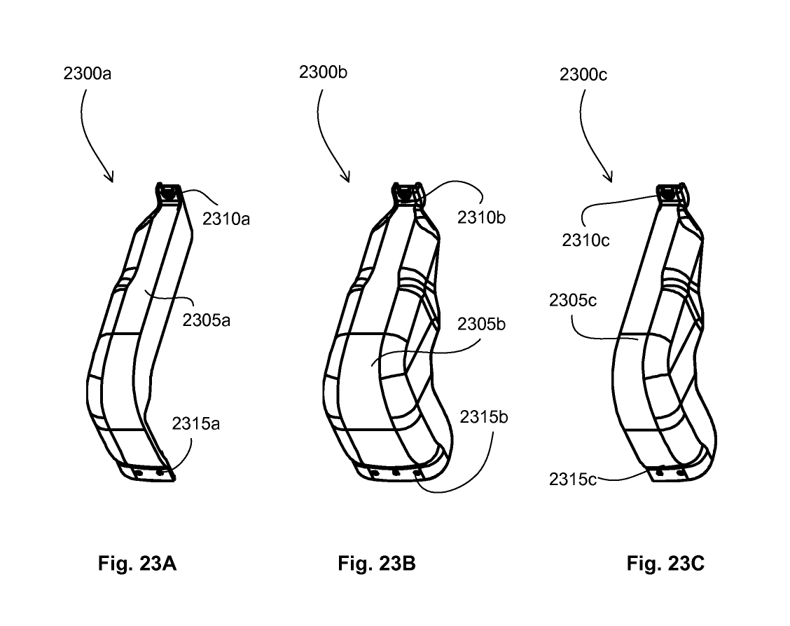

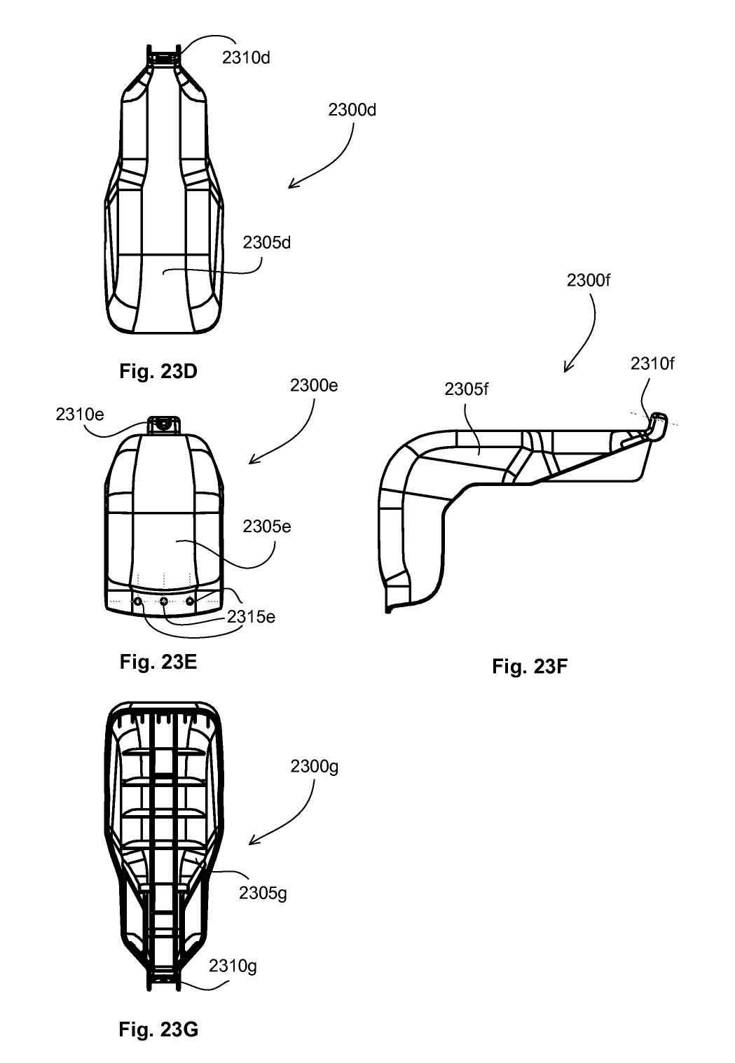

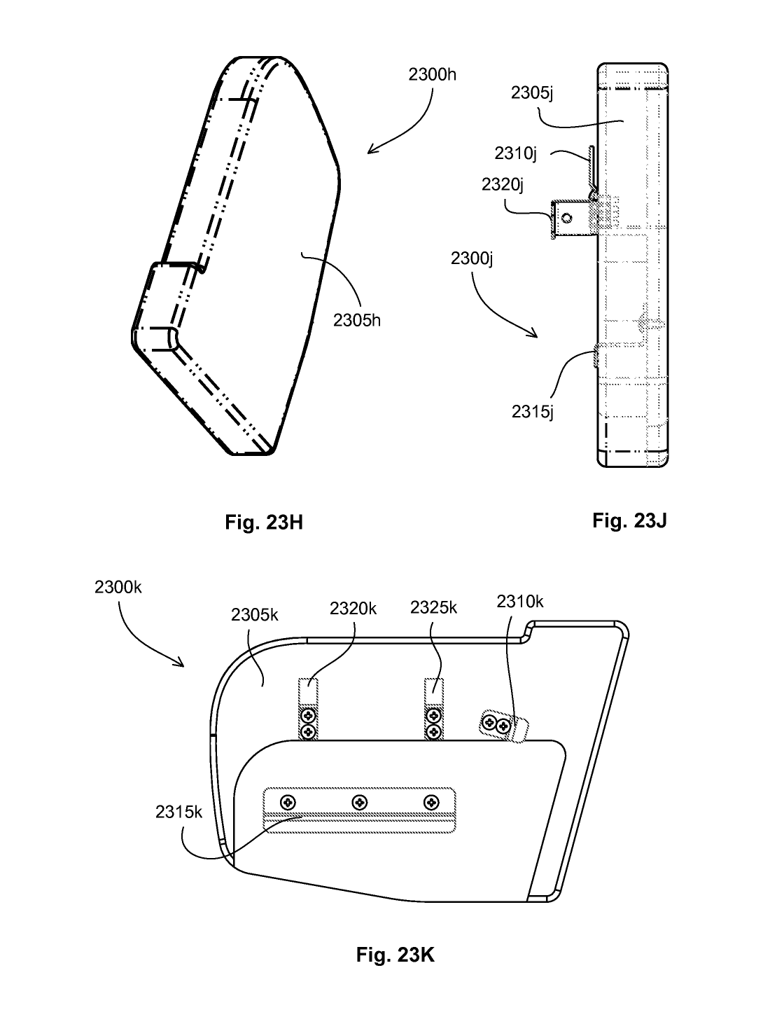

Turning to FIGS. 23A-23G, various view of debris cover assemblies 2300a, 2300b, 2300c, 2300d, 2300e, 2300f, 2300g are depicted. FIG. 23A depicts a right-hand debris cover assembly 2300a that may include a right-hand debris cover body 2305a, an upper fastener 2310a and lower fasteners 2315a. FIGS. 23B and 23D-23F depict various views of a center debris cover assembly 2300b, 2300d, 2300e, 2300f, 2300g that may include a center debris cover body 2305b, 2305d, 2305e, 2305f, 2305g, an upper fastener 2310b, 2310d, 2310e, 2310f, 2310g, and lower fasteners 2315b, 2315e. FIG. 23C depicts a left-hand debris cover assembly 2300c that may include a left-hand debris cover body 2305c, an upper fastener 2310c and lower fasteners 2315c. The right-hand debris cover assembly 2300a, the center debris cover assembly 2300b and/or the left-hand debris cover assembly 2300c may be manufactured of plastic, blow-molded plastic, machined plastic, cast metal, cast steel, cast aluminum, metal, steel, aluminum, iron, cast iron, machined steel, machined aluminum, machined metal, composite, fiber-reinforced plastic or any other suitable material.

With reference to FIGS. 23H, 23J and 23K, a right-hand end panel assembly 2300h, 2300j, 2300k that may include a right-hand end panel body 2305h, 2305j, 2305k and securing brackets 2310j, 2315j, 2320j, 2310k, 2315k, 2320k, 2325k. The right-hand end panel assembly 2300h, 2300j, 2300k manufactured of plastic, blow-molded plastic, machined plastic, cast metal, cast steel, cast aluminum, metal, steel, aluminum, iron, cast iron, machined steel, machined aluminum, machined metal, composite, fiber-reinforced plastic or any other suitable material. While only a right-hand end panel assembly 2300h, 2300j, 2300k is depicted in FIGS. 23H, 23J and 23K, a left-hand end panel may be similar to a mirror image of the right-hand end panel assembly 2300h, 2300j, 2300k.

This detailed description is to be construed as exemplary only and does not describe every possible embodiment, as describing every possible embodiment would be impractical, if not impossible. One could implement numerous alternate embodiments, using either current technology or technology developed after the filing date of this application.

What is claimed is:

1. A seat bracket for use in a rocker style chair, comprising:
a first spring assembly fastener hole and a second spring assembly fastener hole, wherein the first spring assembly fastener hole and said second spring assembly fastener hole are configured to receive a respective fastener of a spring assembly;
an over-travel bolt nut receptacle, wherein the over-travel bolt nut receptacle is configured to receive an associated over-travel bolt nut and to prevent the over-travel bolt nut from rotating when the over-travel bolt nut is received within the over-travel bolt nut receptacle; and
a seat assembly fastener hole and corresponding seat assembly fastening bolt head receptacle, wherein the seat assembly fastening bolt head receptacle is configured to receive an associated seat assembly fastening bolt head and to prevent the seat assembly fastening bold head from rotating when the seat assembly fastening bolt head is received within the seat assembly fastening bolt head receptacle.

2. The seat bracket as in claim 1, wherein the seat assembly fastener hole is offset from a center line that extends through the first spring assembly fastener hole and the second spring assembly fastener hole.

3. The seat bracket as in claim 1, wherein the seat bracket is made from one of: cast iron, cast aluminum, cast metal or an alloy material.

4. The seat bracket as in claim 3, further comprising thinned portions within at least one section.

5. The seat bracket as in claim 1, further comprising a substantially flat bottom surface that is configured to engage a substantially flat surface of an associated spring assembly.

6. The seat bracket as in claim 5, further comprising a spring assembly bushing receptacle configured to receive an associated spring assembly bushing.

7. The seat bracket as in claim 1, further comprising seat bracket engagement features that are configured to cooperate with back bracket engagement features of an associated back bracket.

8. A seat bracket for use in a rocker style chair, comprising:
an over-travel bolt nut receptacle, wherein the over-travel bolt nut receptacle is configured to receive an associated over-travel bolt nut and to prevent the over-travel bolt nut from rotating when the over-travel bolt nut is received within the over-travel bolt nut receptacle; and
a seat assembly fastener hole and corresponding seat assembly fastening receptacle, wherein the seat assembly fastening receptacle is configured to receive an associated seat assembly fastening head and to prevent the seat assembly fastening from rotating when the seat assembly fastening head is received within the seat assembly fastening head receptacle.

9. The seat bracket as in claim 8, further comprising an over-travel bolt hole proximate the over-travel bolt nut receptacle, wherein the over-travel bolt hole is configured to allow an associated over-travel bolt to extend through the over-travel bolt hole.

10. The seat bracket as in claim 8, wherein the seat bracket is made from one of: cast iron, cast aluminum, cast metal or an alloy material.

11. The seat bracket as in claim 10, further comprising thinned portions within at least one section.

12. The seat bracket as in claim 8, further comprising a substantially flat bottom surface that is configured to engage a substantially flat surface of an associated spring assembly.

13. The seat bracket as in claim 12, further comprising a spring assembly bushing receptacle configured to receive an associated spring assembly bushing.

14. The seat bracket as in claim 8, further comprising seat bracket engagement features that are configured to cooperate with back bracket engagement features of an associated back bracket.

15. A seat bracket for use in a rocker style chair, comprising:
at least one fastener head receptacle, wherein the at least one fastener head receptacle is configured to receive a fastener head and to prevent the fastener head from rotating when a fastener head is received within the fastener head receptacle; and
a substantially flat bottom surface that is configured to engage a substantially flat surface of an associated spring assembly.

16. The seat bracket as in claim 15, wherein the at least one fastener head receptacle is configured to receive an associated over-travel bolt nut and to prevent the over-travel bolt nut from rotating when the over-travel bolt nut is received within the at least one fastener head receptacle.

17. The seat bracket as in claim 15, wherein the at least one fastener head receptacle is configured to receive a seat assembly fastening bolt head and to prevent the seat assembly fastening bold head from rotating when the seat assembly fastening bolt head is received within the at least one fastener head receptacle.

18. The seat bracket as in claim 15, further comprising a first spring assembly fastener hole and a second spring assembly fastener hole, wherein the first spring assembly fastener hole and said second spring assembly fastener hole are configured to receive a respective fastener of a spring assembly;

19. The seat bracket as in claim 18, wherein the at least one fastener head receptacle is offset from a center line that extends through the first spring assembly fastener hole and the second spring assembly fastener hole.

20. A seat bracket as in claim 15, further comprising a spring assembly bushing receptacle configured to receive an associated spring assembly bushing; and
a substantially flat bottom surface that is configured to engage a substantially flat surface of an associated spring assembly.
